(19) United States
(12) Patent Application Publication
(10) Pub. No.: US 2017/0024961 A1
(43) Pub. Date: Jan. 26, 2017

(54) USER TRANSFER INTERLEAVED SKILL WAGERING GAMING SYSTEM

(71) Applicant: Gamblit Gaming, LLC, Glendale, CA (US)

(72) Inventors: Miles Arnone, Sherborn, MA (US); Frank Cire, Pasadena, CA (US); Eric Meyerhofer, Pasadena, CA (US)

(21) Appl. No.: 15/289,648

(22) Filed: Oct. 10, 2016

Related U.S. Application Data
(63) Continuation of application No. PCT/US15/25462, filed on Apr. 10, 2015.
(60) Provisional application No. 61/977,911, filed on Apr. 10, 2014.

(51) Int. Cl. G07F 17/32

(52) U.S. Cl. CPC G07F 17/3237; G07F 17/3244; G07F 17/3295; G07F 17/3206; G07F 17/3211

(57) ABSTRACT

A configurable user transfer interleaved wagering system is disclosed, and includes an interactive controller configured to: communicate, to a patron management server, application session request data associated with an interactive application provided by the interactive controller; and receive application session instruction; an application controller constructed to receive application session instructions; and the patron management server operatively connecting the interactive controller and the application controller, and constructed to: receive the application session request data; scan the application session request data to determine location information associated with the interactive controller; determine to use the application controller based on a determined location of the interactive controller, the application controller being one of a plurality of application controllers; generate the application session instructions; dynamically configure the interactive controller by communicating the application session instructions to the interactive controller; and dynamically configure the application controller by communicating the application session instructions to the application controller.

### CROSS REFERENCE TO RELATED APPLICATIONS

This application is a continuation of Patent Cooperation Treat Application No. PCT/US15/25462, filed on Apr. 10, 2015, which claims the benefit of U.S. Provisional Patent Application No. 61/977,911, filed on Apr. 10, 2014, the contents of which are hereby incorporated by reference in their entirety as if stated in full herein.

### FIELD OF THE INVENTION

Embodiments of the present invention are generally related to communications within data processing systems. More particularly, the present invention relates to the communication and processing of wagering data.

### BACKGROUND

The gaming industry has traditionally developed electronic gaming machines that present simple gambling games to a user. The communication and processing needs for these simple gambling games are easily met using conventional processing systems.

For example, U.S. Pat. No. 6,905,405 to McClintic describes a conventional gaming device provided with a central processor (CPU) operably coupled to input logic circuitry and output logic circuitry. The input logic circuitry is employed to operably couple CPU to input devices such as, for example, a touch screen segment or physical button, a coin acceptor, a bill acceptor, a player tracking card reader or a credit/debit card reader. The output logic circuitry is employed to operably couple the CPU with output devices such as, for example, a hopper, a video monitor, meter displays, and a printer. The CPU is also operably coupled to controlling software memory, which includes assigned memory locations storing game software and system software. Such controlling software memory dictates when selected graphics or messages are displayed to a player, as well as when play sequences begin and end and management of wager input and award output. The CPU is also operably coupled to a second memory, which is employed to store data indicative of game statistics, number of plays, number of wins, etc. Controlling software memory, a second memory, or other, ancillary memory store data indicative of winning results, such as data representative of one or more symbol combinations, including winning combinations. Second memory may also be used, for example, to store a bit map of the symbol pattern depicted as a matrix display on video monitor. In operation of the gaming device the CPU carries out instructions of the system software to implement an initial display pattern on the video monitor and to enable the input devices. After a wager is received a player activates an initiator element such as a handle, the physical button or the touch screen to initiate a play sequence. At this point, the game software, in conjunction with a random number generator, generates a random symbol configuration at for a random final outcome comprised of a pattern of symbols for depiction on video monitor. System software then animates the video monitor by simulating the movement of visible representations of symbol carriers including symbols thereon so that the player perceives symbol carrier rotational “movement” of each symbol carrier as well as, optionally, rotational movement of the entire group of symbol carriers about a common axis. Once the visible representations of the symbol carriers have stopped, all of the generated, displayed symbols comprising a winning combination or combinations in the matrix display are identified or flagged. The displayed results (pattern of symbols depicted on the video monitor, which may include symbols received from a remote location, is compared with data stored in game software representing winning combinations to determine if any displayed combination on an active pay line is a winning combination. Any identified winning combination or combinations of symbols are then associated with winnings to be distributed to the player according to a paytable of the game software associated with the various possible winning combinations. The various pay line configurations and required combinations of the various indicia for a winning combination within each pay line reside within the game software and are retrieved for comparison to the randomly generated pattern of indicia depicted on the video monitor.

Operation of another conventional computer gaming system is described in U.S. Pat. No. 6,409,602 issued to Wiltshire et al. A game program is executed on server/host computer. It is then determined whether an image is to be displayed on a screen of a client/terminal computer. If so, an image is sent from the server/host computer to client/terminal computer. The image may include any type of graphical information including a bitmap, a JPEG file, a TIFF file or even an encoded audio/video stream such as a compressed video MPEG stream. The image is generated by game computer program and passed to server/host interface program. In turn, the image is transferred over communication pathways to client/terminal computer via the network services provided by server operating system. The image is received by a client/terminal program executing on the client/terminal computer via the network services provided by client operating system. The client/terminal program then causes the image to be displayed on a screen of the client/terminal computer. It is then determined whether an input command has been entered by the patron using the client/terminal computer. The input command may be a keystroke, movement or clicking of the mouse, a voice activated command or even the clicking of a “virtual button” on a touch screen. The client/terminal program causes the input command to be transmitted back to server/host computer via communication pathways, again using network services provided by the client operating system on one end and server operating system on the other. The command is thus received by the server/host interface program, that, in turn, passes the command back to the game program. The game program processes the input command and updates the state of the game accordingly.

However, more complicated gambling games need communication and processing systems that are better suited for implementing these more complicated gambling games. Various aspects of embodiments of the present invention meet such a need.

### SUMMARY OF THE INVENTION

Systems and methods in accordance with embodiments of the invention provide a communication and data processing system constructed for a configurable user transfer interleaved wagering system.

An embodiment of a configurable user transfer interleaved wagering system includes an interactive controller configured to: communicate, to a patron management server, application session request data associated with an interactive application provided by the interactive controller; and receive, from the patron management server, application session instructions based on the application session request data; an application controller constructed to receive, from the patron management server, application session instructions; and the patron management server operatively connecting the interactive controller and the application controller, and constructed to: receive, from the interactive controller, the application session request data; scan the application session request data to determine location information associated with the interactive controller; determine a location of the interactive controller based on the location information; determine to use the application controller based on the location of the interactive controller, the application controller being one of a plurality of application controllers; generate the application session instructions based on the application controller; dynamically configure the interactive controller by communicating the application session instructions to the interactive controller; and dynamically configure the application controller by communicating the application session instructions to the application controller.

In a further embodiment, the interactive controller and the application controller are constructed from the same device, and the application controller is operatively connected to the wager controller using a communication link.

In a further embodiment, the wager controller and the application controller are constructed from the same device, and the application controller is operatively connected to the interactive controller using a communication link.

In a further embodiment, the interactive controller comprises a global positioning system (GPS) receiver, wherein the location information is generated using the GPS receiver.

In a further embodiment, the patron management server determines the location of the interactive controller by: generating location information request instructions using the location information; instructing a geolocation server by communicating the location information request instructions to the geolocation server; receiving, from the geolocation server, interactive controller location data; and scanning the interactive controller location data to determine the location of the interactive controller.

In a further embodiment, the patron management server is further constructed to associate the determined application controller with an application session associated with the interactive controller.

In a further embodiment, the interactive controller is located in a jurisdiction where real currency credit wagering is allowed, and the application controller is a real currency credit wagering application controller.

In a further embodiment, the interactive controller is located in a jurisdiction where real currency credit wagering is not allowed, and the application controller is a non-wagering application controller.

In a further embodiment, the patron management server is further constructed to: generate application controller instantiation instructions; and instruct an application controller server by communicating the application controller instantiation instructions to the application controller server, and the application controller server is constructed to: receive, from the patron management server, the application controller instantiation instructions; and scan the application controller instantiation instructions to determine the application controller to be instantiated.

In a further embodiment, the instantiated application controller is a subprocess of a parent application controller.

Another embodiment includes an application controller of the configurable user transfer interleaved wagering system constructed to receive, from a patron management server, application session instructions; and the patron management server of the configurable user transfer interleaved wagering system operatively connecting the application controller to an interactive controller using a communication link, the patron management server constructed to: receive, from the interactive controller, an application session request data associated with an interactive application provided by the interactive controller; scan the application session request data to determine location information associated with the interactive controller; determine a location of the interactive controller based on the location information; determine to use the application controller based on the location of the interactive controller, the application controller being one of a plurality of application controllers; generate the application session instructions based on the application controller; dynamically configure the interactive controller by communicating the application session instructions to the interactive controller; and dynamically configure the application controller by communicating the application session instructions to the application controller.

Another embodiment includes an interactive controller of the configurable user transfer interleaved wagering system constructed to: communicate, to a patron management server, application session request data associated with an interactive application provided by the interactive controller; and receive, from the patron management server, application session instructions based on the application session request data; and the patron management server of the configurable user transfer interleaved wagering system operatively connecting the interactive controller to a wager controller, and constructed to: receive, from the interactive controller, the application session request data; scan the application session request data to determine location information associated with the interactive controller; determine a location of the interactive controller based on the location information; determine to use the application controller based on the location of the interactive controller, the application controller being one of a plurality of application controllers; generate application session instructions based on the application controller; dynamically configure the interactive controller by communicating the application session instructions to the interactive controller; and dynamically configure the application controller by communicating the application session instructions to the application controller.

Another embodiment includes a configurable user transfer interleaved skill wagering gaming system, including a player's gaming device operatively connected to an application controller, the player's gaming device, configured to communicate, to a patron management server, application session request data associated with an interactive application provided by the player's gaming device; and receive, from the patron management server, application session instructions based on the application session request data; an application controller constructed to receive, from the patron management server, application session instructions; and the patron management server operatively connecting the player's gaming device and the application controller, and constructed to receive, from the player's gaming device, the application session request data; scan the application session request data to determine location information associated with the player's gaming device; determine a location of the player's gaming device based on the location information; determine to use the application controller based on the location of the player's gaming device, the application controller being one of a plurality of application controllers; generate the application session instructions based on the application controller; dynamically configure the player's gaming device by communicating the application session instructions to the player's gaming device; and dynamically configure the application controller by communicating the application session instructions to the application controller.

A further embodiment includes the player's gaming device and the application controller being constructed from a same device, and where the application controller is operatively connected to a real credit controller using a communication link.

In many embodiments a real credit controller and the application controller are constructed from a same device, and where the application controller is operatively connected to the player's gaming device using a communication link.

In various embodiments the player's gaming device comprises a global positioning system (GPS) receiver, where the location information is generated using the GPS receiver.

In many embodiments the patron management server determines the location of the player's gaming device by generating location information request instructions using the location information; instructing a geolocation server by communicating the location information request instructions to the geolocation server; receiving, from the geolocation server, player's gaming device location data; and scanning the player's gaming device location data to determine the location of the player's gaming device.

In various embodiments the patron management server is further constructed to associate the determined application controller with an application session associated with the player's gaming device.

In many embodiments the patron management server is further constructed to generate application controller instantiation instructions; and instruct an application controller server by communicating the application controller instantiation instructions to the application controller server, and where the application controller server is constructed to receive, from the patron management server, the application controller instantiation instructions; and scan the application controller instantiation instructions to determine the application controller to be instantiated.

In various embodiments the instantiated application controller is a subprocess of a parent application controller.

### BRIEF DESCRIPTION OF THE DRAWINGS

FIG. 1A is a diagram of a structure of a user transfer interleaved wagering system in accordance with various embodiments of the invention.

FIG. 1B is a diagram of a land-based configuration of a user transfer interleaved wagering system in accordance with various embodiments of the invention.

FIG. 1C is another diagram of a land-based configuration of a user transfer interleaved wagering system in accordance with various embodiments of the invention.

FIG. 1D is a diagram of an interactive configuration of a user transfer interleaved wagering system in accordance with various embodiments of the invention.

FIG. 1E is a diagram of a mobile configuration of a user transfer interleaved wagering system in accordance with various embodiments of the invention.

FIGS. 2A, 2B, 2C, and 2D are illustrations of interactive controllers of a user transfer interleaved wagering system in accordance with various embodiments of the invention.

FIGS. 3A, 3B and 3C are diagrams of distributed user transfer interleaved wagering systems in accordance with various embodiments of the invention.

FIGS. 4A and 4B are diagrams of a structure of an interactive controller of a user transfer interleaved wagering system in accordance with various embodiments of the invention.

FIGS. 5A and 5B are diagrams of a structure of a wager controller of a user transfer interleaved wagering system in accordance with various embodiments of the invention.

FIGS. 6A and 6B are diagrams of a structure of an application controller of a user transfer interleaved wagering system in accordance with various embodiments of the invention.

FIGS. 7A and 7B are diagrams of a structure of a user management and session controller of a user transfer interleaved wagering system in accordance with various embodiments of the invention.

FIG. 8 is a sequence diagram of interactions between components of a user transfer interleaved wagering system in accordance with various embodiments of the invention.

FIG. 9 is a collaboration diagram for components of a user transfer interleaved wagering system in accordance with various embodiments of the invention.

FIG. 10 is a diagram of user registration in a user transfer interleaved wagering system in accordance with various embodiments of the invention.

FIG. 11 is a diagram of a user's device in a user transfer interleaved wagering system in accordance with various embodiments of the invention.

FIG. 12 is a diagram of a user registration device in a user transfer interleaved wagering system in accordance with various embodiments of the invention.

FIG. 13 is a diagram of a patron management server in a user transfer interleaved wagering system in accordance with various embodiments of the invention.

FIG. 14 is a sequence diagram of an embodiment of a user transfer interleaved wagering system illustrating establishment of an application session in User Mode.

FIG. 15 is a sequence diagram of an embodiment of a user transfer interleaved wagering system, illustrating establishment of an application session in Wagering-Enabled Mode.

FIG. 16 is a sequence diagram of an embodiment of a user transfer interleaved wagering system.

FIG. 17 is a sequence diagram of an embodiment of a user transfer interleaved wagering system.

FIG. 18 is a sequence diagram of an embodiment of a user transfer interleaved wagering system.

FIG. 19 is a sequence diagram of an embodiment of a user transfer interleaved wagering system.

### DETAILED DESCRIPTION

A user transfer interleaved wagering system interleaves wagering with non-wagering activities. In some embodiments of a user transfer interleaved wagering system an interactive application executed by an interactive controller provides non-wagering components of the user transfer interleaved wagering system. The interactive controller is operatively connected to an application controller that manages and configures the interactive application of the interactive controller and determines when wagers should be interleaved with the operations of the interactive application. The application controller is further operatively connected to a wager controller that provides one or more wagering propositions for one or more wagers.

In some embodiments, the interactive controller also includes a wagering user interface that is used to display data about a wagering process, including but not limited a wager outcome of a wager made in accordance with a wagering proposition. The content of the wagering user interface is controlled by the application controller and includes content provided by the wager controller.

In several embodiments, a user or user interactions are represented in a user transfer interleaved wagering system by the electronic representation of interactions between the user and the interactive application, typically received via a user interface of the interactive application, and a user profile of the user transfer interleaved wagering system associated with the user.

Many different types of interactive applications may be utilized with the user transfer interleaved wagering system. In some embodiments, the interactive application reacts to the physical activity of the user. In these embodiments, the user interacts with the interactive application through one or more sensors that monitor the user's physical activities. Such sensors may include, but are not limited to, physiological sensors that monitor the physiology of the user, environmental sensors that monitor the physical environment of the user, accelerometers that monitor changes in motion of the user, and location sensors that monitor the location of the user such as global positioning sensors.

In some embodiments, the interactive application is a skill-based interactive game that is played by the user.

In some embodiments, the interactive application is a tool used by the user to achieve some useful goal.

In operation, a user interacts with the interactive application using various types of elements of the interactive application in an interactive application environment. Elements are interactive application resources utilized by the user within the interactive application environment to provide an interactive experience for the user. Wagers of credits are made in accordance with a wagering proposition as triggered by the user's use of one or more of the elements of the interactive application. Wager outcomes of wagers of credits made in accordance with the wagering proposition can cause consumption, loss or accrual of credits.

In accordance with some embodiments, wager outcomes of wagering events can influence elements in the interactive application such as, but not limited to, providing one or more new elements, restoring one or more consumed elements, causing the loss of one or more elements, and restoration or placement of one or more fixed elements.

In various embodiments, the wagers may be made using one or more credits (Cr).

In some embodiments, Cr can be one or more credits that are purchased using, and redeemed in, a real world currency having a real world value.

In many embodiments, Cr can be one or more credits in a virtual currency. Virtual currency is an alternate currency that can be acquired, purchased or transferred by or to a user, but does not necessarily directly correlate to a real world currency. In many such embodiments, Cr in a virtual currency are allowed to be purchased using a real world currency but are prevented from being redeemed in a real world currency having a real world value.

In several embodiments, during interaction with the interactive application using the elements, a user can optionally consume and/or accrue application environment credit (AC) within the interactive application as a result of the user's use of the interactive application. AC can be in the form of, but is not limited to, application environment credits, experience points, and points generally.

In various embodiments, when the interactive application is a skill-based interactive game, AC is awarded to a player of the skill-based interactive game on the basis of the player's skillful play of the skill-based interactive game. In such embodiments, AC may be analogous to the score in a typical video game. The skill-based interactive game can have one or more scoring criteria, embedded within an application controller and/or an interactive controller that provides the skill-based interactive game, that reflect user performance against one or more goals of the skill-based interactive game.

In many embodiments, AC can be used to purchase in-application items, including but not limited to, application elements that have particular properties, power ups for existing items, and other item enhancements.

In some embodiments, AC may be used to earn entrance into a sweepstakes drawing, to earn entrance in a tournament with prizes, to score in the tournament, and/or to participate and/or score in any other game event.

In several embodiments, AC can be stored on a user-tracking card or in a network-based user tracking system where the AC is attributed to a specific user.

In many embodiments, a wagering proposition includes a wager of AC for a wager outcome of a randomly generated payout of interactive application AC, elements, and/or objects in accordance with a wagering proposition.

In a number of embodiments, a wager of an amount of Cr results in a wager outcome of a payout of AC, elements, and/or objects that have an Cr value if cashed out.

In some embodiments, in a case that an interactive application is a skill-based interactive game, interactive application objects include in-application objects that may be used by a player of the skill-based interactive game to enhance the player's gameplay of the skill-based interactive game. Such objects include, but are not limited to, power-ups, enhanced in-application items, and the like. In some embodiments, the interactive application objects include objects that are detrimental to the player's play of the skill-based interactive game such as, but not limited to, obstructions in the game space, a temporary player handicap, an enhanced opponent, and the like.

In some embodiments, elements in an interactive application include, but are not limited to, enabling elements (EE) that are interactive application environment resources utilized during the user's use of the interactive application and whose utilization by the user while using the interactive application triggers execution of a wager in accordance with a wagering proposition. In another embodiment, elements in an interactive application include, but are not limited to, a reserve enabling element (REE), that is an element that converts into one or more enabling elements upon occurrence of a release event during an interactive user session. In yet another embodiment, elements in an interactive application include, but are not limited to, an actionable element (AE) that is an element that is acted upon during use of the interactive application to trigger a wager in accordance with a wagering proposition and may or may not be restorable during normal play of the interactive application. In yet another embodiment, elements in an interactive application include, but are not limited to, a common enabling element (CEE) that is an element that may be shared by two or more users and causes a wagering event and associated wager to be triggered in accordance with the wagering proposition when used by one of the users during use of the interactive application. In some embodiments, in progressing through interactive application use, a user can utilize elements during interactions with a controlled entity (CE). A CE is a character, entity, inanimate object, device or other object under control of a user.

In accordance with some embodiments of a user transfer interleaved wagering system, the triggering of the wagering event and/or wager can be dependent upon an interactive application environment variable such as, but not limited to, a required object (RO), a required environmental condition (REC), or a controlled entity characteristic (CEC). A RO is a specific interactive application object in an interactive application acted upon for an AE to be completed. A non-limiting example of an RO is a specific key needed to open a door. An REC is an interactive application state present within an interactive application for an AE to be completed. A non-limiting example of an REC is daylight whose presence enables a character to walk through woods. A CEC is a status of the CE within an interactive application for an AE to be completed. A non-limiting example of a CEC is requirement that a CE have full health points before entering battle. Although various interactive application resources such as, but not limited to, the types of interactive application elements as discussed herein may be used to trigger a wager in accordance with a wagering proposition, one skilled in the art will recognize that any interactive application resource can be utilized in a user transfer interleaved wagering system to trigger of a wager as appropriate to the specification of a specific application in accordance with various embodiments of the invention.

In several embodiments, a user transfer interleaved wagering system can utilize an application controller to monitor use of the interactive application executed by an interactive controller for detecting a trigger of a wagering event. The trigger for the wagering event can be detected by the application controller from the utilization of the interactive application in accordance with at least one wagering event occurrence rule. The trigger of the wagering event can be communicated to a wager controller. In response to notification of the trigger, the wager controller executes a wager in accordance with a wagering proposition. In addition, use of an interactive application in a user transfer interleaved wagering system can be modified by the application controller based upon the wager outcome.

In several embodiments, a wagering event occurrence can be determined from one or more application environment variables within an interactive application that are used to trigger a wager and/or associated wager in accordance with a wagering proposition. Application environment variables can include, but are not limited to, passage of a period of time during user transfer interleaved wagering system interactive application use, a result from a user transfer interleaved wagering system interactive application user session (such as, but not limited to, achieving a goal or a particular score), a user action that is a consumption of an element, or a user action that achieves a combination of elements to be associated with a user profile.

In numerous embodiments, an interactive application instruction is an instruction to an interactive controller and/or an interactive application to modify an interactive application state or modify one or more interactive application resources. In some embodiments, the interactive application instructions may be based upon one or more of a wager outcome and application environment variables. An interactive application instruction can modify any aspect of an interactive application, such as, but not limited to, an addition of a period of time available for a current interactive application user session for the interactive application of user transfer interleaved wagering system, an addition of a period of time available for a future user transfer interleaved wagering system interactive application user session or any other modification to the interactive application elements that can be utilized during interactive application use. In some embodiments, an interactive application instruction can modify a type of element whose consumption triggers a wagering event occurrence. In many embodiments, an interactive application instruction can modify a type of element whose consumption is not required in a wagering event occurrence.

In a number of embodiments, a user interface can be utilized that depicts a status of the interactive application in the user transfer interleaved wagering system. A user interface can depict any aspect of an interactive application including, but not limited to, an illustration of user transfer interleaved wagering system interactive application use advancement as a user uses the user transfer interleaved wagering system.

In some embodiments, a user transfer interleaved wagering system including an application controller operatively connected to a wager controller and operatively connected to an interactive controller may provide for interleaving entertainment content from an interactive application. The user transfer interleaved wagering system provides for random wager outcomes in accordance with the wagering proposition that are independent of user skill while providing an interactive experience to the user that may be shaped by the user's skill.

In several embodiments, an application controller of a user transfer interleaved wagering system may provide for a communications interface for asynchronous communications between a wager controller and an interactive application provided by an interactive controller, by operatively connecting the interactive controller, and thus the interactive controller's interactive application, with the wager controller. In some embodiments, asynchronous communications provided for by a user transfer interleaved wagering system may reduce an amount of idle waiting time by an interactive controller of the user transfer interleaved wagering system, thus increasing an amount of processing resources that the interactive controller may provide to an interactive application or other processes of the interactive controller. In many embodiments, asynchronous communications provided for by a user transfer interleaved wagering system reduces an amount of idle waiting time by a wager controller, thus increasing an amount of processing resources that the wager controller may provide to execution of wagers to determine wager outcomes, and other processes provided by the wager controller. In some embodiments, a wager controller of a user transfer interleaved wagering system may be operatively connected to a plurality of interactive controllers through one or more application controllers and the asynchronous communications provided for by the one or more application controllers allows the wager controller to operate more efficiently and provide wager outcomes to a larger number of interactive controllers than would be achievable without the one or more application controllers of the user transfer interleaved wagering system.

In some embodiments, a user transfer interleaved wagering system including an application controller operatively connected to a wager controller and operatively connected to an interactive controller may provide for simplified communication protocols for communications of the interactive controller as the interactive controller may communicate user interactions with an interactive application provided by the interactive controller to the application controller without regard to a nature of a wagering proposition to be interleaved with processes of the interactive application.

In various embodiments, a user transfer interleaved wagering system including an application controller operatively connected to a wager controller and operatively connected to an interactive controller may provide for simplified communication protocols for communications of the wager controller as the wager controller may receive wager requests and communicate wager outcomes without regard to a nature of an interactive application provided by the interactive controller.

### User Transfer Wagering Interleaved Systems

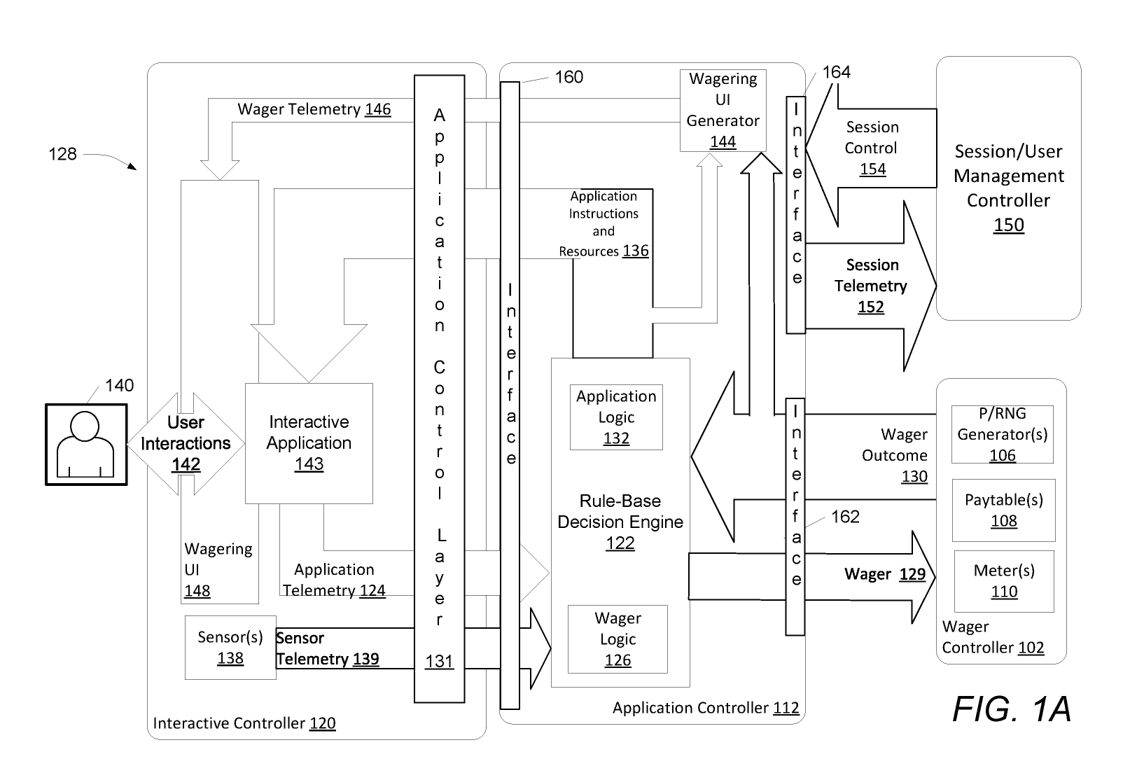

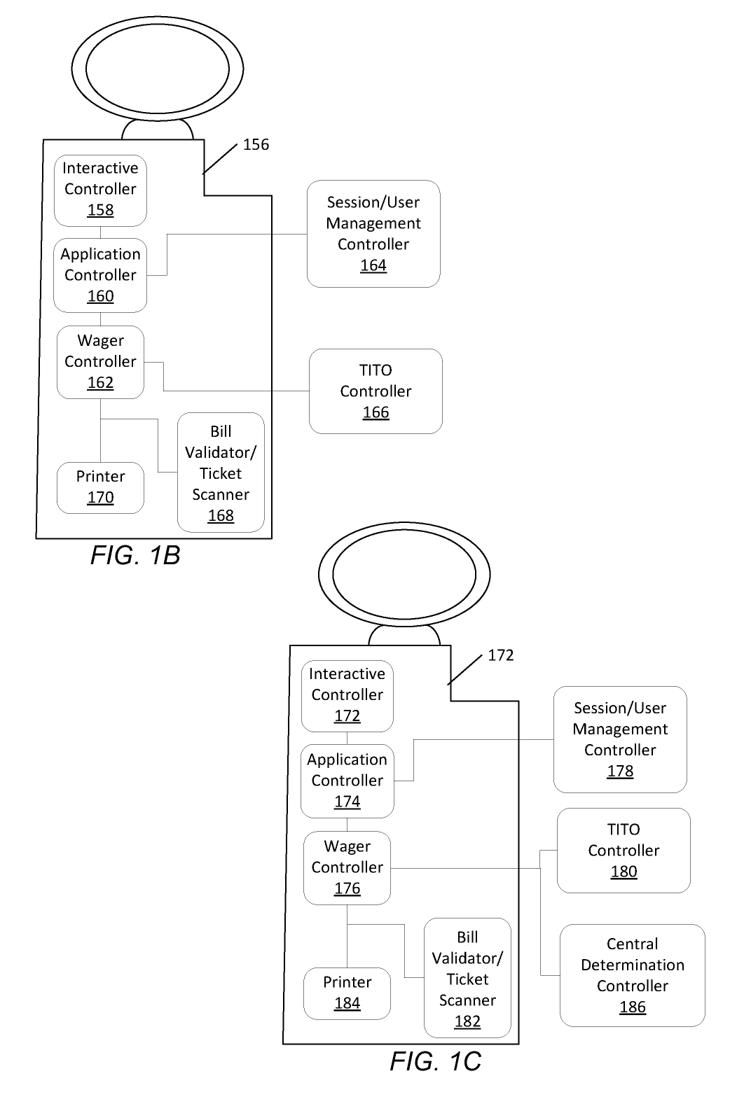

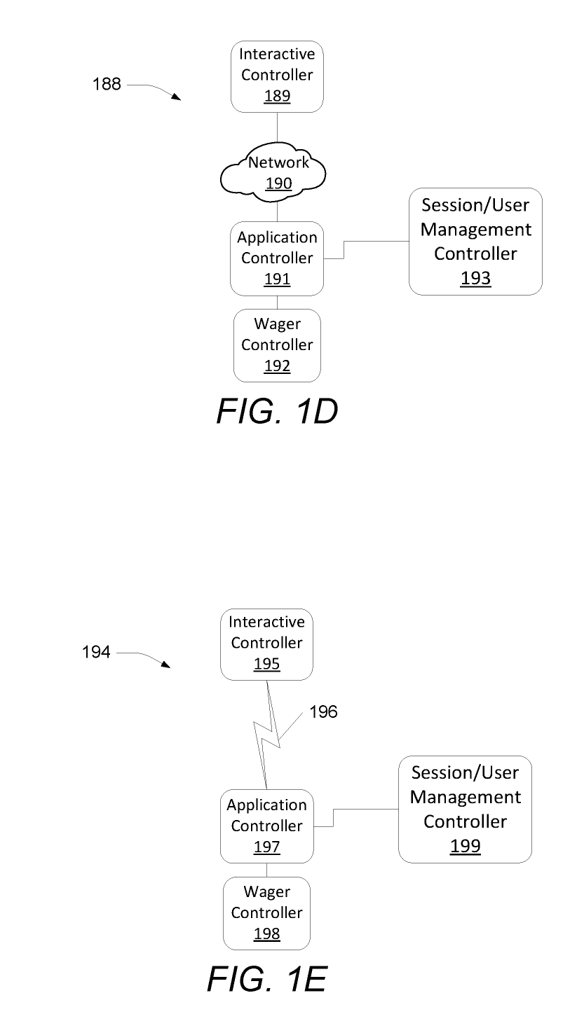

FIG. 1A is a diagram of a structure of a user transfer interleaved wagering system in accordance with various embodiments of the invention. The user transfer interleaved wagering system 128 includes an interactive controller 120, an application controller 112, and a wager controller 102. The interactive controller 120 is operatively connected to, and communicates with, the application controller 112. The application controller 112 is also operatively connected to, and communicates with, the wager controller 102.

In several embodiments, the wager controller 102 is a controller for providing one or more wagering propositions provided by the user transfer interleaved wagering system 128 and executes wagers in accordance with the wagering propositions. Types of value of a wager can be one or more of several different types. Types of value of a wager can include, but are not limited to, a wager of an amount of Cr corresponding to a real currency or a virtual currency, a wager of an amount of AC earned by the player through use of an interactive application, a wager of an amount of elements of an interactive application, and a wager of an amount of objects used in an interactive application. A wager outcome determined for a wager in accordance with a wagering proposition can increase or decrease an amount of the type of value used in the wager, such as, but not limited to, increasing an amount of Cr for a wager of Cr. In various embodiments, a wager outcome determined for a wager in accordance with a wagering proposition can increase or decrease an amount of a type of value that is different than a type of value of the wager, such as, but not limited to, increasing an amount of an object of an interactive application for a wager of Cr.

In many embodiments, the wager controller 120 includes one or more pseudo random or random number generators (P/RNG) 106 for generating random results, one or more paytables 108 for determining a wager outcome from the random results, and one or more credit or value meters 110 for storing amounts of wagered and won credits.

The one or more P/RNG generators 106 execute processes that can generate random or pseudo random results. The one or more paytables 108 are tables that can be used in conjunction with the random or pseudo random results to determine a wager outcome including an amount of Cr, AC, elements or objects won as a function of user transfer interleaved wagering system use. There can be one or more paytables 108 in the wager controller 102. The paytables 108 are used to implement one or more wagering propositions in conjunction with a random output of the random or pseudo random results.

In some embodiments, selection of a paytable to use to execute a wager can be based on factors including, but not limited to, interactive application progress a user has achieved through use of the interactive application, user identification, and eligibility of the user for bonus rounds.

In various embodiments, the interactive controller 120 provides an interactive application 143 and provides human input devices (HIDs) and output devices for interacting with the user 140. The interactive controller 120 provides for user interactions 142 with the interactive application 143 by receiving input from a user through the HIDs and providing outputs such as video, audio and/or other sensory output to the user using the output devices.

The interactive controller 120 is operatively connected to, and communicates with, the application controller 112. The interactive controller communicates application telemetry data 124 to the application controller 112 and receives application instructions and resources 136 from the application controller 112. Via the communication of application instructions and resources 136, the application controller 112 can communicate certain interactive application resources including control parameters to the interactive application 143 to affect the interactive application's execution by the interactive controller 120. In various embodiments, these interactive application control parameters can be based on a wager outcome of a wager that was triggered by an element in the interactive application being utilized or acted upon by the user.

In some embodiments, execution of the interactive application by the interactive controller 120 communicates user interactions with the interactive application to the application controller 112. The application telemetry data 124 includes, but is not limited to, the user's utilization of the elements in the interactive application.

In some embodiments, the interactive application 143 is a skill-based interactive game. In such embodiments, execution of the skill-based interactive game by the interactive controller 120 is based on the user's skillful play of the skill-based interactive game. The interactive controller 120 can also communicate user choices made in the skill-based interactive game to the application controller 112 included in the application telemetry data 124 such as, but not limited to, the user's utilization of the elements of the skill-based interactive game during the user's skillful play of the skill-based interactive game. In such an embodiment, the application controller is interfaced to the interactive controller 120 in order to allow the coupling of the skill-based interactive game to wagers made in accordance with a wagering proposition.

In some embodiments, the interactive controller 120 includes one or more sensors 138 that sense various aspects of the physical environment of the interactive controller 120. Examples of sensors include, but are not limited to: global positioning sensors (GPSs) for sensing communications from a GPS system to determine a position or location of the interactive controller; temperature sensors; accelerometers; pressure sensors; and the like. Sensor telemetry data 128 is communicated by the interactive controller to the application controller 112. The application controller 112 receives the sensor telemetry data 128 and uses the sensor telemetry data to make wager decisions.

In many embodiments, the interactive controller includes a wagering user interface 148 used to display wagering data to the user.

In various embodiments, an application control layer 131 resident in the interactive controller 120 provides an interface between the interactive controller 120 and the application controller 112. The application control layer 131 implements an interactive controller to application controller communication protocol employing a device-to-device communication protocol

In some embodiments, the application controller 112 includes an interactive controller interface 160 to an interactive controller. The interactive controller interface 160 provides for the communication of data between the interactive controller and the application controller, including but not limited to wager telemetry data 146, application instructions and resources 136, application telemetry data 124, and sensor telemetry data 128.

In many embodiments, application controller 112 provides an interface between the interactive application 143 provided by the interactive controller 120 and a wagering proposition provided by the wager controller 102.

In various embodiments, the application controller 112 includes a wager controller interface 162 to a wager controller. The wager controller interface 162 provides for communication of data between the application controller 112 and the wager controller, including but not limited to wager outcome data 130 and wager execution instructions 129.

In some embodiments, the application controller 112 includes a user management and session controller interface 164 to a user management and session controller. The user management and session controller interface 164 provides for communication of data between the application controller 112 and the user management and session controller, including but not limited to user session control data 154 and user session telemetry data 152.

The application controller 112 includes a rule-based decision engine 122 that receives telemetry data, such as application telemetry data 124 and sensor telemetry data 128, from the interactive controller 120. The rule-based decision engine 122 uses the telemetry data, along with trigger logic 126 to generate wager execution instructions 129 that are used by the application controller 112 to instruct the wager controller 120 to execute a wager. The wager execution data is communicated by the application controller 112 to the wager controller 102. The wager controller 102 receives the wager execution instructions 129 and executes a wager in accordance with the wager execution instructions.

In some embodiments, the application telemetry data 124 includes, but is not limited to, application environment variables that indicate the state of the interactive application 143 being used by a user 140, interactive controller data indicating the state of the interactive controller, and user actions and interactions 142 between the user and the interactive application 143 provided by the interactive controller 120. The wager execution instructions 129 may include, but are not limited to, an amount and type of the wager, a trigger of the wager, and a selection of a paytable 108 to be used when executing the wager.

In some embodiments, the rule-based decision engine 122 also receives wager outcome data 130 from the wager controller 102. The decision engine 122 uses the wager outcome data 130, in conjunction with the telemetry data and application logic 132 to generate application decisions 134 communicated to an application resource generator 138. The application resource generator 138 receives the application decisions and uses the application decisions to generate application instructions and application resources 136 to be communicated to the interactive application 143.

In some embodiments, the wager outcome data 130 includes game state data about execution of a gambling game that underlies a wagering proposition, including but not limited to a final state, intermediate state and/or beginning state of the gambling game. For example, in a gambling game that is a slot math-based game, the final state of the gambling game may be reel positions, in a gambling game that is a roulette wheel-based game, the final state may be a pocket where a ball may have come to rest, in a gambling game that is a card-based game, the beginning, intermediate and final states may represent a play of cards, etc.

In many embodiments, the application controller 112 includes a pseudo random or random result generator used to generate random results that are communicated to the application resource generator 138. The application resource generator 138 uses the random results to generate application instructions and application resources 136 used by the application controller 112 to instruct the interactive controller 120.

In various embodiments, the rule-based decision engine 122 also determines an amount of AC to award to the user 140 based at least in part on the user's use of the interactive application of the user transfer interleaved wagering system as determined from the application telemetry data 124. In some embodiments, wager outcome data 130 may also be used to determine the amount of AC that should be awarded to the user.

In numerous embodiments, the interactive application is a skill-based interactive game and the AC is awarded to the user for the user's skillful play of the skill-based interactive game.

In some embodiments, the application decisions 134 and wager outcome data 130 are communicated to a wagering user interface generator 144. The wagering user interface generator 144 receives the application decisions 134 and wager outcome data 130 and generates wager telemetry instructions 146 used by the application controller 112 to instruct the interactive controller to generate a wagering user interface 148 describing the state of wagering and credit accumulation and loss for the user transfer interleaved wagering system. In some embodiments, the wager telemetry data 146 may include, but is not limited to, amounts of AC and elements earned, lost or accumulated by the user through use of the interactive application as determined from the application decisions, and Cr amounts won, lost or accumulated as determined from the wager outcome data 130 and the one or more meters 110.

In some embodiments, the wager outcome data 130 also includes data about one or more game states of a gambling game executed in accordance with a wagering proposition by the wager controller 102. In various such embodiments, the wagering user interface generator 144 generates a gambling game process display and/or gambling game state display using the one or more game states of the gambling game. The gambling game process display and/or gambling game state display is included in the wager telemetry data 146 that is communicated to the interactive controller 120. The gambling game process display and/or a gambling game state display is displayed by the wagering user interface 148 to the user 140. In other such embodiments, the one or more game states of the gambling game are communicated to the interactive controller 120 and the interactive controller 120 is instructed to generate the gambling game process display and/or gambling game state display of the wagering user interface 148 using the one or more game states of the gambling game for display to the user 140.

The application controller 112 can further operatively connect to the wager controller 102 to determine an amount of credit or elements available and other wagering metrics of a wagering proposition. Thus, the application controller 112 may potentially affect an amount of Cr in play for participation in the wagering events of a gambling game provided by the wager controller 102 in some embodiments. The application controller 112 may additionally include various audit logs and activity meters. In some embodiments, the application controller 112 can also couple to a centralized server for exchanging various data related to the user and the activities of the user during game play of a user transfer interleaved wagering system.

In many embodiments, one or more users can be engaged in using the interactive application executed by the interactive controller 120. In various embodiments, a user transfer interleaved wagering system can include an interactive application that provides a skill-based interactive game that includes head-to-head play between a single user and a computing device, between two or more users against one another, or multiple users playing against a computer device and/or each other. In some embodiments, the interactive application can be a skill-based interactive game where the user is not skillfully playing against the computer or any other user such as skill-based interactive games where the user is effectively skillfully playing against himself or herself.

In some embodiments, the operation of the application controller 112 does not affect the provision of a wagering proposition by the wager controller 102 except for user choice parameters that are allowable in accordance with the wagering proposition. Examples of user choice parameters include, but are not limited to: wager terms such as but not limited to a wager amount; speed of game play (for example, by pressing a button or pulling a handle of a slot machine); and/or agreement to wager into a bonus round.

In various embodiments, wager outcome data 130 communicated from the wager controller 102 can also be used to convey a status operation of the wager controller 102.

In a number of embodiments, communication of the wager execution instructions 129 between the wager controller 102 and the application controller 112 can further be used to communicate various wagering control factors that the wager controller 102 uses as input. Examples of wagering control factors include, but are not limited to, an amount of Cr, AC, elements, or objects consumed per wagering event, and/or the user's election to enter a jackpot round.

In some embodiments, the application controller 112 utilizes the wagering user interface 148 to communicate certain interactive application data to the user, including but not limited to, club points, user status, control of the selection of choices, and messages which a user can find useful in order to adjust the interactive application experience or understand the wagering status of the user in accordance with the wagering proposition in the wager controller 102.

In some embodiments, the application controller 112 utilizes the wagering user interface 148 to communicate aspects of a wagering proposition to the user including, but not limited to, odds of certain wager outcomes, amount of Cr, AC, elements, or objects in play, and amounts of Cr, AC, elements, or objects available.

In a number of embodiments, the wager controller 102 can accept wager proposition factors including, but not limited to, modifications in the amount of Cr, AC, elements, or objects wagered on each individual wagering event, a number of wagering events per minute the wager controller 102 can resolve, entrance into a bonus round, and other factors. An example of a varying wager amount that the user can choose can include, but is not limited to, using a more difficult interactive application level associated with an amount of a wager. These factors can increase or decrease an amount wagered per individual wagering proposition in the same manner that a standard slot machine player can decide to wager more or less credits for each pull of the handle. In several embodiments, the wager controller 102 can communicate a number of factors back and forth to the application controller 112, via an interface, such that an increase/decrease in a wagered amount can be related to the change in user profile of the user in the interactive application. In this manner, a user can control a wager amount per wagering event in accordance with the wagering proposition with the change mapping to a parameter or component that is applicable to the interactive application experience.

In some embodiments, a user management and session controller 150 is used to authorize a user transfer interleaved wagering system user session. The user management and session controller receives game user session data 152, that may include, but is not limited to, user, interactive controller, application controller and wager controller data from the application controller 112. The user management and session controller 150 uses the user, interactive controller, application controller and wager controller data to regulate a user transfer interleaved wagering system user session. In some embodiments, the user management and session controller 150 may also assert control of a user transfer interleaved wagering system game user session 154. Such control may include, but is not limited to, ending a user transfer interleaved wagering system game user session, initiating wagering in a user transfer interleaved wagering system game user session, ending wagering in a user transfer interleaved wagering system game user session but not ending a user's play of the interactive application portion of the user transfer interleaved wagering system, and changing from real credit wagering in a user transfer interleaved wagering system to virtual credit wagering, or vice versa.

In many embodiments, the user management and session controller 150 manages user profiles for a plurality of users. The user management and session controller 150 stores and manages data about users in order to provide authentication and authorization of users of the user transfer interleaved wagering system 128. In some embodiments, the user management and session controller 150 also manages geolocation information to ensure that the user transfer interleaved wagering system i128 is only used by users in jurisdictions were gaming is approved. In various embodiments, the user management and session controller 150 stores application credits that are associated with the user's use of the interactive application of the user transfer interleaved wagering system 128.

In various embodiments, the application controller operates as an interface between the interactive controller and the wager controller. By virtue of this construction, the wager controller is isolated from the interactive controller allowing the interactive controller to operate in an unregulated environment will allowing the wager controller to operate in a regulated environment.

In some embodiments, a single wager controller may provide services to two or more interactive controllers and/or two or more application controllers, thus allowing a user transfer interleaved wagering system to operate over a large range of scaling.

In various embodiments, multiple types of interactive controllers using different operating systems may be interfaced to a single type of application controller and/or wager controller without requiring customization of the application controller and/or the wager controller.

In many embodiments, an interactive controller may be provided as a user device under control of a user while maintaining the wager controller in an environment under the control of a regulated operator of wagering equipment.

In several embodiments, data communicated between the controllers may be encrypted to increase security of the user transfer interleaved wagering system.

In some embodiments, the application controller isolates trigger logic and application logic as unregulated logic from a regulated wager controller, thus allowing errors in the application logic and/or trigger logic to be corrected, new application logic and/or trigger logic to be used, or modifications to be made to the application logic and/or trigger logic without a need for regulatory approval.

In various embodiments, an interactive application may require extensive processing resources from an interactive controller leaving few processing resources for the functions performed by an application controller and/or a wager controller. By virtue of the architecture described herein, processing loads may be distributed across multiple devices such that operations of the interactive controller may be dedicated to the interactive application and the processes of the application controller and/or wager controller are not burdened by the requirements of the interactive application.

In many embodiments, a user transfer interleaved wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a user transfer interleaved wagering system are distributed in close proximity to each other and communicate using a local area network and/or a communication bus. In several embodiments, an interactive controller and an application controller of a user transfer interleaved wagering system are in a common location and communicate with an external wager controller. In some embodiments, an application controller and a wager controller of a user transfer interleaved wagering system are in a common location and communicate with an external interactive controller. In many embodiments, an interactive controller, an application controller, and a wager controller of a user transfer interleaved wagering system are located in a common location. In some embodiments, a user management and session controller is located in a common location with an application controller and/or a wager controller.

In various embodiments, These multiple devices can be constructed from or configured using a single server or a plurality of servers such that a user transfer interleaved wagering system is executed as a system in a virtualized space such as, but not limited to, where a wager controller and an application controller are large scale centralized servers in the cloud operatively connected to widely distributed interactive controllers via a wide area network such as the Internet or a local area network. In such embodiments, the components of a user transfer interleaved wagering system may communicate using a networking protocol or other type of device-to-device communications protocol.

In many embodiments, a centralized wager controller is operatively connected to, and communicates with, one or more application controllers using a communication link. The centralized wager controller can generate wager outcomes for wagers in accordance with one or more wagering propositions. The centralized wager controller can execute a number of simultaneous or pseudo-simultaneous wagers in order to generate wager outcomes for a variety of wagering propositions that one or more distributed user transfer interleaved wagering systems can use.

In several embodiments, a centralized application controller is operatively connected to one or more interactive controllers and one or more wager controllers using a communication link. The centralized application controller can perform the functionality of an application controller across various user transfer interleaved wagering systems.

In a variety of embodiments, management of user profile data can be performed by a user management and session controller operatively connected to, and communicating with, one or more application controllers, wager controllers and interactive controllers using a communication link. A user management and session controller can manage data related to a user profile. The managed data in the user profile may include, but is not limited to, data concerning controlled entities (characters) in interactive application use, user performance metrics for a type or class of interactive application, interactive application elements acquired by a user; Cr and AC associated with a particular user, and tournament reservations.

Although a user management and session controller is discussed as being separate from an application controller server, a centralized application controller server may also perform the functions of a user management and session controller in some embodiments.

In numerous embodiments, an interactive application server provides a host for managing head-to-head play operating over a network of interactive controllers connected to the interactive application server using a communication link. The interactive application server provides an environment where users can compete directly with one another and interact with other users.

Processing devices connected using a communication link to construct user transfer interleaved wagering systems in accordance with many embodiments of the invention can communicate with each other to provide services utilized by a user transfer interleaved wagering system. In several embodiments, a wager controller can communicate with an application controller using a communication link. In some embodiments, the wager controller can communicate with an application controller to communicate any type of data as appropriate for a specific application. Examples of the data that may be communicated include, but are not limited to, data used to configure the various simultaneous or pseudo simultaneous wager controllers executing in parallel within the wager controller to accomplish user transfer interleaved wagering system functionalities; data used to determine metrics of wager controller performance such as wagers run and/or wager outcomes for tracking system performance; data used to perform audits and/or provide operator reports; and data used to request the results of a wager outcome for use in one or more function(s) operating within the application controller such as, but not limited to, automatic drawings for prizes that are a function of interactive controller performance.

In several embodiments, an application controller can communicate with an interactive application server using a communication link when the interactive application server is also communicating with one or more interactive controllers using a communication link. An application controller can communicate with an interactive application server to communicate any type of data as appropriate for a specific application. The data that may be communicated between an application controller and an interactive application server includes, but is not limited to, the data for management of an interactive application server by an application controller server during a user transfer interleaved wagering system tournament. In an example embodiment, an application controller may not be aware of the relationship of the application controller to the rest of a tournament since the actual tournament play may be managed by the interactive application server. Therefore, management of a user transfer interleaved wagering system can include, but is not limited to tasks including, but not limited to, conducting tournaments according to system programming that can be coordinated by an operator of the user transfer interleaved wagering system; allowing entry of a particular user into a tournament; communicating the number of users in a tournament; and the status of the tournament (such as, but not limited to the amount of surviving users, the status of each surviving user within the game, and time remaining on the tournament); communicating the performance of users within the tournament; communicating the scores of the various users in the tournament; and providing a synchronizing link to connect the application controllers in a tournament with their respective interactive controllers.

In several embodiments, an application controller can communicate with a user management and session controller using a communication link. An application controller can communicate with a user management and session controller to communicate any type of data as appropriate for a specific application. Examples of data communicated between an application controller and a user management and session controller include, but are not limited to, data for configuring tournaments according to system programming conducted by an operator of a user transfer interleaved wagering system; data for exchange of data used to link a user's user profile to an ability to participate in various forms of user transfer interleaved wagering system use (such as but not limited to the difficulty of play set by the application controller server for an interactive application that is a skill-based interactive game); data for determining a user's ability to participate in a tournament as a function of a user's characteristics (such as but not limited to a user's prowess or other metrics used for tournament screening); data for configuring application controller and interactive controller performance to suit preferences of a user on a particular user transfer interleaved wagering system; and data for determining a user's use and wagering performance for the purposes of marketing intelligence; and data for logging secondary drawing awards, tournament prizes, Cr and/or AC into the user profile.

In many embodiments, a user transfer interleaved wagering system can be distributed across one or more processing devices, with the actual location of where various process are executed being located either on an end device (user management and session controller, wager controller, application controller, interactive controller), on servers (user management and session controller, wager controller, application controller, or interactive application server), or a combination of both end devices and servers. In a number of embodiments, certain functions of a wager controller, application controller, and/or interactive application server can operate on a local wager controller, local application controller and/or local interactive controller used to construct a user transfer interleaved wagering system being provided locally on a device. In some embodiments, a controller or server can be part of a server system including multiple servers, where applications can be run on one or more physical devices. Similarly, in particular embodiments, multiple servers can be combined on a single physical device.

In many embodiments, a user transfer interleaved wagering system can be distributed across one or more processing devices that are in close proximity to each other, such as a common enclosure. In such an embodiment, the one or more processing devices can be operatively connected using communication links that incorporate an interdevice communication protocol over a serial or parallel physical link.

FIG. 1B is a diagram of a land-based configuration of a user transfer interleaved wagering system in accordance with various embodiments of the invention. Land-based configurations are suitable for deployment in a gaming establishment. A land-based configuration of a user transfer interleaved wagering system 156 includes an interactive controller 158, an application controller 160 and a wager controller 162 housed in a common enclosure. The application controller 160 is operatively connected to an external session/user management controller 164. The wager controller 162 is operatively connected to a ticket-in-ticket-out (TITO) controller 166 or other type of credit controller. The wager controller 162 communicates with the TITO controller 166 to obtain amounts of credits used for wagering. In operation, the wager controller 162 uses a bill validator/ticket scanner 168 to scan a TITO ticket having indicia of credit account data of a credit account of the TITO controller 166. The wager controller 162 communicates the credit account data to the TITO controller 166. The TITO controller 166 uses the credit account data to determine an amount of credits to transfer to the wager controller 162. The TITO controller 166 communicates the amount of credits to the wager controller 162. The wager controller 162 credits the one or more credit meters with the amount of credits so that the credits can be used when a user makes wagers using the user transfer interleaved wagering system 156. In addition, the wager controller 162 can use the TITO controller 166 along with a ticket printer 170 to generate a TITO ticket for a user. In operation, the wager controller 162 communicates an amount of credits for a credit account on the TITO controller 166. The TITO controller 166 receives the amount of credits and creates the credit account and credits the credit account with the amount of credits. The TITO controller 166 generates credit account data for the credit account and communicates the credit account data to the wager controller 162. The wager controller 162 uses the ticket printer 170 to print indicia of the credit account data onto a TITO ticket.

FIG. 1B is a diagram of another land-based configuration of a user transfer interleaved wagering system in accordance with various embodiments of the invention. A land-based configuration of a user transfer interleaved wagering system 172 includes an interactive controller 172, an application controller 174 and a wager controller 176 housed in a common enclosure. The application controller 174 is operatively connected to an external session/user management controller 178. The wager controller 176 is operatively connected to a ticket-in-ticket-out (TITO) controller 180 or other type of credit controller. The wager controller 176 communicates with the TITO controller 180 to obtain amounts of credits used for wagering. In operation, the wager controller 176 uses a bill validator/ticket scanner 182 to scan a TITO ticket having indicia of credit account data of a credit account of the TITO controller 180. The wager controller 176 communicates the credit account data to the TITO controller 180. The TITO controller 180 uses the credit account data to determine an amount of credits to transfer to the wager controller 176. The TITO controller 180 communicates the amount of credits to the wager controller 176. The wager controller 176 receives the amount of credits and credits the one or more credit meters with the amount of credits so that the credits can be used when a user makes wagers using the user transfer interleaved wagering system 172. In addition, the wager controller 176 can use the TITO controller 180 along with a ticket printer 184 to generate a TITO ticket for a user. In operation, the wager controller 176 communicates an amount of credits for a credit account on the TITO controller 180. The TITO controller 180 receives the amount of credits and creates the credit account and credits the credit account with the amount of credits. The TITO controller 180 generates credit account data for the credit account and communicates the credit account data to the wager controller 176. The wager controller 176 uses the ticket printer 184 to print indicia of the credit account data onto a TITO ticket.

The wager controller 176 is operatively connected to a central determination controller 186. In operation, when the wager controller 176 needs to determine a wager outcome, the wager controller communicates a request to the central determination controller 186 for the wager outcome. The central determination controller 186 receives the wager outcome request and generates a wager outcome in response to the wager request. The central determination controller 186 communicates the wager outcome to the wager controller 176. The wager controller 176 receives the wager outcome and utilizes the wager outcome as described herein. In some embodiments, the wager outcome is drawn from a pool of pre-determined wager outcomes. In some embodiments, the wager outcome is a pseudo random result or random result that is utilized by the wager controller along with paytables to determine a wager outcome as described herein.

FIG. 1D is a diagram of an interactive configuration of a user transfer interleaved wagering system in accordance with various embodiments of the invention. An interactive configuration of a user transfer interleaved wagering system is useful for deployment over a wide area network such as an internet. An interactive configuration of a user transfer interleaved wagering system 188 includes an interactive controller 189 operatively connected by a network 190 to an application controller 191, and a wager controller 192. The application controller 191 is operatively connected to a session/user management controller 193.

FIG. 1E is a diagram of a mobile configuration of a user transfer interleaved wagering system in accordance with various embodiments of the invention. A mobile configuration of a user transfer interleaved wagering system is useful for deployment over wireless communication network, such as a wireless local area network or a wireless telecommunications network. An interactive configuration of a user transfer interleaved wagering system 194 includes an interactive controller 195 operatively connected by a wireless network 196 to an application controller 197, and a wager controller 198. The application controller 197 is also operatively connected to a session/user management controller 199.

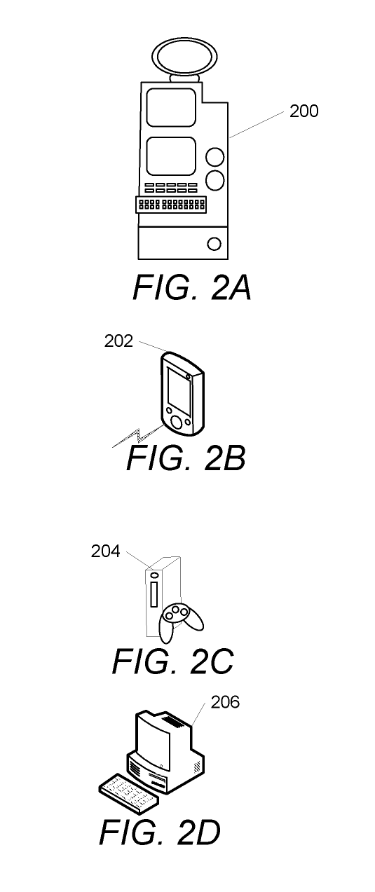

FIGS. 2A, 2B, 2C, and 2D are illustrations of interactive controllers of a user transfer interleaved wagering system in accordance with various embodiments of the invention. An interactive controller, such as interactive controller 120 of FIG. 1A, may be constructed from or configured using one or more processing devices configured to perform the operations of the interactive controller. An interactive controller in a user transfer interleaved wagering system may be constructed from or configured using any processing device having sufficient processing and communication capabilities that may be configured to perform the processes of an interactive controller in accordance with various embodiments of the invention. In some embodiments, the construction or configuration of the interactive controller may be achieved through the use of an application control layer, such as application control layer 131 of FIG. 1A, and/or through the use of an interactive application, such as interactive application 143 of FIG. 1A.

In some embodiments, an interactive controller may be constructed from or configured using an electronic gaming machine 200 as shown in FIG. 2A. The electronic gaming machine 200 may be physically located in various types of gaming establishments.

In many embodiments, an interactive controller may be constructed from or configured using a portable device 202 as shown in FIG. 2B. The portable device 202 is a device that may wirelessly connect to a network. Examples of portable devices include, but are not limited to, a tablet computer, a personal digital assistant, and a smartphone.

In some embodiments, an interactive controller may be constructed from or configured using a gaming console 204 as shown in FIG. 2C.

In various embodiments, an interactive controller may be constructed from or configured using a personal computer 206 as shown in FIG. 2D.

In some embodiments, a device, such as the devices of FIGS. 2A, 2B, 2C, and 2D, may be used to construct a complete user transfer interleaved wagering system and may be operatively connected using a communication link to a session and/or user management controller, such as session and/or user management controller 150 of FIG. 1A.

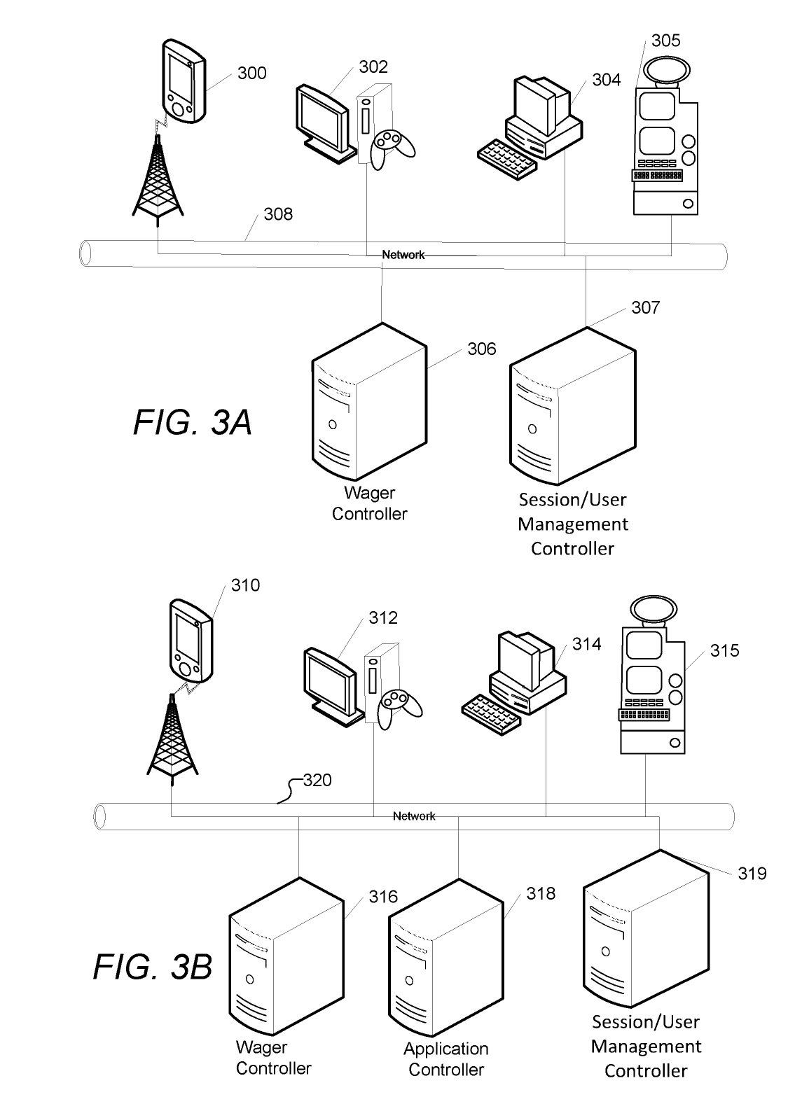

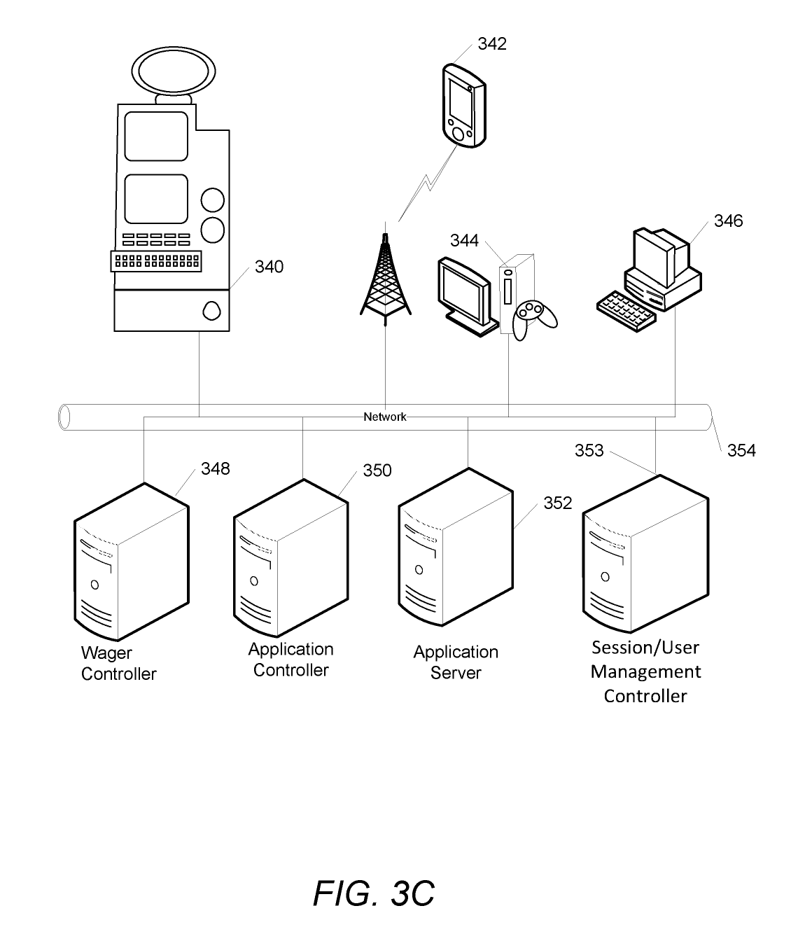

Some user transfer interleaved wagering systems in accordance with many embodiments of the invention can be distributed across a plurality of devices in various configurations. FIGS. 3A, 3B and 3C are diagrams of distributed user transfer interleaved wagering systems in accordance with various embodiments of the invention. Turning now to FIG. 3A, one or more interactive controllers of a distributed user transfer interleaved wagering system, such as but not limited to, a mobile or wireless device 300, a gaming console 302, a personal computer 304, and an electronic gaming machine 305, are operatively connected with a wager controller 306 of a distributed user transfer interleaved wagering system using a communication link 308. Communication link 308 is a communications link that allows processing systems to communicate with each other and to share data. Examples of the communication link 308 can include, but are not limited to: a wired or wireless interdevice communication link, a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and an application controller as described herein are executed on the individual interactive controllers 300, 302, 304 and 305 while one or more processes of a wager controller as described herein can be executed by the wager controller 306.

In many embodiments, a distributed user transfer interleaved wagering system and may be operatively connected using a communication link to a session and/or user management controller 307, that performs the processes of a session and/or user management controller as described herein.

A distributed user transfer interleaved wagering system in accordance with another embodiment of the invention is illustrated in FIG. 3B. As illustrated, one or more interactive controllers of a distributed user transfer interleaved wagering system, such as but not limited to, a mobile or wireless device 310, a gaming console 312, a personal computer 314, and an electronic gaming machine 315, are operatively connected with a wager controller server 316 and an application controller 318 over a communication link 320. Communication link 320 is a communication link that allows processing systems to communicate and share data. Examples of the communication link 320 can include, but are not limited to: a wired or wireless interdevice communication link, a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, the processes of an interactive controller as described herein are executed on the individual interactive controllers 310, 312, 314 and 315. One or more processes of a wager controller as described herein are executed by the wager controller 316, and one or more processes of an application controller as described herein are executed by the application controller 318.

In many embodiments, a distributed user transfer interleaved wagering system and may be operatively connected using a communication link to a session and/or user management controller 319, that performs the processes of a session and/or user management controller as described herein.

A distributed user transfer interleaved wagering systems in accordance with still another embodiment of the invention is illustrated in FIG. 3C. As illustrated, one or more interactive controllers of a distributed user transfer interleaved wagering system, such as but not limited to, a mobile device 342, a gaming console 344, a personal computer 346, and an electronic gaming machine 340 are operatively connected with a wager controller 348 and an application controller 350, and an interactive application server 352 using a communication link 354. Communication link 354 is a communications link that allows processing systems to communicate and to share data. Examples of the communication link 354 can include, but are not limited to: a wired or wireless interdevice communication link, a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of a display and user interface of an interactive controller as described herein are executed on the individual interactive controllers 340, 342, 344 and 346. One or more processes of a wager controller as described herein can be executed by the wager controller server 348. One or more processes of an application controller as described herein can be executed by the application controller server 350 and one or more processes of an interactive controller excluding the display and user interfaces can be executed by the interactive application server 352.

In many embodiments, a distributed user transfer interleaved wagering system and may be operatively connected using a communication link to a session and/or user management controller 353, that performs the processes of a session and/or user management controller as described herein.

In various embodiments, a user management and session controller may be operatively connected to components of a user transfer interleaved wagering system using a communication link. In other embodiments, a number of other peripheral systems, such as a user management system, a gaming establishment management system, a regulatory system, and/or hosting servers are also operatively connected with the user transfer interleaved wagering systems using a communication link. Also, other servers can reside outside the bounds of a network within a firewall of the operator to provide additional services for network connected user transfer interleaved wagering systems.

Although various distributed user transfer interleaved wagering systems are described herein, user transfer interleaved wagering systems can be distributed in any configuration as appropriate to the specification of a specific application in accordance with embodiments of the invention. In some embodiments, components of a distributed user transfer interleaved wagering system, such as an application controller, wager controller, interactive controller, or other servers that perform services for an application controller, wager controller and/or interactive controller, can be distributed in different configurations for a specific distributed user transfer interleaved wagering system application.

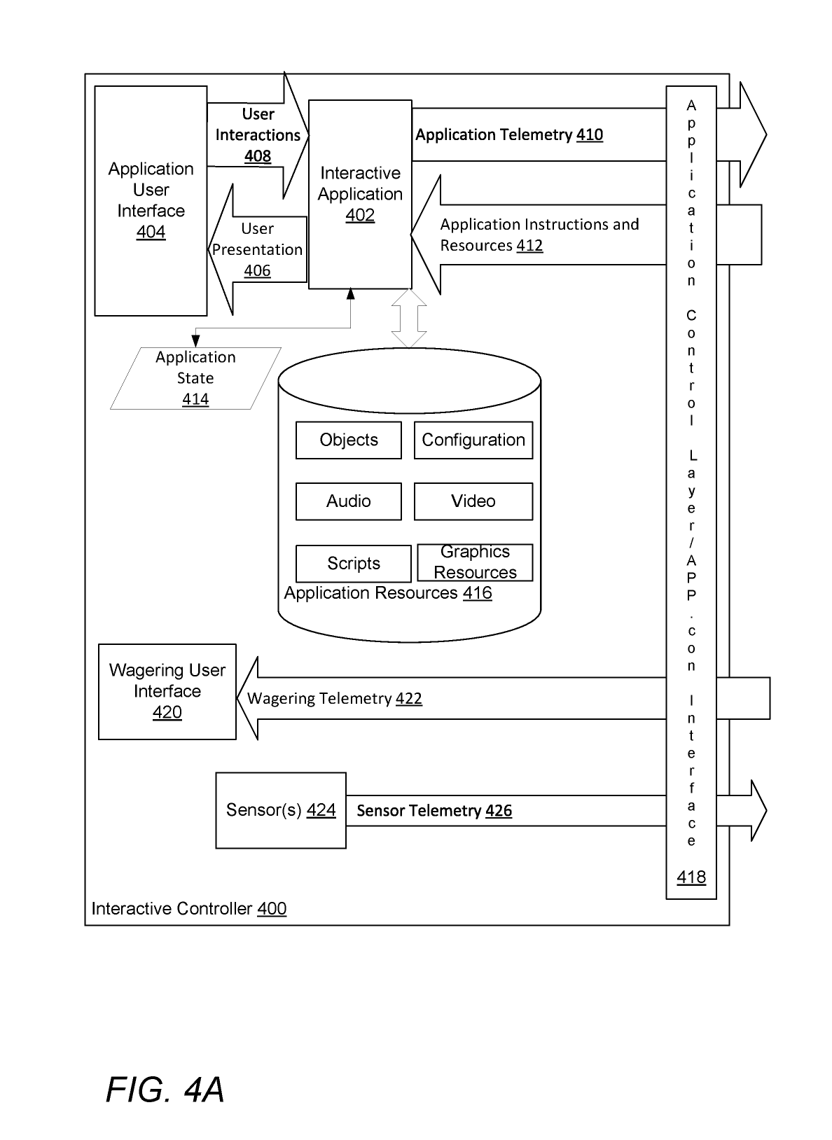

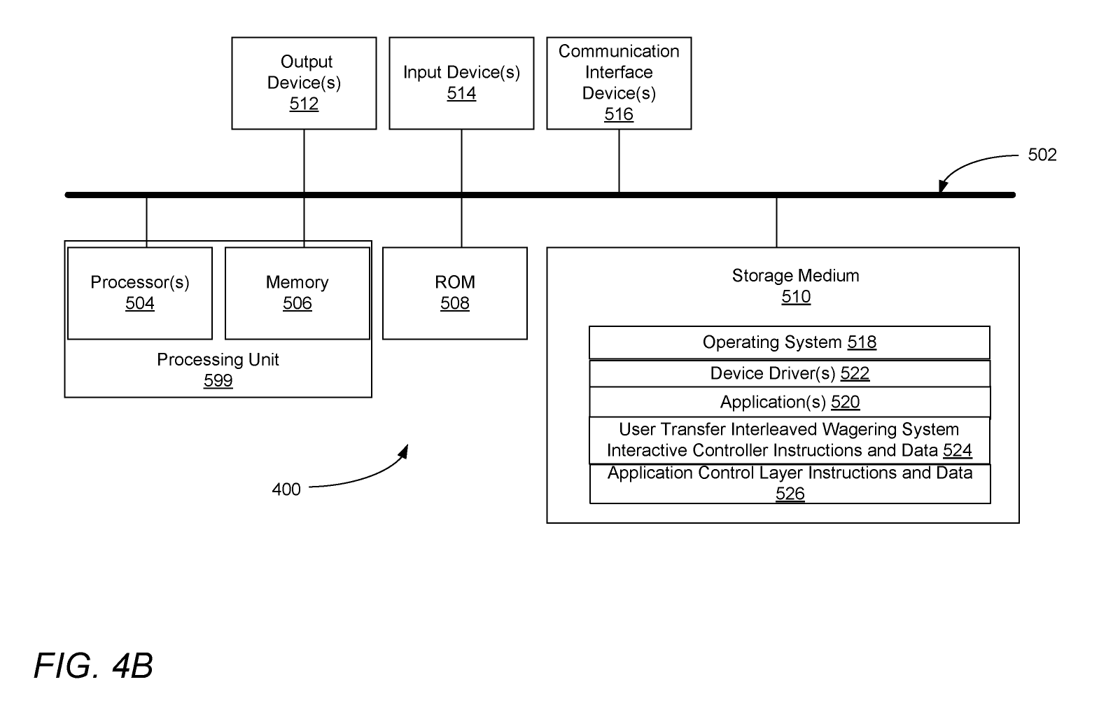

FIGS. 4A and 4B are diagrams of a structure of an interactive controller of a user transfer interleaved wagering system in accordance with various embodiments of the invention. An interactive controller may be constructed from or configured using one or more processing devices configured to perform the operations of the interactive controller. In many embodiments, an interactive controller can be constructed from or configured using various types of processing devices including, but not limited to, a mobile device such as a smartphone or the like, a personal digital assistant, a wireless device such as a tablet computer or the like, an electronic gaming machine, a personal computer, a gaming console, a set-top box, a computing device, a controller, or the like.

Referring now to FIG. 4A, an interactive controller 400, suitable for use as interactive controller 120 of FIG. 1A, provides an execution environment for an interactive application 402 of a user transfer interleaved wagering system. In several embodiments, an interactive controller 400 of a user transfer interleaved wagering system provides an interactive application 402 that generates an application user interface 404 for interaction with by a user. The interactive application 402 generates a user presentation 406 that is presented to the user through the application user interface 404. The user presentation 406 may include audio features, visual features or tactile features, or any combination of these features. The application user interface 404 further includes one or more human input devices (HIDs) interfaces that communicate with one or more HIDs (e.g., the input devices 514 of FIG. 4b) that the user can use to interact with the user transfer interleaved wagering system. The user's interactions 408 are included by the interactive application 402 in application telemetry data 410 that is communicated by interactive controller 400 to various other components of a user transfer interleaved wagering system as described herein. The interactive application 402 receives application instructions and resources 412 communicated from various other components of a user transfer interleaved wagering system as described herein.

In some embodiments, various components of the interactive application 402 can read data from an application state 414 in order to provide one or more features of the interactive application. In various embodiments, components of the interactive application 402 can include, but are not limited to, a physics engine, a rules engine, and/or a graphics engine. The physics engine is used to simulate physical interactions between virtual objects in the interactive application 402. The rules engine implements the rules of the interactive application and a P/RNG that may be used for influencing or determining certain variables and/or outcomes to provide a randomizing influence on the operations of the interactive application. The graphics engine is used to generate a visual representation of the interactive application state to the user. Furthermore, the components may also include an audio engine to generate audio outputs for the user interface.

During operation, the interactive application reads and writes application resources 416 stored on a data store of the interactive controller host. The application resources 416 may include objects having graphics and/or control logic used to provide application environment objects of the interactive application. In various embodiments, the resources may also include, but are not limited to, video files that are used to generate a portion of the user presentation 406; audio files used to generate music, sound effects, etc. within the interactive application; configuration files used to configure the features of the interactive application; scripts or other types of control code used to provide various features of the interactive application; and graphics resources such as textures, objects, etc. that are used by a graphics engine to render objects displayed in an interactive application.

In operation, components of the interactive application 402 read portions of the application state 414 and generate the user presentation 406 for the user that is presented to the user using the user interface 404. The user perceives the user presentation and provides user interactions 408 using the HIDs. The corresponding user interactions are received as user actions or inputs by various components of the interactive application 402. The interactive application 402 translates the user actions into interactions with the virtual objects of the application environment stored in the application state 414. Components of the interactive application use the user interactions with the virtual objects of the interactive application and the interactive application state 414 to update the application state 414 and update the user presentation 406 presented to the user. The process loops continuously while the user interacts with the interactive application of the user transfer interleaved wagering system.

The interactive controller 400 provides one or more interfaces 418 between the interactive controller 400 and other components of a user transfer interleaved wagering system, such as, but not limited to, an application controller. The interactive controller 400 and the other user transfer interleaved wagering system components communicate with each other using the interfaces. The interface may be used to pass various types of data, and to communicate and receive messages, status data, commands and the like. In certain embodiments, the interactive controller 400 and an application controller communicate application instructions and environment resources 412 and application telemetry data 410. In some embodiments, the communications include requests by the application controller that the interactive controller 400 update the application state 414 using data provided by the application controller.

In many embodiments, a communication by an application controller includes a request that the interactive controller 400 update one or more resources 416 using data provided by the application controller. In a number of embodiments, the interactive controller 400 provides all or a portion of the application state to the application controller. In some embodiments, the interactive controller 400 may also provide data about one or more of the application resources 416 to the application controller. In some embodiments, the communication includes user interactions that the interactive controller 400 communicates to the application controller. The user interactions may be low level user interactions with the user interface 404, such as manipulation of a HID, or may be high level interactions with game objects as determined by the interactive application. The user interactions may also include resultant actions such as modifications to the application state 414 or game resources 416 resulting from the user's interactions taken in the user transfer interleaved wagering system interactive application. In some embodiments, user interactions include, but are not limited to, actions taken by entities such as non-player characters (NPC) of the interactive application that act on behalf of or under the control of the user.

In some embodiments, the interactive controller 400 includes a wagering user interface 420 used to communicate user transfer interleaved wagering system telemetry data 422 to and from the user. The user transfer interleaved wagering system telemetry data 422 from the user transfer interleaved wagering system include, but are not limited to, data used by the user to configure Cr, AC and element wagers, and data about the gambling game Cr, AC and element wagers such as, but not limited to, Cr, AC and element balances and Cr, AC and element amounts wagered.

In some embodiments, the interactive controller includes one or more sensors 424. Such sensors may include, but are not limited to, physiological sensors that monitor the physiology of the user, environmental sensors that monitor the physical environment of the interactive controller, accelerometers that monitor changes in motion of the interactive controller, and location sensors that monitor the location of the interactive controller such as global positioning sensors (GPSs). The interactive controller 400 communicates sensor telemetry data 426 to one or more components of the user transfer interleaved wagering system.

Referring now to FIG. 4B, interactive controller 400 includes a bus 502 that provides an interface for one or more processors 504, random access memory (RAM) 506, read only memory (ROM) 508, machine-readable storage medium 510, one or more user output devices 512, one or more user input devices 514, and one or more communication interface devices 516.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

Examples of output devices 512 include, but are not limited to, display screens; light panels; and/or lighted displays. In accordance with particular embodiments, the one or more processors 504 are operatively connected to audio output devices such as, but not limited to: speakers; and/or sound amplifiers. In accordance with many of these embodiments, the one or more processors 504 are operatively connected to tactile output devices like vibrators, and/or manipulators.

Examples of user input devices 514 include, but are not limited to: tactile devices including but not limited to, keyboards, keypads, foot pads, touch screens, and/or trackballs; non-contact devices such as audio input devices; motion sensors and motion capture devices that the interactive controller can use to receive inputs from a user when the user interacts with the interactive controller; physiological sensors that monitor the physiology of the user; environmental sensors that monitor the physical environment of the interactive controller; accelerometers that monitor changes in motion of the interactive controller; and location sensors that monitor the location of the interactive controller such as global positioning sensors.

The one or more communication interface devices 516 provide one or more wired or wireless interfaces for communicating data and commands between the interactive controller 400 and other devices that may be included in a user transfer interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to an interactive application; and user transfer interleaved wagering system interactive controller instructions and data 524 for use by the one or more processors 504 to provide the features of an interactive controller as described herein. In some embodiments, the machine-executable instructions further include application control layer/application control interface instructions and data 526 for use by the one or more processors 504 to provide the features of an application control layer/application control interface as described herein.

In various embodiments, the machine-readable storage medium 510 is one of a (or a combination of two or more of) a hard drive, a flash drive, a DVD, a CD, a flash storage, a solid state drive, a ROM, an EEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of a user transfer interleaved wagering system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many such embodiments, an interactive controller of a user transfer interleaved wagering system includes an interactive application server operatively connected to an interactive client using a communication link. The interactive application server and interactive application client cooperate to provide the features of an interactive controller as described herein.

In various embodiments, the interactive controller 400 may be used to construct other components of a user transfer interleaved wagering system as described herein.

In some embodiments, components of an interactive controller and an application controller of a user transfer wagering interleaved system may be constructed from or configured using a single device using processes that communicate using an interprocess communication protocol. In other such embodiments, the components of an interactive controller and an application controller of a user transfer wagering interleaved system may communicate by passing messages, parameters or the like.

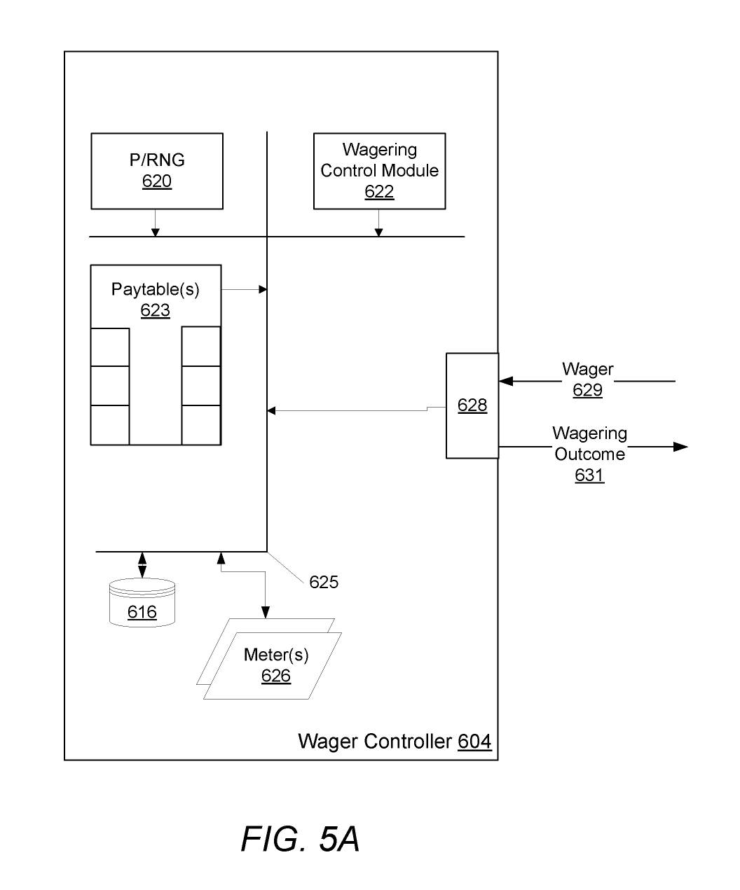

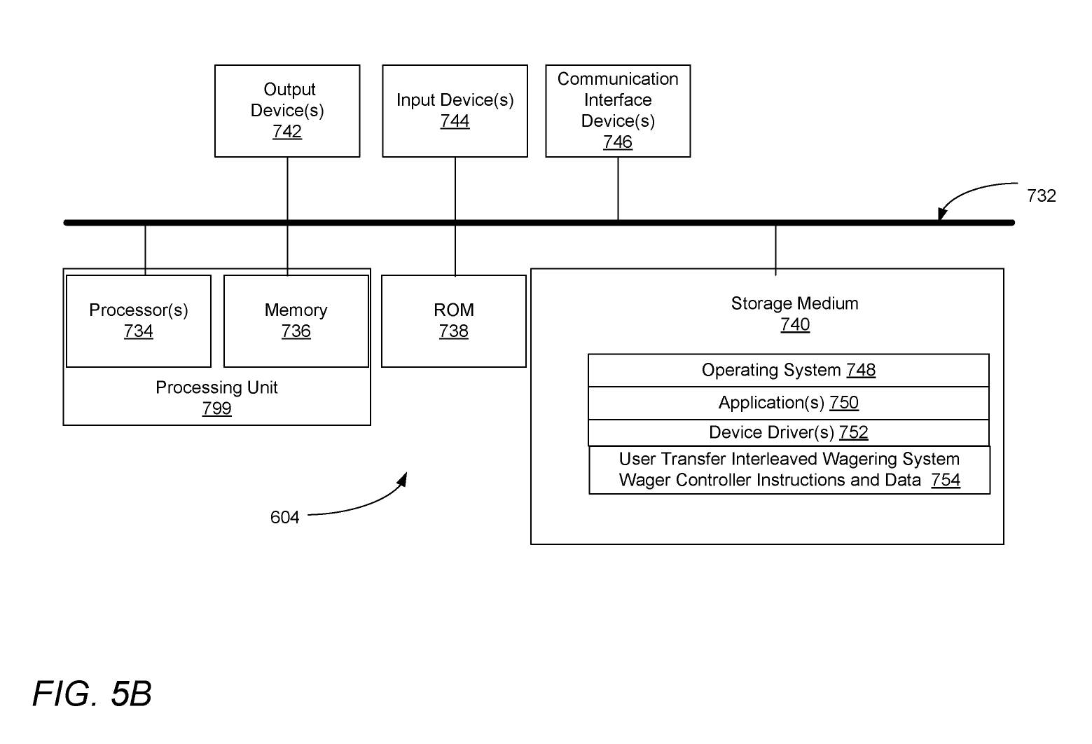

FIGS. 5A and 5B are diagrams of a structure of a wager controller of a user transfer interleaved wagering system in accordance with various embodiments of the invention. A wager controller may be constructed from or configured using one or more processing devices configured to perform the operations of the wager controller. In many embodiments, a wager controller can be constructed from or configured using various types of processing devices including, but not limited to, a mobile device such as a smartphone or the like, a personal digital assistant, a wireless device such as a tablet computer or the like, an electronic gaming machine, a personal computer, a gaming console, a set-top box, a computing device, a controller, or the like.

Referring now to FIG. 5A, in various embodiments, a wager controller 604, suitable for use as wager controller 102 of FIG. 1A, includes a pseudorandom or random number generator (P/RNG) 620 to produce random results or pseudo random results; one or more paytables 623 which includes a plurality of factors indexed by the random result to be multiplied with an amount of Cr, AC, elements, or objects committed in a wager; and a wagering control module 622 whose processes may include, but are not limited to, generating random results, looking up factors in the paytables, multiplying the factors by an amount of Cr, AC, elements, or objects wagered, and administering one or more Cr, AC, element, or object meters 626. The various wager controller components can interface with each other via an internal bus 625 and/or other appropriate communication mechanism.

An interface 628 allows the wager controller 604 to operatively connect to an external device, such as one or more application controllers as described herein. The interface 628 provides for receiving of wager execution instructions 629 from the external device that is used to specify wager parameters and/or trigger execution of a wager by the wager controller 604. The interface 628 may also provide for communicating wager outcome data 631 to an external device. In numerous embodiments, the interface between the wager controller 604 and other systems/devices may be a wide area network (WAN) such as the Internet. However, other methods of communication may be used including, but not limited to, a local area network (LAN), a universal serial bus (USB) interface, and/or some other method by which two electronic devices could communicate with each other.

In various embodiments, a wager controller 604 may use a P/RNG provided by an external system. The external system may be connected to the wager controller 604 by a suitable communication network such as a local area network (LAN) or a wide area network (WAN). In some embodiments, the external P/RNG is a central deterministic system that provides random or pseudo random results to one or more connected wager controllers.

During operation of the wager controller, the external system communicates wager execution instructions 629 to the wager controller 604. The wager controller 604 receives the wager execution instructions and uses the wager execution instructions to trigger execution of a wager in accordance with a wagering proposition. The wager controller 604 executes the wager and determines a wager outcome for the wager. The wager controller communicates wager outcome data 631 of the wager outcome to the external system.

In some embodiments, the wager controller uses the wager execution instructions to select a paytable 628 to use and/or an amount of Cr, AC, elements, or objects to wager.

In some embodiments, the wager outcome data may include, but is not limited to, an amount of Cr, AC, elements, or objects won in the wager.

In various embodiments, the wager outcome data may include, but is not limited to, an amount of Cr, AC, elements, or objects in the one or more meters 626.

In some embodiments, the wager outcome data includes state data for the wagering proposition of the executed wager. The state data may correspond to one or more game states of a gambling game that is associated with the wagering proposition. Examples of state data include, but are not limited to, reel strips in an operation state or a final state for a reel-based gambling game, one or more dice positions for a dice-based gambling game, positions of a roulette wheel and roulette ball, position of a wheel of fortune, or the like.

In various embodiments, the wagering control module 622 determines an amount of a wager and a paytable to use from the one or more paytables 623. In such embodiments, in response to the wager execution instructions triggering execution of the wager, the wager control module 622 executes the wager by requesting a P/RNG result from the P/RNG 620; retrieving a paytable from the one or more paytables 623; adjusting the one or more credit meters 626 for an amount of the wager; applying the P/RNG result to the retrieved paytable; multiplying the resultant factor from the paytable by an amount wagered to determine a wager outcome; updating the one or more meters 626 based on the wager outcome; and communicating the wager outcome to the external device.

In various embodiments, an external system communicates a request for a P/RNG result from the wager controller 604. In response, the wager controller 604 returns a P/RNG result as a function of an internal P/RNG or a P/RNG external to the external system to which the wager controller 604 is operatively connected.

In some embodiments, a communication exchange between the wager controller 604 and an external system relate to the external system support for coupling a P/RNG result to a particular paytable contained in the wager controller 604. In such an exchange, the external system communicates to the wager controller 604 as to which of the one or more paytables 623 to use, and requests a result whereby the P/RNG result would be associated with the requested paytable 623. The result of the coupling is returned to the external system. In such an exchange, no actual Cr, AC, element, or object wager is conducted, but might be useful in coupling certain non-value wagering interactive application behaviors and propositions to the same final resultant wagering return which is understood for the user transfer interleaved wagering system to conduct wagering.

In some embodiments, the wager controller 604 may also include storage for statuses, wagers, wager outcomes, meters and other historical events in a storage device 616.

In some embodiments, an authorization access module provides a process to permit access and command exchange with the wager controller 604 and access to the one or more credit meters 626 for the amount of Cr, AC, elements, or objects being wagered by the user in the user transfer interleaved wagering system.

In numerous embodiments, communication occurs between various types of a wager controller and an external system 630, such as application controller. In some of these embodiments, the purpose of the wager controller is to allocate wagers to pools, detect occurrences of one or more events upon which the wagers were made, and determine the wager outcomes for each individual wager based on the number of winning wagers and the amount paid into the pool.

In some embodiments, the wager controller manages accounts for individual users wherein the users make deposits into the accounts, amounts are deducted from the accounts, and amounts are credited to the users' accounts based on the wager outcomes.

In some embodiments a wager controller is a pari-mutuel wagering system such as used for wagering on an events such as horse races, greyhound races, sporting events and the like. In a pari-mutuel wagering system, user's wagers on the outcome of an event are allocated to a pool. When the event occurs, wager outcomes are calculated by sharing the pool among all winning wagers.

In various embodiments, a wager controller is a central determination system, such as but not limited to a central determination system for a Class II wagering system or a wagering system in support of a “scratch off” style lottery. In such a wagering system, a player plays against other players and competes for a common prize. In a given set of wager outcomes, there are a certain number of wins and losses. Once a certain wager outcome has been determined, the same wager outcome cannot occur again until a new set of wager outcomes is generated.

In numerous embodiments, communication occurs between various components of a wager controller 604 and an external system, such as an application controller. In some of these embodiments, the purpose of the wager controller 604 is to manage wagering on wagering events and to provide random (or pseudo random) results from a P/RNG.

Referring now to FIG. 5B, wager controller 604 includes a bus 732 that provides an interface for one or more processors 734, random access memory (RAM) 736, read only memory (ROM) 738, machine-readable storage medium 740, one or more user output devices 742, one or more user input devices 744, and one or more communication interface and/or network interface devices 746.

The one or more processors 734 may take many forms, such as, but not limited to, a central processing unit (CPU), a multi-processor unit (MPU), an ARM processor, a controller, a programmable logic device, or the like.

In the example embodiment, the one or more processors 734 and the random access memory (RAM) 736 form a wager controller processing unit 799. In some embodiments, the wager controller processing unit includes one or more processors operatively connected to one or more of a RAM, ROM, and machine-readable storage medium; the one or more processors of the wager controller processing unit receive instructions stored by the one or more of a RAM, ROM, and machine-readable storage medium via a bus; and the one or more processors execute the received instructions. In some embodiments, the wager controller processing unit is an ASIC (Application-Specific Integrated Circuit). In some embodiments, the wager controller processing unit is a SoC (System-on-Chip).

Examples of output devices 742 include, but are not limited to, display screens, light panels, and/or lighted displays. In accordance with particular embodiments, the one or more processors 734 are operatively connected to audio output devices such as, but not limited to speakers, and/or sound amplifiers. In accordance with many of these embodiments, the one or more processors 734 are operatively connected to tactile output devices like vibrators, and/or manipulators.

Examples of user input devices 734 include, but are not limited to, tactile devices including but not limited to, keyboards, keypads, touch screens, and/or trackballs; non-contact devices such as audio input devices; motion sensors and motion capture devices that the wager controller can use to receive inputs from a user when the user interacts with the wager controller 604.

The one or more communication interface and/or network interface devices 746 provide one or more wired or wireless interfaces for exchanging data and commands between the wager controller 604 and other devices that may be included in a user transfer interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface; a cellular or satellite telephone network interface; and the like.

The machine-readable storage medium 740 stores machine-executable instructions for various components of a wager controller, such as but not limited to: an operating system 748; one or more application programs 750; one or more device drivers 752; and user transfer interleaved wagering system wager controller instructions and data 754 for use by the one or more processors 734 to provide the features of a user transfer interleaved wagering system wager controller as described herein.

In various embodiments, the machine-readable storage medium 740 is one of a (or a combination of two or more of) a hard drive, a flash drive, a DVD, a CD, a flash storage, a solid state drive, a ROM, an EEPROM, and the like.

In operation, the machine-executable instructions are loaded into memory 736 from the machine-readable storage medium 740, the ROM 738 or any other storage location. The respective machine-executable instructions are accessed by the one or more processors 734 via the bus 732, and then executed by the one or more processors 734. Data used by the one or more processors 734 are also stored in memory 736, and the one or more processors 734 access such data during execution of the machine-executable instructions. Execution of the machine-executable instructions causes the one or more processors 734 to control the wager controller 604 to provide the features of a user transfer interleaved wagering system wager controller as described herein

Although the wager controller 604 is described herein as being constructed from or configured using one or more processors and machine-executable instructions stored and executed by hardware components, the wager controller can be composed of only hardware components in accordance with other embodiments. In addition, although the storage medium 740 is described as being operatively connected to the one or more processors through a bus, those skilled in the art of processing devices will understand that the storage medium can include removable media such as, but not limited to, a USB memory device, an optical CD ROM, magnetic media such as tape and disks. In some embodiments, the storage medium 740 can be accessed by the one or more processors 734 through one of the interfaces or using a communication link. Furthermore, any of the user input devices or user output devices can be operatively connected to the one or more processors 734 via one of the interfaces or using a communication link.

In various embodiments, the wager controller 604 may be used to construct other components of a user transfer interleaved wagering system as described herein.

In some embodiments, components of a wager controller and an application controller of a user transfer wagering interleaved system may be constructed from or configured using a single device using processes that communicate using an interprocess communication protocol. In other such embodiments, the components of a wager controller and an application controller of a user transfer wagering interleaved system may communicate by passing messages, parameters or the like.

It should be understood that there may be many embodiments of a wager controller 604 which could be possible, including forms where many modules and components of the wager controller are located in various servers and locations, so the foregoing is not meant to be exhaustive or all inclusive, but rather provide data on various embodiments of a wager controller 604.

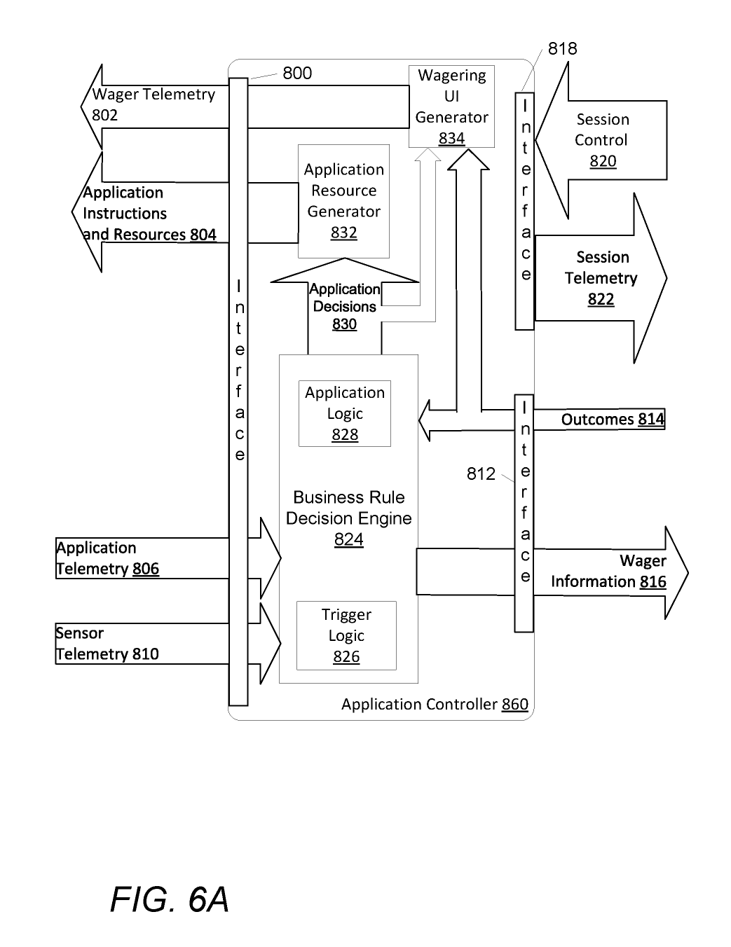

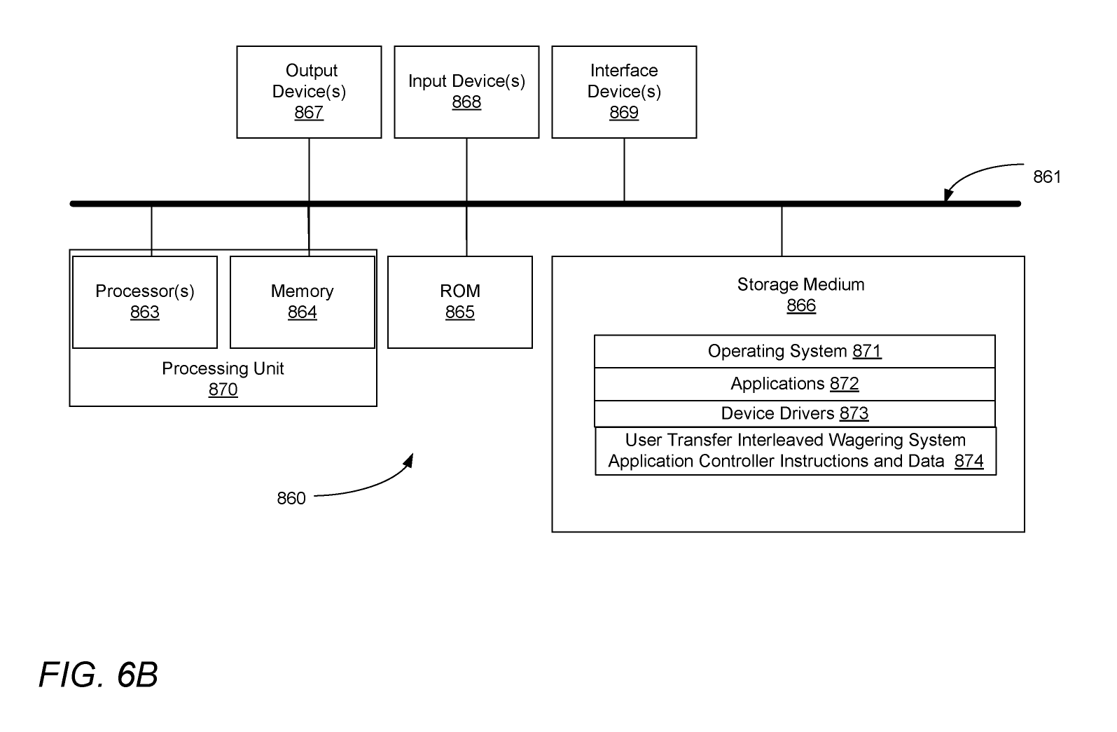

FIGS. 6A and 6B are diagrams of a structure of an application controller of a user transfer interleaved wagering system in accordance with various embodiments of the invention. An application controller may be constructed from or configured using one or more processing devices configured to perform the operations of the application controller. In many embodiments, an application controller can be constructed from or configured using various types of processing devices including, but not limited to, a mobile device such as a smartphone, a personal digital assistant, a wireless device such as a tablet computer or the like, an electronic gaming machine, a personal computer, a gaming console, a set-top box, a computing device, a controller, or the like.

Referring now to FIG. 6A, in many embodiments, an application controller 860, suitable for use as application controller 112 of FIG. 1A, manages operation of a user transfer interleaved wagering system, with a wager controller and an interactive controller being support units to the application controller 860. The application controller 860 provides an interface between the interactive application, provided by an interactive controller, and a wagering proposition, provided by a wager controller.

In some embodiments, the application controller 860 includes an interactive controller interface 800 to an interactive controller. The interactive controller interface 800 provides for communication of data between an interactive controller and the application controller 860, including but not limited to wager telemetry data 802, application instructions and resources 804, application telemetry data 806, and sensor telemetry data 810.

In various embodiments, the application controller 860 includes a wager controller interface 812 to a wager controller. The wager controller interface 812 provides for communication of data between the application controller 860 and a wager controller, including but not limited to wager outcomes 814 and wager execution instructions 816.

In some embodiments, the application controller 860 includes a user management and session controller interface 818 to a user management and session controller. The user management and session controller interface 818 provides for communication of data between the application controller 860 and a user management and session controller, including but not limited to user session control data 820 and user session telemetry data 822.

The application controller 860 includes a rule-based decision engine 824 that receives telemetry data, such as application telemetry data and sensor telemetry data, from an interactive controller. The rule-based decision engine 824 uses the telemetry data, along with trigger logic 826 to generate wager execution instructions used to trigger a wager in a wager controller.

In some embodiments, the application telemetry data includes, but is not limited to, application environment variables that indicate the state of an interactive application being used by a user, interactive controller data indicating a state of an interactive controller, and user actions and interactions between a user and an interactive application provided by an interactive controller. The wagering and/or wager execution instructions may include, but is not limited to, an amount and type of the wager, a trigger of the wager, and a selection of a paytable to be used when executing the wager.

In some embodiments, the rule-based decision engine 824 also receives wager outcome data from a wager controller. The decision engine 824 uses the wager outcome data, in conjunction with telemetry data and application logic 828 to generate application decisions 830 communicated to an application resource generator 832. The application resource generator 832 receives the application decisions and uses the application decisions to generate application instructions and application resources to be communicated to an interactive application.

In many embodiments, the application controller 860 includes a pseudo random or random result generator used to generate random results that are communicated to the application resource generator 832. The application resource generator uses the random results to generate application instructions and application resources to be communicated to an interactive controller for use by an interactive application.

In various embodiments, the rule-based decision engine 824 also determines an amount of AC to award to a user based at least in part on the user's use of an interactive application of the user transfer interleaved wagering system as determined from application telemetry data. In some embodiments, wager outcome data may also be used to determine the amount of AC that should be awarded to the user.

In numerous embodiments, an interactive application is a skill-based interactive game and the AC is awarded to the user for the user's skillful play of the skill-based interactive game.

In some embodiments, the application decisions and wager outcome data are communicated to a wagering user interface generator 834. The wagering user interface generator 834 receives the application decisions and wager outcome data and generates wager telemetry data describing the state of wagering and credit accumulation and loss for the user transfer interleaved wagering system. In some embodiments, the wager telemetry data 146 may include, but is not limited to, amounts of AC and elements earned, lost or accumulated by the user through use of the interactive application as determined from the application decisions, and Cr amounts won, lost or accumulated as determined from the wager outcome data and the one or more credit meters.

In some embodiments, the wager outcome data 814 also includes data about one or more game states of a gambling game executed in accordance with a wagering proposition by a wager controller. In various such embodiments, the wagering user interface generator 834 generates a gambling game process display and/or gambling game state display using the one or more game states of the gambling game. The gambling game process display and/or gambling game state display is included in wager telemetry data that is communicated to an interactive controller. The gambling game process display and/or a gambling game state display is displayed by a wagering user interface of the interactive controller to a user. In other such embodiments, the one or more game states of the gambling game are communicated to an interactive controller and a wagering user interface of the interactive controller generates a gambling game process display and/or gambling game state display using the one or more game states of the gambling game for display to a user.

The application controller 860 can further operatively connect to a wager controller to determine an amount of credit or elements available and other wagering metrics of a wagering proposition. Thus, the application controller 860 may potentially affect an amount of Cr in play for participation in the wagering events of a gambling game provided by the wager controller. The application controller 860 may additionally include various audit logs and activity meters. In some embodiments, the application controller 860 can also couple to a centralized server for exchanging various data related to the user and the activities of the user during game play of a user transfer interleaved wagering system.

In some embodiments, the operation of the application controller 860 does not affect the provision of a wagering proposition by a wager controller except for user choice parameters that are allowable in accordance with the wagering proposition. Examples of user choice parameters include, but are not limited to: wager terms such as but not limited to a wager amount; speed of game play (for example, by pressing a button or pulling a handle of a slot machine); and/or agreement to wager into a bonus round.

In a number of embodiments, communication of wager execution instructions between a wager controller and the application controller 860 can further be used to communicate various wagering control factors that the wager controller uses as input. Examples of wagering control factors include, but are not limited to, an amount of Cr, AC, elements, or objects consumed per wagering event, and/or the user's election to enter a jackpot round.

In some embodiments, the application controller 860 utilizes a wagering user interface to communicate certain interactive application data to the user, including but not limited to, club points, user status, control of the selection of user choices, and messages which a user can find useful in order to adjust the interactive application experience or understand the wagering status of the user in accordance with the wagering proposition in the wager controller.

In some embodiments, the application controller 860 utilizes a wagering user interface to communicate aspects of a wagering proposition to the user including, but not limited to, odds of certain wager outcomes, amount of Cr, AC, elements, or objects in play, and amounts of Cr, AC, elements, or objects available.

In a number of embodiments, a wager controller can accept wager proposition factors including, but not limited to, modifications in the amount of Cr, AC, elements, or objects wagered on each individual wagering event, a number of wagering events per minute the wager controller can resolve, entrance into a bonus round, and other factors. In several embodiments, the application controller 860 can communicate a number of factors back and forth to the wager controller, such that an increase/decrease in a wagered amount can be related to the change in user profile of the user in the interactive application. In this manner, a user can control a wager amount per wagering event in accordance with the wagering proposition with the change mapping to a parameter or component that is applicable to the interactive application experience.

Referring now to FIG. 6B, application controller 860 includes a bus 861 providing an interface for one or more processors 863, random access memory (RAM) 864, read only memory (ROM) 865, machine-readable storage medium 866, one or more user output devices 867, one or more user input devices 868, and one or more communication interface and/or network interface devices 869.

The one or more processors 863 may take many forms, such as, but not limited to: a central processing unit (CPU); a multi-processor unit (MPU); an ARM processor; a programmable logic device; or the like.

Examples of output devices 867 include, include, but are not limited to: display screens; light panels; and/or lighted displays. In accordance with particular embodiments, the one or more processors 863 are operatively connected to audio output devices such as, but not limited to: speakers; and/or sound amplifiers. In accordance with many of these embodiments, the one or more processors 863 are operatively connected to tactile output devices like vibrators, and/or manipulators.

In the example embodiment, the one or more processors 863 and the random access memory (RAM) 864 form an application controller processing unit 870. In some embodiments, the application controller processing unit includes one or more processors operatively connected to one or more of a RAM, ROM, and machine-readable storage medium; the one or more processors of the application controller processing unit receive instructions stored by the one or more of a RAM, ROM, and machine-readable storage medium via a bus; and the one or more processors execute the received instructions. In some embodiments, the application controller processing unit is an ASIC (Application-Specific Integrated Circuit). In some embodiments, the application controller processing unit is a SoC (System-on-Chip).

Examples of user input devices 868 include, but are not limited to: tactile devices including but not limited to, keyboards, keypads, foot pads, touch screens, and/or trackballs; non-contact devices such as audio input devices; motion sensors and motion capture devices that the application controller can use to receive inputs from a user when the user interacts with the application controller 860.

The one or more communication interface and/or network interface devices 869 provide one or more wired or wireless interfaces for exchanging data and commands between the application controller 860 and other devices that may be included in a user transfer interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 866 stores machine-executable instructions for various components of the application controller 860 such as, but not limited to: an operating system 871; one or more applications 872; one or more device drivers 873; and user transfer interleaved wagering system application controller instructions and data 874 for use by the one or more processors 863 to provide the features of an application controller as described herein.

In various embodiments, the machine-readable storage medium 870 is one of a (or a combination of two or more of) a hard drive, a flash drive, a DVD, a CD, a flash storage, a solid state drive, a ROM, an EEPROM, and the like.

In operation, the machine-executable instructions are loaded into memory 864 from the machine-readable storage medium 866, the ROM 865 or any other storage location. The respective machine-executable instructions are accessed by the one or more processors 863 via the bus 861, and then executed by the one or more processors 863. Data used by the one or more processors 863 are also stored in memory 864, and the one or more processors 863 access such data during execution of the machine-executable instructions. Execution of the machine-executable instructions causes the one or more processors 863 to control the application controller 860 to provide the features of a user transfer interleaved wagering system application controller as described herein.

Although the application controller 860 is described herein as being constructed from or configured using one or more processors and instructions stored and executed by hardware components, the application controller can be composed of only hardware components in accordance with other embodiments. In addition, although the storage medium 866 is described as being operatively connected to the one or more processors through a bus, those skilled in the art of application controllers will understand that the storage medium can include removable media such as, but not limited to, a USB memory device, an optical CD ROM, magnetic media such as tape and disks. Also, in some embodiments, the storage medium 866 may be accessed by processor 863 through one of the interfaces or using a communication link. Furthermore, any of the user input devices or user output devices may be operatively connected to the one or more processors 863 via one of the interfaces or using a communication link.

In various embodiments, the application controller 860 may be used to construct other components of a user transfer interleaved wagering system as described herein.

In some embodiments, components of an interactive controller and an application controller of a user transfer wagering interleaved system may be constructed from or configured using a single device using processes that communicate using an interprocess communication protocol. In other such embodiments, the components of an interactive controller and an application controller of a user transfer wagering interleaved system may communicate by passing messages, parameters or the like.

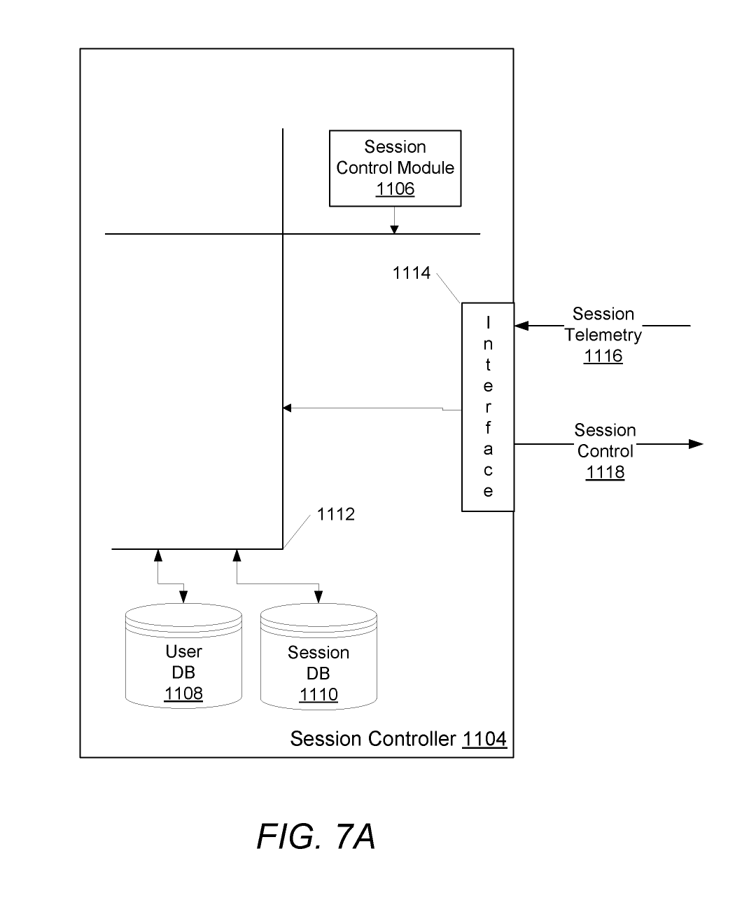

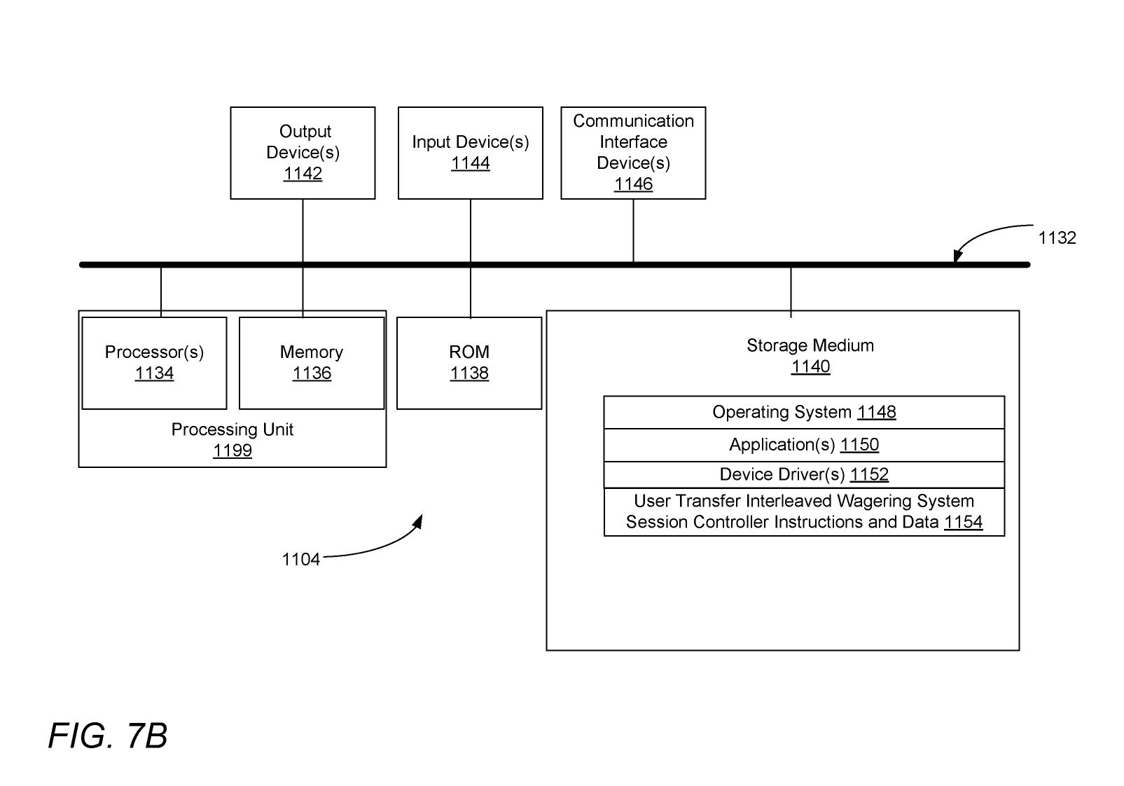

FIGS. 7A and 7B are diagrams of a structure of a user management and session controller of a user transfer interleaved wagering system in accordance with various embodiments of the invention. A user management and session controller may be constructed from or configured using one or more processing devices configured to perform the operations of the user management and session controller. In many embodiments, a wager user session can be constructed from or configured using various types of processing devices including, but not limited to, a mobile device such as a smartphone or the like, a personal digital assistant, a wireless device such as a tablet computer or the like, an electronic gaming machine, a personal computer, a gaming console, a set-top box, a computing device, a controller, a server, or the like.

Referring now to FIG. 7A, in various embodiments, a user management and session controller 1104, suitable for use as user management and session controller 150 of FIG. 1A, includes a user management and session control module 1106 whose processes may include, but are not limited to, registering users of a user transfer wagering interleaved system, validating users of a user transfer wagering interleaved system using user registration data, managing various types of user sessions for users of the user transfer wagering interleaved system, and the like.

The user management and session controller 1104 may further include a datastore 1108 storing user data used to manage user registration and validation. The user management and session controller 1104 may further include a datastore 1110 storing user session data used to manage one or more user sessions.

The various user management and session controller components can interface with each other via an internal bus 1112 and/or other appropriate communication mechanism.

An interface 1114 allows the user management and session controller 1104 to operatively connect to one or more external devices, such as one or more application controllers, wager controllers and/or interactive controllers as described herein. The interface provides for receiving session telemetry data 1116 from the one more external devices. The user session telemetry data includes, but is not limited to, amounts of AC earned by one or more users, requests for entering into a user transfer user session as described herein, and telemetry data regarding the progress of one or more users during a user transfer user session. The interface 1114 may also provide for communicating secession control data 1118 used to manage a user session.

In numerous embodiments, the interface between the user management and session controller and other systems/devices may be a wide area network (WAN) such as the Internet. However, other methods of communication may be used including, but not limited to, a local area network (LAN), a universal serial bus (USB) interface, and/or some other method by which two electronic devices could communicate with each other.

During operation of the user management and session controller, the external system communicates user session telemetry data to the user management and session controller. The user management and session controller receives the user session telemetry data and uses the user session telemetry data to generate user session control data as described herein. The user management and session controller communicates the user session control data to the external system.

Referring now to FIG. 7B, user management and session controller 1104 includes a bus 1132 that provides an interface for one or more processors 1134, random access memory (RAM) 1136, read only memory (ROM) 1138, machine-readable storage medium 1140, one or more user output devices 1142, one or more user input devices 1144, and one or more communication interface and/or network interface devices 1146.

The one or more processors 1134 may take many forms, such as, but not limited to, a central processing unit (CPU), a multi-processor unit (MPU), an ARM processor, a controller, a programmable logic device, or the like.

In the example embodiment, the one or more processors 1134 and the random access memory (RAM) 1136 form a user management and session controller processing unit 1199. In some embodiments, the user management and session controller processing unit includes one or more processors operatively connected to one or more of a RAM, ROM, and machine-readable storage medium; the one or more processors of the user management and session controller processing unit receive instructions stored by the one or more of a RAM, ROM, and machine-readable storage medium via a bus; and the one or more processors execute the received instructions. In some embodiments, the user management and session controller processing unit is an ASIC (Application-Specific Integrated Circuit). In some embodiments, the user management and session controller processing unit is a SoC (System-on-Chip).

Examples of output devices 1142 include, but are not limited to, display screens, light panels, and/or lighted displays. In accordance with particular embodiments, the one or more processors 1134 are operatively connected to audio output devices such as, but not limited to speakers, and/or sound amplifiers. In accordance with many of these embodiments, the one or more processors 1134 are operatively connected to tactile output devices like vibrators, and/or manipulators.

Examples of user input devices 1144 include, but are not limited to, tactile devices including but not limited to, keyboards, keypads, touch screens, and/or trackballs; non-contact devices such as audio input devices; motion sensors and motion capture devices that the user management and session controller can use to receive inputs from a user when the user interacts with the user management and session controller 1104.

The one or more communication interface and/or network interface devices 1146 provide one or more wired or wireless interfaces for exchanging data and commands between the user management and session controller 1104 and other devices that may be included in a user transfer interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface; a cellular or satellite telephone network interface; and the like.

The machine-readable storage medium 1140 stores machine-executable instructions for various components of a user management and session controller, such as but not limited to: an operating system 1148; one or more application programs 1150; one or more device drivers 1152; and user transfer interleaved wagering system user management and session controller instructions and data 1154 for use by the one or more processors 1134 to provide the features of a user transfer interleaved wagering system user management and session controller as described herein.

In various embodiments, the machine-readable storage medium 1140 is one of a (or a combination of two or more of) a hard drive, a flash drive, a DVD, a CD, a flash storage, a solid state drive, a ROM, an EEPROM, and the like.

In operation, the machine-executable instructions are loaded into memory 736 from the machine-readable storage medium 1140, the ROM 1138 or any other storage location. The respective machine-executable instructions are accessed by the one or more processors 1134 via the bus 1132, and then executed by the one or more processors 1134. Data used by the one or more processors 1134 are also stored in memory 1136, and the one or more processors 1134 access such data during execution of the machine-executable instructions. Execution of the machine-executable instructions causes the one or more processors 1134 to control the user management and session controller 1104 to provide the features of a user transfer interleaved wagering system user management and session controller as described herein

Although the user management and session controller 1104 is described herein as being constructed from or configured using one or more processors and machine-executable instructions stored and executed by hardware components, the user management and session controller can be composed of only hardware components in accordance with other embodiments. In addition, although the storage medium 1140 is described as being operatively connected to the one or more processors through a bus, those skilled in the art of processing devices will understand that the storage medium can include removable media such as, but not limited to, a USB memory device, an optical CD ROM, magnetic media such as tape and disks. In some embodiments, the storage medium 1140 can be accessed by the one or more processors 1134 through one of the interfaces or using a communication link. Furthermore, any of the user input devices or user output devices can be operatively connected to the one or more processors 1134 via one of the interfaces or using a communication link.

In various embodiments, the user management and session controller 1104 may be used to construct other components of a user transfer interleaved wagering system as described herein.

In some embodiments, components of a user management and session controller and an application controller of a user transfer wagering interleaved system may be constructed from or configured using a single device using processes that communicate using an interprocess communication protocol. In other such embodiments, the components of a user management and session controller and an application controller of a user transfer wagering interleaved system may communicate by passing messages, parameters or the like.

In some embodiments, components of a user management and session controller and a wager controller of a user transfer wagering interleaved system may be constructed from or configured using a single device using processes that communicate using an interprocess communication protocol. In other such embodiments, the components of a user management and session controller and an application controller of a user transfer wagering interleaved system may communicate by passing messages, parameters or the like.

It should be understood that there may be many embodiments of a user management and session controller 1104 which could be possible, including forms where many modules and components of the user management and session controller are located in various servers and locations, so the foregoing is not meant to be exhaustive or all inclusive, but rather provide data on various embodiments of a user management and session controller 1104.

In numerous embodiments, any of a wager controller, an application controller, an interactive controller, or a user management and session controller as described herein can be constructed from or configured using multiple processing devices, whether dedicated, shared, or distributed in any combination thereof, or can be constructed from or configured using a single processing device. In addition, while certain aspects and features of user transfer interleaved wagering system processes described herein have been attributed to a wager controller, an application controller, an interactive controller, or a user management and session controller, these aspects and features can be provided in a distributed form where any of the features or aspects can be provided by any of a user management and session controller, a wager controller, an application controller, and/or an interactive controller within a user transfer interleaved wagering system without deviating from the spirit of the invention.

Although various components of user transfer interleaved wagering systems are discussed herein, user transfer interleaved wagering systems can be configured with any component as appropriate to the specification of a specific application in accordance with embodiments of the invention. In certain embodiments, components of a user transfer interleaved wagering system, such as a user management and session controller, an application controller, a wager controller, and/or an interactive controller, can be configured in different ways for a specific user transfer interleaved wagering system.

In some embodiments, components of a user management and session controller, an interactive controller, an application controller, and/or a wager controller of a user transfer wagering interleaved system may be constructed from or configured using a single device using processes that communicate using an interprocess communication protocol. In many embodiments, the components of a user management and session controller, an interactive controller, an application controller and a wager controller of a user transfer wagering interleaved system may communicate by passing messages, parameters or the like.

In addition, while certain aspects and features of user transfer interleaved wagering system processes described herein have been attributed to a user management and session controller, a wager controller, an application controller, or an interactive controller, these aspects and features can be provided in a distributed form where any of the features or aspects can be provided by any of a user management and session controller, a wager controller, an application controller, and/or an interactive controller within a user transfer interleaved wagering system.

### Operation of User Transfer Wagering Interleaved Systems

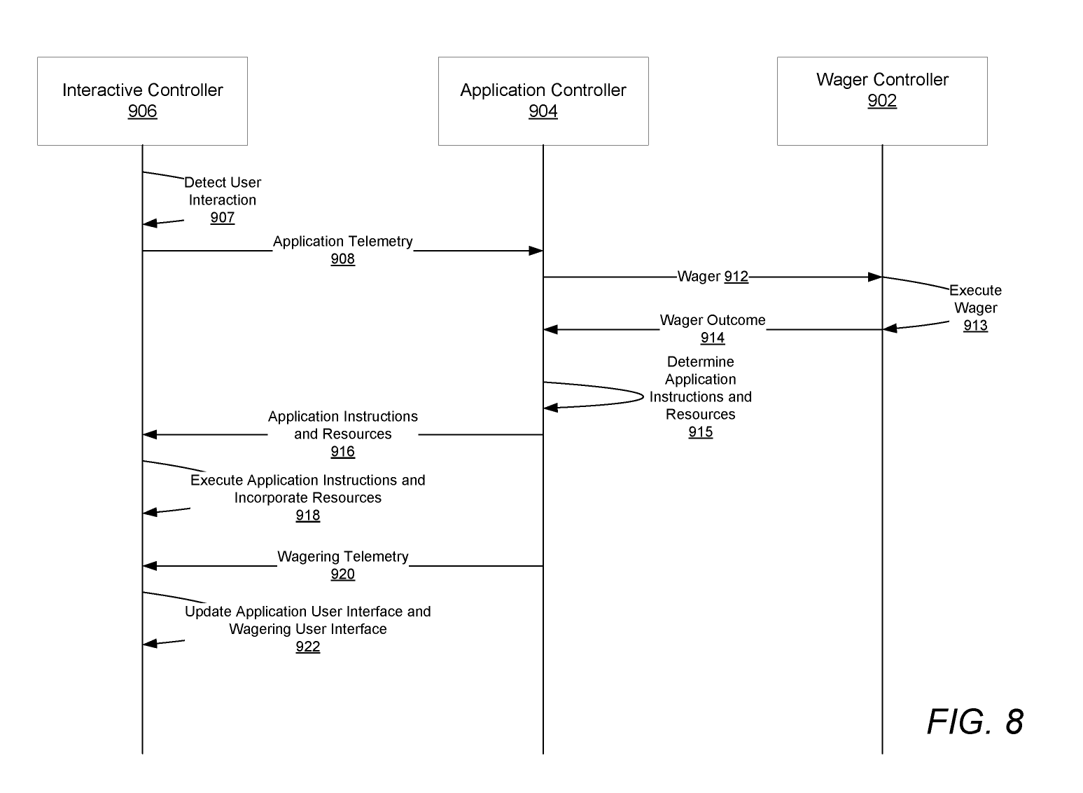

FIG. 8 is a sequence diagram of interactions between components of a user transfer interleaved wagering system in accordance with various embodiments of the invention. The components of the user transfer interleaved wagering system include a wager controller 902, such as wager controller 102 of FIG. 1A, an application controller 904, such as application controller 112 of FIG. 1A, and an interactive controller 906, such as interactive controller 120 of FIG. 1A. The process begins with the interactive controller 906 detecting a user performing a user interaction in a user interface of an interactive application provided by the interactive controller 906. The interactive controller 906 communicates application telemetry data 908 to the application controller 904. The application telemetry data includes, but is not limited to, the user interaction detected by the interactive controller 906.

The application controller 904 receives the application telemetry data 908. Upon determination by the application controller 904 that the user interaction indicates a wagering event, the application controller 904 generates wager execution instructions including a wager request 912 that the application controller 904 uses to instruct the wager controller 902 to execute a wager. The request for a wager event may include wager terms associated with a wagering proposition. The application controller 904 communicates the wager execution instructions to the wager controller 902.

The wager controller 902 receives the wager execution instructions 912 and uses the wager execution instructions to execute (913) a wager in accordance with a wagering proposition. The wager controller 902 communicates a wager outcome 914 of the executed wager to the application controller 904.

The application controller 904 receives the wager outcome and generates (915) interactive application instructions and resources 916 for the interactive application. The application controller 904 uses the interactive application instructions and resources 916 to instruct the interactive controller. The application controller communicates the interactive application instructions and resources 916 to the interactive controller 906. The application controller also communicates wagering telemetry data 920 including the wager outcome to the interactive controller 906.

The interactive controller 906 receives the interactive application instructions and resources 916 and wagering telemetry data 918. The interactive controller 906 incorporates the received interactive application resources and executes the received interactive application instructions (918). The interactive controller updates (922) an application user interface of the interactive application provided by the interactive controller using the interactive application instructions and the resources, and updates (922) a wagering user interface using the wagering telemetry data.

In several embodiments, a user can interact with a user transfer interleaved wagering system by using Cr for wagering in accordance with a wagering proposition along with AC and elements in interactions with an interactive application. Wagering can be executed by a wager controller while an interactive application can be executed by an interactive controller and managed with an application controller.

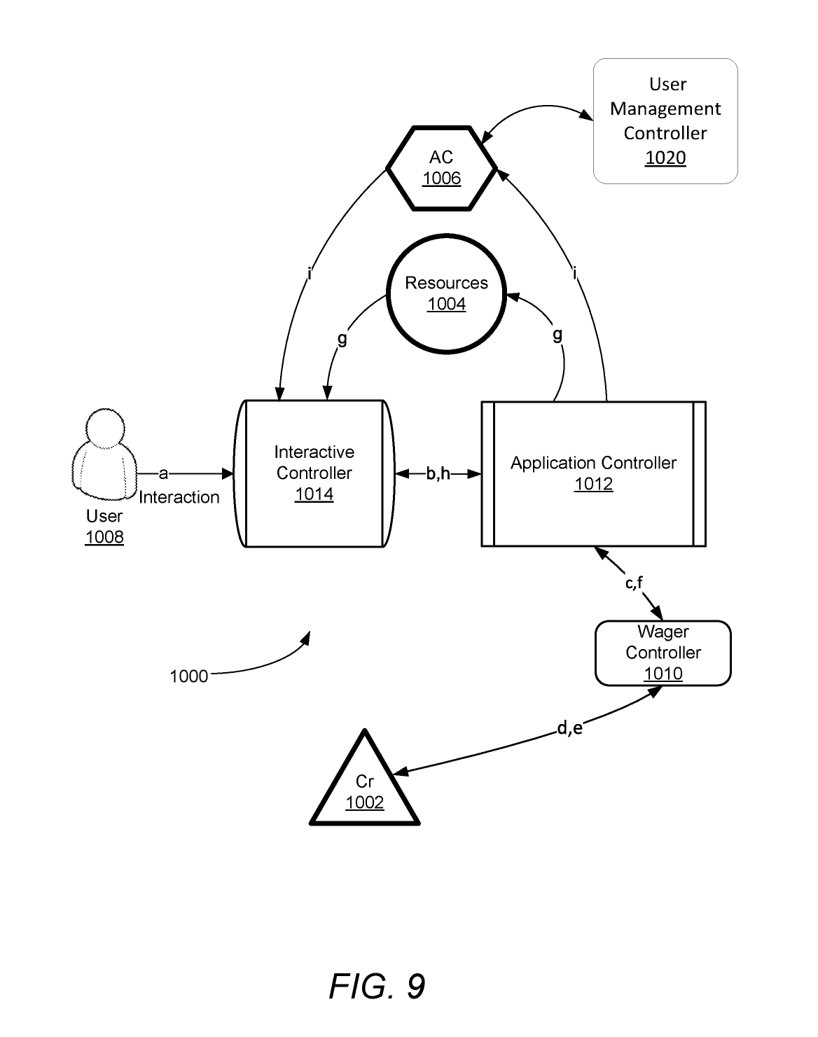

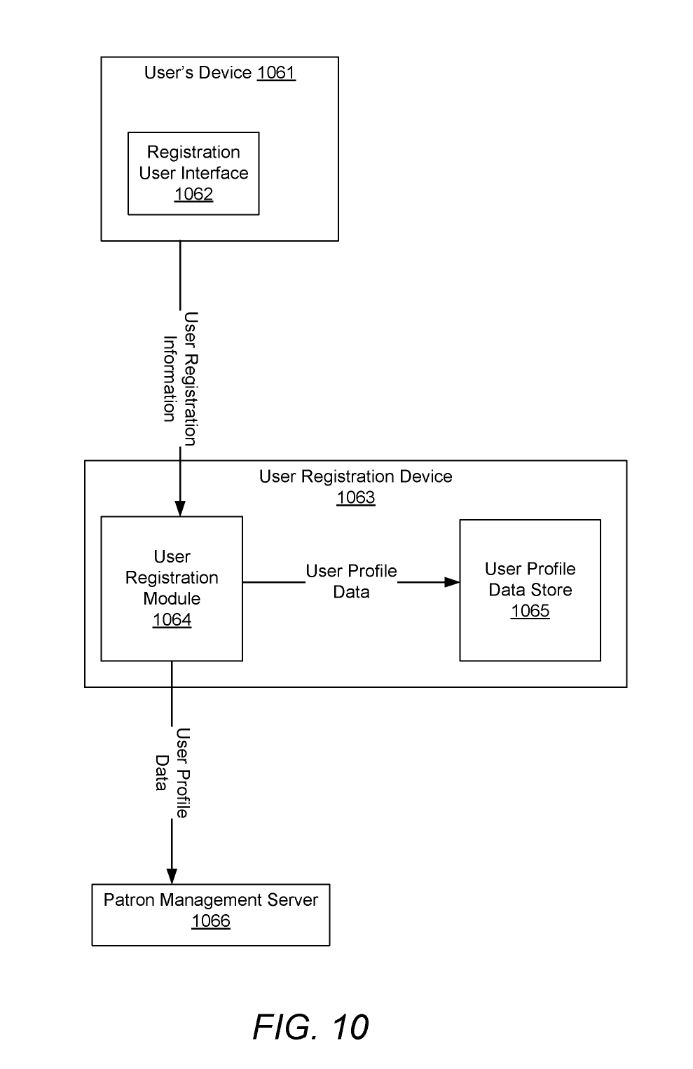

FIG. 9 is a collaboration diagram that illustrates how resources such as AC, Cr, elements, and objects are utilized in a user transfer interleaved wagering system in accordance with various embodiments of the invention. The collaboration diagram 1000 illustrates that Cr 1002, interactive application resources including elements and objects 1004 and AC 1006 can be utilized by a user 1008 in interactions with a wager controller 1010, such as wager controller 102 of FIG. 1A, an application controller 1012, such as wager controller 112 of FIG. 1, and an interactive controller 1014, such as interactive controller 120 of FIG. 1A, of a user transfer interleaved wagering system. The contribution of elements and objects such as included in resources 1004, can be linked to a user's access to credits, such as Cr 1002 and/or AC 1006. Electronic receipt of these credits can come via a smart card, voucher or other portable media, or as received using a communication link from a server. In some embodiments, these credits can be drawn on demand from a user profile located in a database locally on a user transfer interleaved wagering system or in a remote server.

A user's actions and/or decisions can affect an interactive application of interactive controller 1014 that consume and/or accumulate AC 1004 and/or resources 1004 in an interactive application executed by an interactive controller 1014, a wager controller 101 and an application controller 1012. The application controller 1012 can monitor the activities taking place within an interactive application executed by an interactive controller 1014 for wagering event occurrences. The application controller 1012 can also communicate the wagering event occurrences to the wager controller 1010 that triggers a wager of Cr 1002 in accordance with a wagering proposition executed by the wager controller 1010.

In several embodiments, the user commences interaction with the user transfer interleaved wagering system by contributing credit to a user transfer interleaved wagering system such as, but not limited to, Cr 1002 that may be credit in a real currency or may be credit in a virtual currency that is not fungible with a real currency, AC 1006 that may be application environment credits, and specified types of interactive application elements and/or objects 1004. One or more of these contributions may be provided directly as currency and/or transferred in electronically. Electronic transfer may come via a smart card, voucher or other portable media, or as transferred in using a communication link from a user data server or user transfer interleaved wagering system user management and session controller. In many embodiments, contributions may be drawn on demand from user accounts located in servers residing on the network or in the cloud on a real time basis as the credits, elements and/or object are committed or consumed by the user transfer interleaved wagering system. Generally, Cr is utilized and accounted for by the wager controller 1010; and the resources 1004 and AC 1006 are utilized and accounted for by the application controller 1012 and/or the interactive controller 1014.

The user interacts (a) with an interactive application provided by the interactive controller 1014 with the interaction representing an action by the user within the context of the interactive application. The interactive controller 1014 receives the user interaction and communicates (b) the interaction to the application controller 1012. The application controller 1012 receives the interaction and determines from the interaction whether or not a wager should be triggered. If a wager should be triggered, the application controller 1012 instructs (c) the wager controller 1010 to execute a wager in accordance with a wagering proposition associated with the interaction and thereby triggers a wager. The wager controller receives the wager execution instructions and executes the wager in accordance with the wagering proposition, and consumes (d) an appropriate amount of Cr 1002 for the wager. The wager controller 1010 adjusts (e) the Cr 1002 based upon a wager outcome of the wager and communicates (f) the wager outcome to the application controller 1012 as to the outcome of the wager triggered by the application controller 1012. The application controller 1012 receives the wager outcome. The application controller determines what resources 1004 should be provided to the interactive controller, generates the resources 1004 and application instructions and instructs (g) the interactive controller 1014 using the resources 1004 and application instructions. The interactive controller receives the resources 1004 and application instructions from the application controller 1012 and integrates them into the execution of the interactive application provided by the interactive controller 1014.

In some embodiments, the application controller 1012 communicates (h) data about the wager outcome to the interactive controller. The interactive controller receives the wager outcome and displays the wager outcome to the user 1008.

In some embodiments, the application controller 1012 determines what resources and instructions to provide to the interactive controller 1014 for use by the interactive application provided by the interactive controller 1014 partially on the basis of the wager outcome. In some such embodiments, resources are provided in a case that the wager was a winning wager for the user. In other such embodiments, fewer or no resources are provided in a case of a losing wager.

In some embodiments, the application controller 1012 determines what resources to provide based on internal logic of the application controller 1012. In some such embodiments, the application controller 1012 employs a random result generator, such as a P/RNG, to generate a random result and the random result is used to determine what resources are provided to the interactive controller 1014.

In several embodiments, the application controller 1012 determines an increment or a decrement of an amount of AC 1006 using the interactions received from the interactive controller. The increment or decremented amount is communicated (i) to the interactive controller for display to the user.

In some embodiments, the application controller 1012 executes a wager of Cr as a virtual currency, AC, elements or objects. In some such embodiments, the application controller 1012 employs a random result generator, such as a P/RNG, to generate a random result and the random result is used to determine a wager outcome in Cr as a virtual currency, AC, elements or objects.

The following is description of an embodiment of the described collaboration where an interactive application provided by an interactive controller of a user transfer interleaved wagering system is a first person shooter game. The process begins by a user selecting a machine gun to use in the game and then fires a burst of bullets at an opponent. The interactive controller can communicate to the application controller of the user's choice of weapon, that a burst of bullets was fired, and/or the outcome of the burst. The application controller communicates to the wager controller that 3 credits (Cr) are to be wagered on the outcome of a wagering event to match the three bullets consumed. The wager controller then performs the wagering event and determines the result of the wager and may determine the winnings from a paytable. The wager controller consumes 3 credits of Cr for the wager and executes the specified wager. By way of example, the wager controller may determine that the user hit a jackpot of 6 credits and returns the 6 credits to the Cr and communicates to the application controller that 3 net credits were won by the user.

The application controller communicates to the interactive controller to add 3 bullets to an ammunition clip. The interactive controller adds 3 bullets back to the ammo clip. The ammunition may be added by directly adding the ammunition to the clip or by allowing the user to find extra ammunition during use. The application controller logs the new user score (AC) in the game (as a function of the successful hit on the opponent) based on the interactive controller communication, and adds 2 extra points to the user score since a jackpot has been won. The application controller then adds 10 points to the user score (AC) given the success of the hit which in this example is worth 8 points, plus the 2 extra point. Note that this example is only intended to provide an illustration of how credits flow in a user transfer interleaved wagering system, but is not intended to be exhaustive and only lists only one of numerous possibilities of how a user transfer interleaved wagering system may be configured to manage its fundamental credits.

In many embodiments, user management and session controller 1020, such as user account controller 150 of FIG. 1A, of a user transfer interleaved wagering system is used to store AC for use of the user. In such an embodiment, AC is generated by the application controller based on the user's use of the user transfer interleaved wagering system and an amount of the AC is communicated to the user management and session controller 1020. The user management and session controller stores the amount of AC between user sessions. In some embodiments, the user management and session controller communicates an amount of AC to the application controller at the start of a user session for use by the user during a user session.

### User Registration and Management of User Profile Information

### —Interactive Application Modes—

A user transfer interleaved wagering system in accordance with an example embodiment operates in one of three modes: Guest Mode, User Mode and Wagering-Enabled Mode. In some embodiments, a user transfer interleaved wagering system operates in two modes: Guest Mode and Wagering-Enabled Mode. In some embodiments, a user transfer interleaved wagering system operates in one mode: Wagering-Enabled Mode.

In Guest Mode, the interactive controller (e.g., interactive controller 120 of FIG. 1) of the user transfer interleaved wagering system (e.g., 128 of FIG. 1) provides an interactive application of the user transfer interleaved wagering system in connection with a non-wagering application controller or a virtual currency credit application controller. In Guest Mode, the user transfer interleaved wagering system executes the interactive application for an un-registered user.

In User Mode, the interactive controller (e.g., interactive controller 120 of FIG. 1) of the user transfer interleaved wagering system (e.g., 128 of FIG. 1) provides an interactive application of the user transfer interleaved wagering system in connection with a non-wagering application controller or a virtual currency credit application controller. In User Mode, the user transfer interleaved wagering system provides the interactive application for a registered user that has been registered for the interactive application.

In Wagering-Enabled Mode, the interactive controller (e.g., interactive controller 120 of FIG. 1) of the user transfer interleaved wagering system (e.g., 128 of FIG. 1) provides an interactive application of the user transfer interleaved wagering system in connection with a real currency credit wagering application controller. In Wagering-Enabled Mode, the user transfer interleaved wagering system provides the interactive application for a registered user that has been registered for real currency credit wagering. In some implementations, in the Wagering-Enabled Mode the registered user has also been registered for the interactive application. In some implementations, in the Wagering-Enabled Mode the registered user has not been registered for the interactive application.

In some implementations, an application credits earning rate changes based on the mode of the user transfer interleaved wagering system. In an example embodiment, the application credits earning rate in User Mode may be higher than the application credits earning rate in Guest Mode, and the application credits earning rate in Wagering-Enabled Mode may be higher than the application credits earning rate in User Mode.

### —User Registration for the Interactive Application—

In the example embodiment, registration for the interactive application is performed by using a user registration user interface (e.g., 1062 of FIG. 10) in connection with a user registration module (e.g., 1064 of FIG. 10). In the example embodiment, a processor of a user's device (e.g., 1061 of FIG. 10) executes processor-executable instructions that when executed, control the user's device to provide the user registration user interface. User registration information is received by the user's device via the user registration user interface. In some embodiments, the user's device comprises an interactive controller (e.g., 120 of FIG. 1).

The user's device provides the received user registration information to the user registration module (e.g., 1064 of FIG. 10), which generates user profile data based on the received user registration information. In an example implementation, the user profile data includes authorization credentials for the interactive application. In some implementations, the user profile data includes user contact information, such as, for example, an e-mail address, a phone number, a mailing address, social network account information, and the like. During operation of the interactive application, the user profile data is updated to include interactive application score data, data associated with controlled entities (such as characters used by a user in user transfer interleaved wagering system interactive application interaction), tournament reservation data, and data identifying elements, virtual credits (VRC) and application credits associated with the user. In some implementations, the elements (including elements acquired from in-application purchases), virtual credits (VRC) and application credits are managed by a user wallet, and the user profile data includes information for accessing the user wallet. In some implementations, the elements (including elements acquired from in-application purchases), virtual credits (VRC) and application credits are managed by a user wallet, and the user profile data includes the user wallet.

In some implementations, the user registration information includes payment information for in-application purchases (e.g., of elements and VRC), and the user registration module includes the payment information in the user profile data.

### —User Registration for Real Currency Credit Wagering—

In the example embodiment, registration for real currency credit wagering is performed as described above with respect to user registration for the interactive application. In addition, the user registration module (e.g., 1064 of FIG. 10) generates real currency credit wagering identification information, for identifying the user in accordance with real currency credit wagering regulations of one or more real currency credit wagering jurisdictions. In some implementations, the user registration information includes real currency credit wagering payment information for purchase of RC, and the user registration module includes the real currency credit wagering payment information in the user profile data. During operation of the real currency credit wagering application, the user profile data is updated to include RC. In some implementations, the RC, along with elements (including elements acquired form in-application purchases), virtual credits (VRC) and application credits are managed by a user wallet, and the user profile data includes information for accessing the user wallet. In some implementations, the RC, along with the elements (including elements acquired form in-application purchases), virtual credits (VRC) and application credits are managed by a user wallet, and the user profile data includes the user wallet.

In an example implementation, registration for real currency credit wagering is performed in a case where the user's device (e.g., 1061 of FIG. 10) is communicatively coupled with a real currency credit wagering application controller. In an example embodiment, in a case where the user's device enters a real currency credit wagering jurisdiction and a real currency credit wagering application controller is selected, the user's device provides a real currency credit wagering user registration user interface (e.g., 1062 of FIG. 10) to perform user registration for real currency credit wagering by using the selected application controller. In some implementations, registration for real currency credit wagering is performed in a case where the user's device (e.g., 1061 of FIG. 10) is not communicatively coupled with a real currency credit wagering application controller. In an example embodiment, a user may be pre-registered for real currency credit wagering prior to the user's device entering a real currency credit wagering jurisdiction, such that real currency credit wagering may be seamlessly enabled upon entering the real currency credit wagering jurisdiction. In some implementations, the pre-registration is an application controller-specific pre-registration in which the user is registered for real currency credit wagering with a specific application controller (e.g., an application controller in a specific jurisdiction or an application controller operated by a specific real currency credit wagering operator). In some implementations, the pre-registration is a universal pre-registration in which the user is registered for real currency credit wagering with any real currency credit wagering application controller.

### —Control of User Profile Data—

In an example implementation, a processor of a user registration device (e.g., 1063 of FIG. 10) external to the user's device includes the user registration module. In more detail, the user registration device stores processor-executable instructions that when executed by the processor of the user registration device, control the user registration device to provide the functionality of the user registration module, which generates user profile data based on received user registration information. The user registration device is controlled by one of an interactive application publisher of the interactive application, an interactive application publisher of the user transfer interleaved wagering system, an interactive application publisher of the real money interactive application, an operator of the interactive application, an operator of the user transfer interleaved wagering system, and an operator of the real money interactive application.

In an example implementation, the user registration module stores the generated user profile data in a user profile data store (e.g., 1065 of FIG. 10). The user profile data store is controlled by one of an interactive application publisher of the interactive application, an interactive application publisher of the user transfer interleaved wagering system, an interactive application publisher of the real money interactive application, an operator of the interactive application, an operator of the user transfer interleaved wagering system, and an operator of the real money interactive application.

In an example embodiment in a case where a user registers to play the Furious Avians interactive application published by X Application Publisher, the user's device (e.g., 1061 of FIG. 10) performs the user registration in connection with a user registration device controlled by the interactive application publisher X Application Publisher, and the user registration device stores the generated user profile data in a user profile data store controlled by the interactive application publisher X Application Publisher.

In a case where a user registers to play the Furious Avians user transfer interleaved wagering system published by X Application Publisher, the user's device (e.g., 1061 of FIG. 10) performs the user registration in connection with a user registration device controlled by the user transfer interleaved wagering system publisher X Application Publisher, and the user registration device stores the generated user profile data in a user profile data store controlled by the user transfer interleaved wagering system publisher X Application Publisher.

In a case where a user registers to play the Furious Avians interactive application operated by Operator A, the user's device (e.g., 1061 of FIG. 10) performs the user registration in connection with a user registration device controlled by the Operator A, and the user registration device stores the generated user profile data in a user profile data store controlled by the Operator A.

In some implementations, in a case where the user has been registered for the interactive application, but not the wagering application, when the user's device enters a real currency credit wagering jurisdiction and a real currency credit wagering application controller of Operator A is selected, the user's device (e.g., 1061 of FIG. 10) performs the real application user registration in connection with a user registration device controlled by the Operator A. In some implementations, the user registration device stores the generated user profile data in a user profile data store controlled by the Operator A. In some implementations, the user registration device provides the generated user profile data to a user profile data store controlled by the entity that performed the user registration for the interactive application.

In the example embodiment, after the user registration module generates the user profile data, the user registration module registers the user profile data with a patron management server. In some embodiments, the patron management server is a session management controller, as described herein.

### —User's Device, User Registration Device and Patron Management Server—

User registration, as discussed above, is illustrated in FIG. 10. As illustrated in FIG. 10, the user's device 1061 provides a registration user interface 1062 for receiving user registration information (e.g., interactive application user registration information, real currency credit wagering user registration information, or any combination of interactive application user registration information and real currency credit wagering user registration information). The user's device 1061 provides user registration information received via the registration user interface 1062 to a user registration device 1063, as discussed above. A user registration module 1064 of the user registration device 1063 generates user profile data based on the user registration information received from the user's device 1061. The user registration module 1064 stores the generated user profile data in a user profile data store 1065. The user registration module 1064 also registers the generated user profile data with a patron management server 1066.

The user registration device 1063 is controlled by one of an interactive application publisher of the interactive application, an interactive application publisher of the user transfer interleaved wagering system, an interactive application publisher of the real money interactive application, an operator of the interactive application, an operator of the user transfer interleaved wagering system, and an operator of the real money interactive application. In some implementations, the patron management server 1066 is controlled by an operator of the user transfer interleaved wagering system.

In some implementations, the user registration device 1063 includes one or more of an application controller and a wager controller.

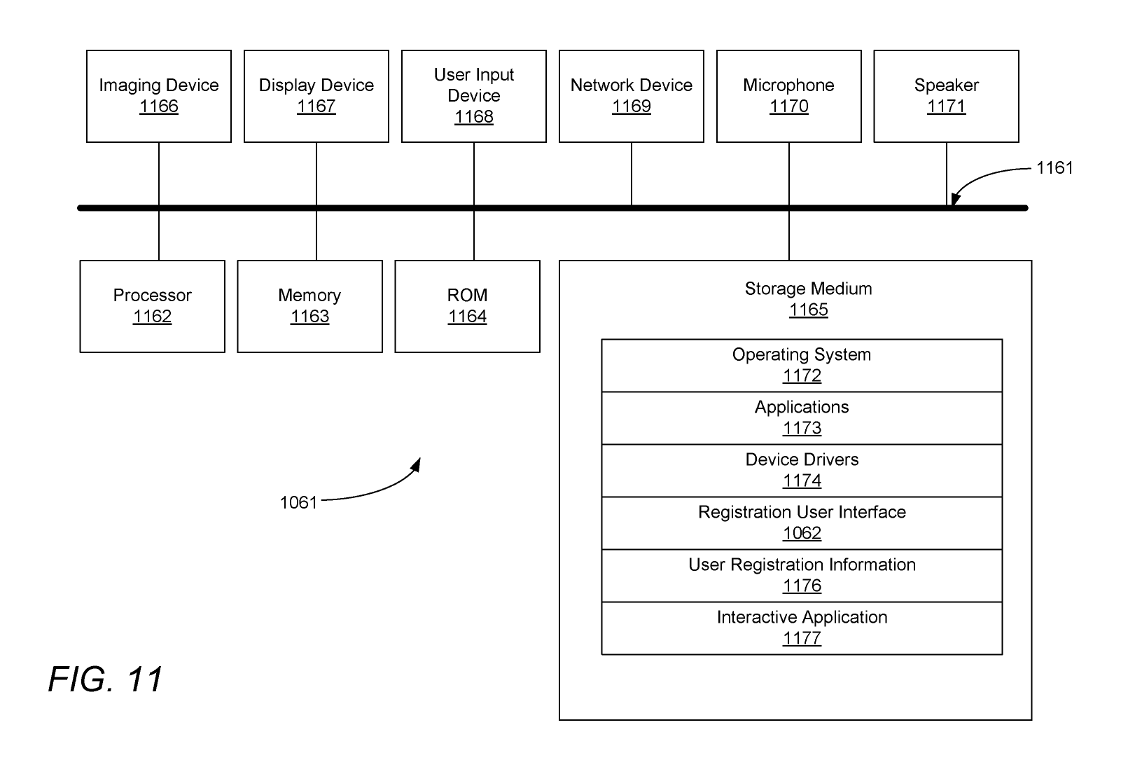

FIG. 11 is an illustration of the user's device 1061. In the example embodiment, the user's device is a portable device, such as, for example, a tablet computer, a smartphone or a portable device. In some embodiments, the user's device is an interactive controller, as described herein.

The bus 1161 interfaces with a processor 1162, a random access memory (RAM) 1163, a read only memory (ROM) 1164, a processor-readable storage medium 1165, an image capture device 1166, a display device 1167, a user input device 1168, a network device 1169, a microphone 1170, a speaker 1171, a GPS device (not shown), a proximity sensor (not shown), a motion sensor (not shown), an accelerometer (not shown), and a gyroscope (not shown).

The processor 1162 may take many forms, such as, for example, a central processing unit (processor), a multi-processor unit (MPU), an ARM processor, and the like.

The network device 1169 provides one or more wired or wireless interfaces for exchanging data and commands between the user's device 1061 and other devices. Such wired and wireless interfaces include, for example, a Universal Serial Bus (USB) interface, Bluetooth interface, Wi-Fi interface, Ethernet interface, Near Field Communication (NFC) interface, and the like.

Machine-executable instructions in software programs (such as an operating system 1172, application programs 1173, and device drivers 1174) are loaded into the memory 1163 from the processor-readable storage medium 1165, the ROM 1164 or any other storage location. During execution of these software programs, the respective machine-executable instructions are accessed by the processor 1162 via the bus 1161, and then executed by the processor 1162. Data used by the software programs are also stored in the memory 1163, and such data is accessed by the processor 1162 during execution of the machine-executable instructions of the software programs.

The processor-readable storage medium 1165 is a non-transitory processor-readable storage medium, such as, for example, a hard drive, a flash drive, a DVD, a CD, a flash storage, a solid state drive, and the like. The processor-readable storage medium 1165 includes an operating system 1172, the software programs 1173, device drivers 1174, a registration user interface 1062, user registration information 1176, and an interactive application 1177.

The registration user interface 1062 includes machine-executable instructions for controlling the processor 1162 to control the user's device 1061 to provide the registration user interface 1062, as described above. The interactive application 1177 includes machine-executable instructions for controlling the processor 1162 to control the user's device 1061 to provide the interactive application 1177 similar to the interactive application interactive controller 120 of FIG. 1. The interactive application 1177 is the interactive application of a user transfer interleaved wagering system, similar to the user transfer interleaved wagering system 128 of FIG. 1.

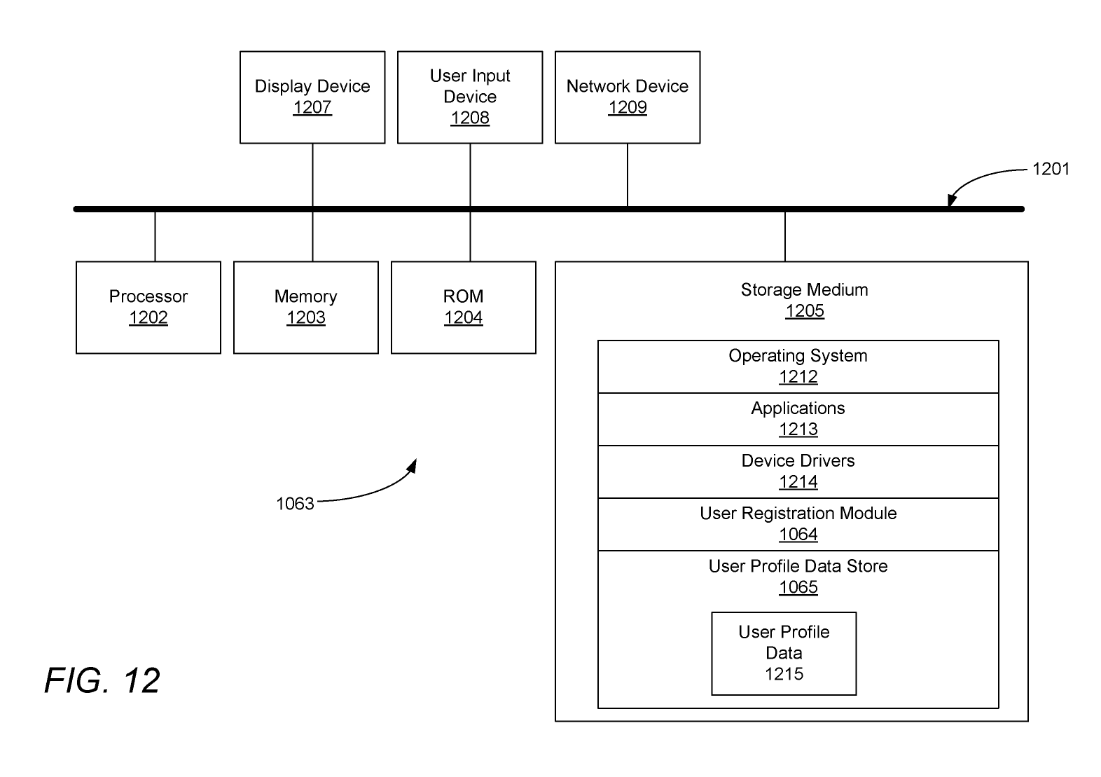

FIG. 12 is an illustration of the user registration device 1063. In the example embodiment, the user registration device 1063 is a server device.

The bus 1201 interfaces with a processor 1202, a random access memory (RAM) 1203, a read only memory (ROM) 1204, a processor-readable storage medium 1205, a display device 1207, a user input device 1208, and a network device 1209.

The processor 1202 may take many forms, such as, for example, a central processing unit (processor), a multi-processor unit (MPU), an ARM processor, and the like.

The network device 1209 provides one or more wired or wireless interfaces for exchanging data and commands between the user registration device 1063 and other devices, such as, for example, the user's device 1061. Such wired and wireless interfaces include, for example, a Universal Serial Bus (USB) interface, Bluetooth interface, Wi-Fi interface, Ethernet interface, Near Field Communication (NFC) interface, and the like.

Machine-executable instructions in software programs (such as an operating system 1212, application programs 1213, and device drivers 1214) are loaded into the memory 1203 from the processor-readable storage medium 1205, the ROM 1204 or any other storage location. During execution of these software programs, the respective machine-executable instructions are accessed by the processor 1202 via the bus 1201, and then executed by the processor 1202. Data used by the software programs are also stored in the memory 1203, and such data is accessed by the processor 1202 during execution of the machine-executable instructions of the software programs.

The processor-readable storage medium 1205 is a non-transitory processor-readable storage medium, such as, for example, a hard drive, a flash drive, a DVD, a CD, a flash storage, a solid state drive, and the like. The processor-readable storage medium 1205 includes an operating system 1212, the software programs 1213, device drivers 1214, the user registration module 1064, and the user profile data store 1065. The user profile data store 1065 includes user profile data 1215.

The user registration module 1064 includes machine-executable instructions for controlling the processor 1202 to control the user registration device 1063 to generate user profile data and register the user profile data with the patron management server 1066, as described above.

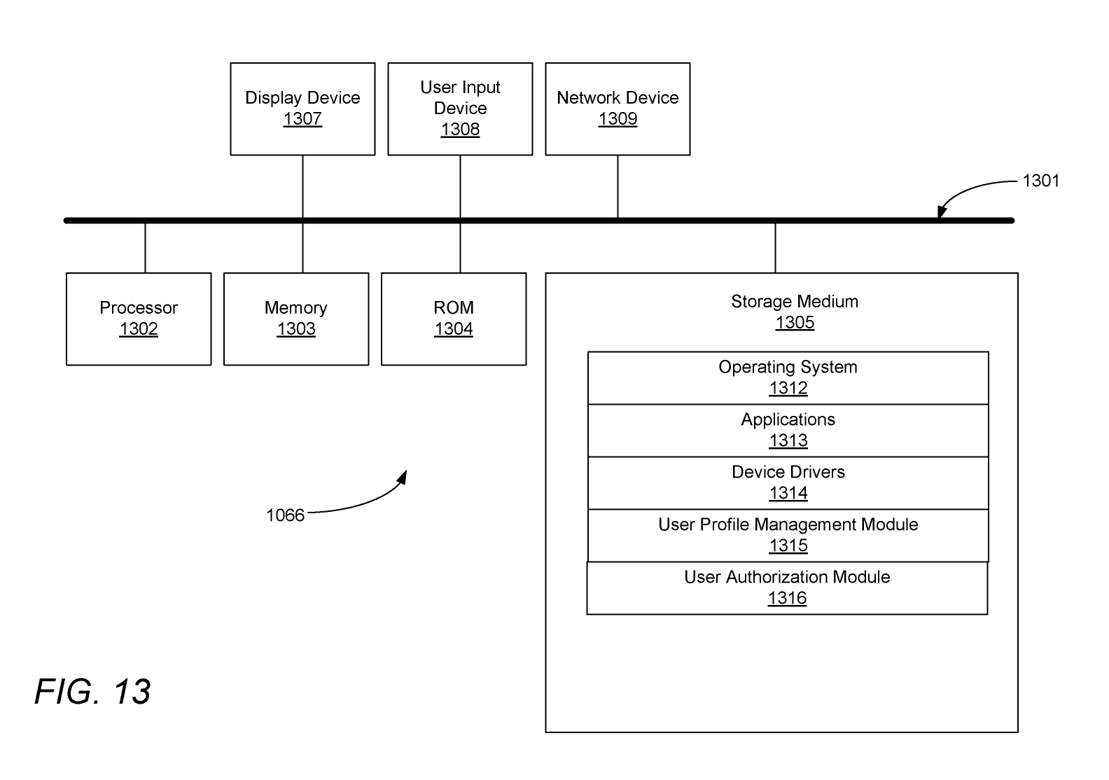

FIG. 13 is an illustration of the patron management server 1066. In the example embodiment, the patron management server 1066 is a server device. In some embodiments, the patron management server 1066 is a session management controller, as described herein.

The bus 1301 interfaces with a processor 1302, a random access memory (RAM) 1303, a read only memory (ROM) 1304, a processor-readable storage medium 1305, a display device 1307, a user input device 1308, and a network device 1309.

The processor 1302 may take many forms, such as, for example, a central processing unit (processor), a multi-processor unit (MPU), an ARM processor, and the like.

The network device 1309 provides one or more wired or wireless interfaces for exchanging data and commands between the patron management server 1066 and other devices, such as, for example, the user registration device 1063. Such wired and wireless interfaces include, for example, a Universal Serial Bus (USB) interface, Bluetooth interface, Wi-Fi interface, Ethernet interface, Near Field Communication (NFC) interface, and the like.

Machine-executable instructions in software programs (such as an operating system 1312, application programs 1313, and device drivers 1314) are loaded into the memory 1303 from the processor-readable storage medium 1305, the ROM 1304 or any other storage location. During execution of these software programs, the respective machine-executable instructions are accessed by the processor 1302 via the bus 1301, and then executed by the processor 1302. Data used by the software programs are also stored in the memory 1303, and such data is accessed by the processor 1302 during execution of the machine-executable instructions of the software programs.

The processor-readable storage medium 1305 is a non-transitory processor-readable storage medium, such as, for example, a hard drive, a flash drive, a DVD, a CD, a flash storage, a solid state drive, and the like. The processor-readable storage medium 1305 includes an operating system 1312, the software programs 1313, device drivers 1314, a user profile management module 1315 and a user authorization module 1316.

In some implementations, the user profile management module 1315 includes user profile data, and the user profile management module 1315 includes machine-executable instructions for controlling the processor 1302 to control the patron management server to receive user profile data from a user registration device (e.g., user registration device 1063). In some implementations, the user profile management module 1315 includes information for accessing the user profile data from another device, such as, for example, the user registration device 1063, and the user profile management module 1315 includes machine-executable instructions for controlling the processor 1302 to control the patron management server to receive information for accessing the user profile data, the information being received from a user registration device (e.g., user registration device 1063).

In some implementations, the user profile management module 1315 includes machine-executable instructions for controlling the processor 1302 to control the patron management server to, update user profile data based on information received from an application controller, update user profile data based on information received from an interactive application (or interactive controller), provide information based on the user profile data to an application controller, provide information based on the user profile data to an interactive application (or interactive controller), and control access to the user profile data. In some implementations, the user profile management module 1315 provides the user profile data to an application controller or interactive controller. In some implementations, the user profile management module 1315 provides a portion of the user profile data to an application controller or interactive controller. In some implementations, the user profile management module 1315 provides information generated from the user profile data to an application controller or interactive controller. In some implementations, the user profile management module 1315 provides a link to user profile data to an application controller or interactive controller.

In some implementations, the user authorization module 1316 includes machine-executable instructions for controlling the processor 1302 to control the selection of an application controller for use in the user transfer interleaved wagering system.

### —Establishing an Application Session in Guest Mode—

In the example embodiment, the user's device 1061 initiates an application session in Guest Mode in response to reception (via the user input device 1168) of a user instruction to initiate an application session in a case where the user instruction does not specify user authorization credentials. The user's device 1061 initiates the application session by executing the interactive application 1177. In Guest Mode, the user's device 1061 initiates the application session by executing the interactive application 1177 in connection with a non-wagering application controller or a virtual currency credit application controller.

### —Establishing an Application Session in User Mode—

In the example embodiment, the user's device 1061 initiates an application session in User Mode in response to reception (via the user input device 1168) of a user instruction to initiate an application session in a case where the user instruction specifies user authorization credentials for a user for whom real currency credit wagering has not been enabled. The user's device 1061 initiates the application session by executing the interactive application 1177. In User Mode, the user's device 1061 initiates the application session by executing the interactive application 1177 in connection with a non-wagering application controller or a virtual currency credit application controller.

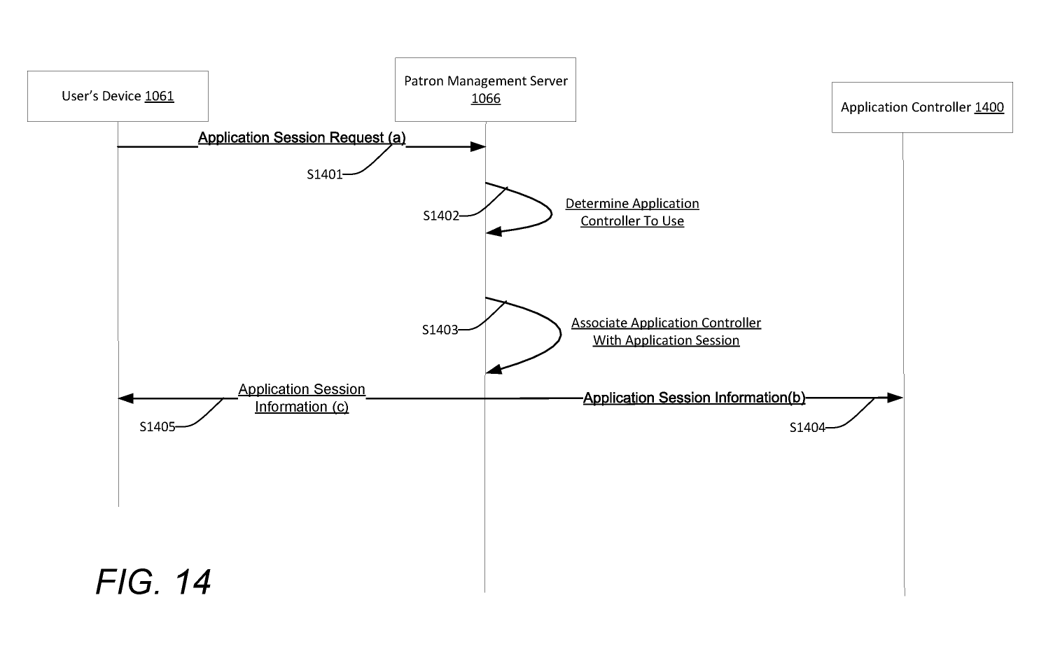

FIG. 14 is a sequence diagram of an embodiment of a user transfer interleaved wagering system illustrating establishment of an application session in User Mode. In some embodiments, the system includes a user's device, a patron management server, and an application controller. In some embodiments, the user's device is an interactive controller, as described herein. In some embodiments, the patron management server operatively connects the user's device to the application controller.

At S1401, the user's device 1061 communicates request data for an application session to the patron management server 1066.

At S1402, in response to reception of the request for the application session, the patron management server 1066 scans the request data to determine a non-wagering application controller or a virtual currency credit application controller (e.g., application controller 1400) to be used. At S1403, the patron management server 1600 associates the application controller 1400 with the application session. In some embodiments, the patron management server 1066 is a session management controller, as described herein.

The patron management server 1066 generates application session instructions using the determined application controller 1400. At S1404, the patron management server 1066 dynamically configures the application controller 1400 by communicating the application session instructions to the application controller 1400 (e.g., a non-wagering application controller or a virtual currency credit application controller), thereby notifying the application controller 1400 that the application controller 1400 has been bound to an application session with the user's device 1061. In the case of an interactive application that is being resumed, the application session information includes information based on user profile data (e.g., 1215 of FIG. 12) corresponding to a user of the device 1061.

In some implementations, the user profile data (e.g., 1215 of FIG. 12) corresponding to the user of the device 1061 is controlled by an entity that is different from an entity that controls the patron management server 1066, and the patron management server 1066 accesses the user profile data from the user profile data store (e.g., 1065 of FIG. 10) of the entity that controls the user profile data for the user.

The patron management server 1066 stores binding information that indicates that the user's device 1061 is bound to the application controller 1400. At S1405, the patron management server 1066 dynamically configures the user's device 1061 by communicating the application session instructions to the user's device 1061.

During the application session, the user's device 1061 communicates application telemetry (e.g., application telemetry 124 of FIG. 1) to the application controller 1400. The application controller 1400 receives the application telemetry and scans the application telemetry. The application controller 1400 generates application resource instructions using a wager outcome received from a wager controller. The application controller 1400 instructs the user's device 1061 by communicating the application resource instructions to the user's device 1061. The application resource instructions include application resources (e.g., application resources 136 of FIG. 1). The application telemetry includes session information. During the interactive application session, the patron management server 1066 receives updated application session data from the application controller 1400. The updated application session information may include, but is not limited to, user, interactive controller, application controller and wager controller information.

The patron management server 1066 scans the updated application session data to determine the user, interactive controller, application controller and wager controller information. The patron management server 1066 uses the user, interactive controller, application controller and wager controller information to regulate the application session. In some implementations, the patron management system 1066 may also assert control of the application session. Such control may include, but is not limited to, ending an application session.

In some implementations, the patron management server 1066 updates the user profile data (e.g., 1215 of FIG. 12) corresponding to the user of the device 1061 based on the updated application session data. More specifically, the patron management server 1066 updates the user profile data in the user profile data store (e.g., 1065 of FIG. 10) of the entity that controls the user profile data for the user. In an example embodiment, if an interactive application publisher registered the user, and the interactive application publisher controls the user profile data for the user, then the patron management server 1066 updates the user profile data in the user profile data store of the interactive application publisher such that the interactive application publisher controls an updated copy of the user profile data.

### —Establishing an Application Session in Wagering-Enabled Mode—

In the example embodiment, the user's device 1061 initiates an application session in Wagering-Enabled Mode in response to reception (via the user input device 1168) of a user instruction to initiate an application session in a case where the user instruction specifies user authorization credentials for a user for whom real currency credit wagering has been enabled. The user's device 1061 initiates the application session by executing the interactive application 1177. In Wagering-Enabled Mode, the user's device 1061 initiates the application session by executing the interactive application 1177 in connection with a real currency credit wagering application controller.

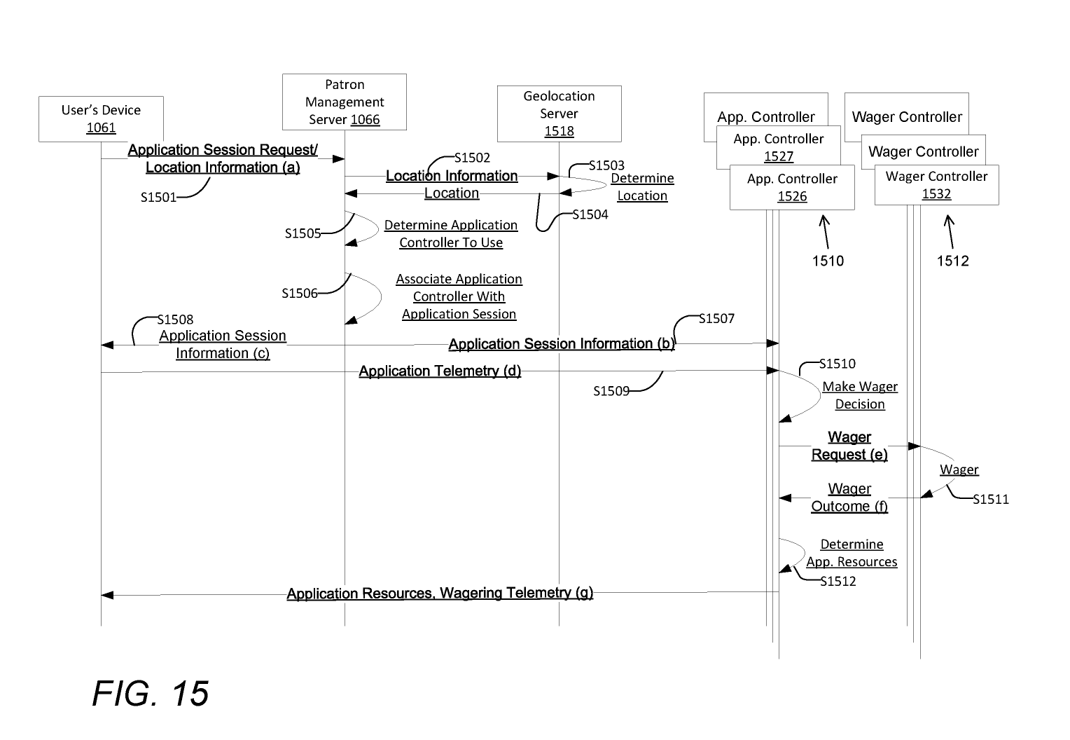

FIG. 15 is a sequence diagram of an embodiment of a user transfer interleaved wagering system, illustrating establishment of an application session in Wagering-Enabled Mode. In some embodiments, the system includes a user's device, a patron management server, a geolocation server, one or more application controllers, and one or more wager controller. In some embodiments, the user's device is an interactive controller, as described herein. In some embodiments, the patron management server operatively connects the user's device to one of the one or more application controllers.

At S1501, the user's device 1061 communicates application session request data (a) to the patron management server 1066. In some embodiments, the patron management server is a session management controller, as described herein. The application session request data includes location information of the user's device 1061. In an implementation, the location information of the user's device 1061 is determined by a GPS device of the user's device 1061.

The patron management server 1066 receives, from the user's device 1061, the application session request data. The patron management server 1066 scans the application session request data to determine location information. The patron management server 1066 generates location information request instructions based on the location information. At S1502, the patron management server 1066 instructs a geolocation server 1518 by communicating the location information request instructions to the geolocation server 1518. The geolocation server 1518 receives the location information request instructions and scans the location information request instructions to determine location information.

At S1503, the geolocation server 1518 uses the location information to determine the location of the user's device 1061. At S1504, the geolocation server 1518 communicates user device location data to the patron management server 1066.

The patron management server 1066 receives the user device location data from the geolocation server 1518 and scans the user device location data to determine the location of the user's device 1061. At S1505, the patron management server 1066 determines which of a plurality of application controllers 1510 to use, based on the determined location of the user's device 1061.

At S1506, the patron management server 1066 associates the determined application controller (e.g., application controller 1526) with the application session. In an example embodiment, if the user's device 1061 is located in a jurisdiction in which real currency credit wagering is allowed, then the patron management server 1066 selects an application controller 1526 that enables real currency credit wagering. However, if the user's device 1061 is located in a jurisdiction in which real currency credit wagering is not allowed, then the patron management server 1066 selects an application controller 1527 that enables virtual currency credit application and not real currency credit wagering.

In some implementations, in a case in which there are more than one application controllers that enable real currency credit wagering in a same jurisdiction, then the patron management server 1066 selects one of the real currency credit wagering application controllers based on at least one of user profile data (corresponding to a user of the user's device 1061) and information received via the user input device 1168 of the user's device 1061. In an example embodiment an application controller of Operator A and an application controller of Operator B may provide real currency credit wagering in a same jurisdiction, and one of the application controllers may be selected based on a user's prior registration with a particular operator, as identified by user profile data, or based on user selection via the user input device of the user's device 1061.

The patron management server 1066 generates application session instructions using the selected application controller 1526. At S1507, the patron management server 1066 dynamically configures the selected application controller by communicating the application session instructions (b) to the selected application controller 1526, thereby notifying the selected application controller 1526 that the selected application controller 1526 has been selected and bound to an application session with the user's device 1061.

In the case of an interactive application that is being resumed, the application session information includes information based on user profile data (e.g., 1215 of FIG. 12) corresponding to a user of the device 1061.

In some implementations, the user profile data (e.g., 1215 of FIG. 12) corresponding to the user of the device 1061 is controlled by an entity that is different from an entity that controls the patron management server 1066, and the patron management server 1066 accesses the user profile data from the user profile data store (e.g., 1065 of FIG. 10) of the entity that controls the user profile data for the user.

The patron management server 1066 stores binding information that indicates that the user's device 1061 is bound to the application controller 1526.

At S1508, the patron management server 1066 dynamically configures the user's device 1061 by communicating the application session instructions (c) to the user's device 1061.

During the application session, the user's device 1061 communicates application telemetry (d) (e.g., application telemetry 124 of FIG. 1) to the selected application controller 1526 (at S1509). At S1510, the application controller 1526 receives the application telemetry and scans the application telemetry to determine a wagering decision, as described herein. If a wager is to be made, the application controller 1526 generates wager request instructions using the wagering decision and instructs the wager controller 1532 by communicating the wager request instructions (e) to the wager controller 1532 that is associated with the application controller 1526. At S1511, the wager controller 1532 receives the wager request instructions, scans the wager request instructions for the wager request, and makes the requested wager. The wager controller communicates wagering outcome data (f) to the application controller 1526.

At S1512, the application controller 1526 receives the wagering outcome data from the wager controller 1532, scans the wager outcome data to determine the wager outcome, and generates application resource instructions including application resources to be allocated in the application session as a result of the wagering outcome and application information as described herein. The application controller 1526 instructs the user's device by communicating the application resource instructions and telemetry (g) (e.g., wager telemetry 146 of FIG. 1) as described herein to the user's device 1061.

During the interactive application session, the patron management server 1066 receives updated application session data from the application controller 1526. The updated application session data may include, but is not limited to, user, interactive controller, application controller and wager controller information.

The patron management server 1066 scans the updated application session data to determine the user, interactive controller, application controller and wager controller information to regulate the application session. In some implementations, the patron management server 1066 may also assert control of the application session. Such control may include, but is not limited to, ending the application session, initiating wagering in the application session, ending wagering in the application session but not ending a user's play of the interactive application portion of the interactive application, changing from real credit wagering to virtual credit wagering, or changing from virtual credit wagering to real credit wagering.

In some implementations, the patron management server 1066 updates the user profile data (e.g., 1215 of FIG. 12) corresponding to the user of the device 1061 based on the updated application session data. More specifically, the patron management server 1066 updates the user profile data in the user profile data store (e.g., 1065 of FIG. 10) of the entity that controls the user profile data for the user. In an example embodiment, if an application publisher registered the user, and the application publisher controls the user profile data for the user, then the patron management server 1066 updates the user profile data in the user profile data store of the application publisher such that the application publisher controls an updated copy of the user profile data.

In some implementations, the patron management server 1066, the wager controllers 1512 and the application controllers 1510 are all instantiated on the same hosting device and/or server. In some implementations, the patron management server 1066, the wager controller 1512 and the application controllers 1510 are instantiated on more than one hosting device and/or server.

—Moving from a Non-Wagering Jurisdiction to a Real Currency Credit Wagering Jurisdiction—

In Wagering-Enabled Mode, an application session may transition from virtual credit wagering to real credit wagering in a case where a location of the user's device 1061 moves from a jurisdiction in which real currency credit wagering is not allowed to a jurisdiction in which real currency credit wagering is allowed.

In an example embodiment, a user may be playing an application session in Wagering-Enabled mode during a train ride from New York (a jurisdiction in which real currency credit wagering is not allowed) to New Jersey (a jurisdiction in which real currency credit wagering is allowed). While in New York, the application session involves virtual credit wagering. When the user moves into New Jersey (as determined by location information provided by the user's device), the application session transitions to real credit wagering.

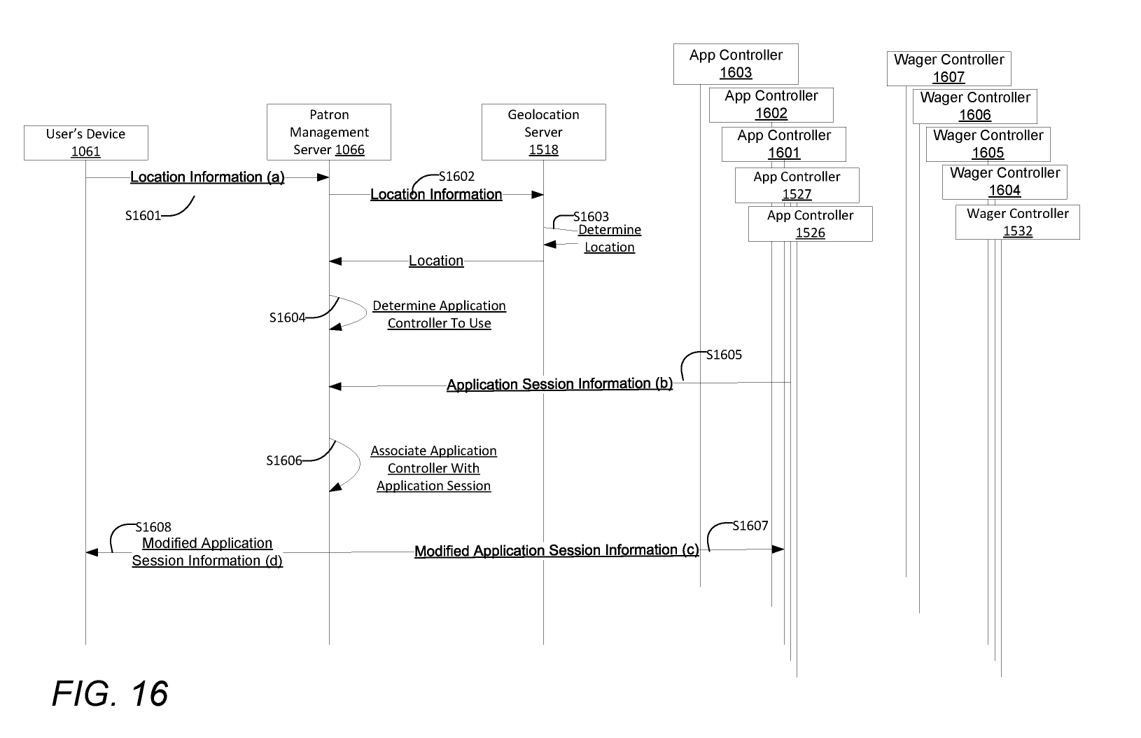

FIG. 16 is a sequence diagram of an embodiment of a user transfer interleaved wagering system. In some embodiments, the system includes a user's device, a patron management server, a geolocation server, one or more application controllers, and one or more wager controller. In some embodiments, the user's device is an interactive controller, as described herein. In some embodiments, the patron management server operatively connects the user's device to one of the one or more application controllers. The transition from virtual credit wagering to real credit wagering is performed by the patron management server 1066, as illustrated in FIG. 16.

In some implementations, the user's device 1061 continuously communicates location data associated with the user's device 1061 to the patron management server 1066. In an implementation, the user's device 1061 communicates location data associated with the user's device 1061 to the patron management server 1066 periodically. In an implementation, the user's device 1061 communicates the location data to the patron management server 1066 in a case where the user's device 1061 determines that the location of the user's device 1061 has moved a predetermined distance.

At S1601, the patron management server 1066 receives location data of the user's device 1061. In some embodiments, the patron management server is a session management controller, as described herein. At S1602, the patron management server 1066 scans the received location data to determine whether the user's device 1061 has moved into a new jurisdiction. In an implementation, the patron server 1066 determines the change of jurisdiction by using the geolocation server 1518 (S1603).

At S1604, in a case where the patron management server 1066 determines (based on the location information received from the user's device 1061) that the user's device has moved from a jurisdiction in which real currency credit wagering is not allowed to a jurisdiction in which real currency credit wagering is allowed, then the patron management server 1066 selects a application controller (e.g., one of application controller 1526, 1527, 1601, 1602, 1603) that enables real currency credit wagering.

In a case in which there are more than one application controllers that enable real currency credit wagering in a same jurisdiction, then the patron management server 1066 selects one of the real currency credit wagering application controllers based on at least one of user profile data (corresponding to a user of the user's device 1061) and information received via the user input device 1168 of the user's device 1061. In an example embodiment an application controller of Operator A and an application controller of Operator B may provide real currency credit wagering in a same jurisdiction, and one of the application controllers may be selected based on a user's prior registration with a particular operator, as identified by user profile data, or based on user selection via the user input device of the user's device 1061.

At S1605, the patron management server 1066 receives application session data from the current virtual currency credit application controller (e.g., application controller 1527). The patron management server 1066 scans the application session data and modifies the received application session data to associate the selected real currency credit wagering application controller (e.g., 1601) with the application session (at S1606). The patron management server 1066 communicates the modified application session data to the selected real currency credit wagering application controller 1601 (at S1607) and the user's device 1061 (at S1608).

After the user's device 1061 and the real currency credit wagering application controller receive the application session data, the application session continues with real credit wagering enabled, by using the real currency credit wagering application controller and an associated wager controller (e.g., one of wager controller 1532, 1604, 1605, 1606, 1607).

In this manner, an application session may transition from virtual credit wagering to real credit wagering in a case where a location of the user's device 1061 moves from a jurisdiction in which real currency credit wagering is not allowed to a jurisdiction in which real currency credit wagering is allowed.

In some implementations, the patron management server 1066 updates the user profile data (e.g., 1215 of FIG. 12) corresponding to the user of the device 1061 based on the modified application session information, as described above.

In some implementations, the application session information includes rule set information that identifies rules sets used in the application session, and the patron management server 1066 uses the rule set information to select an application controller (e.g., one of application controllers 1526, 1527, 1601, 1602, 1603) that enables virtual currency credit application in accordance with the identified rule sets. In some implementations, rule sets include, but are not limited to, rule sets that are specific to a particular jurisdiction and determine whether or not the application controller may make real money wagering decisions. In some implementations, the rule sets include, but are not limited to, rule sets that define what application resources may be transmitted to the interactive application from the application controller based on wagering outcomes and application information.

—Moving from One Real Currency Credit Wagering Jurisdiction to a New Real Currency Credit Wagering Jurisdiction—

In Wagering-Enabled Mode, an application session may transition from one real currency credit wagering jurisdiction to a new real currency credit wagering jurisdiction in a case where a location of the user's device 1061 moves to a new jurisdiction in which real currency credit wagering is allowed.

In an example embodiment, a user may be playing an application session in Wagering-Enabled mode during a train ride from New Jersey (a jurisdiction in which real currency credit wagering is allowed) to Delaware (a different jurisdiction in which real currency credit wagering is allowed). While in New Jersey, real currency credit wagering is provided by an application controller (and corresponding wager controller) that operates in accordance with real currency credit wagering regulations of New Jersey. When the user moves into Delaware (as determined by location information provided by the user's device), the application session transitions such that the real currency credit wagering is provided by an application controller (and corresponding wager controller) that operates in accordance with real currency credit wagering regulations of Delaware.

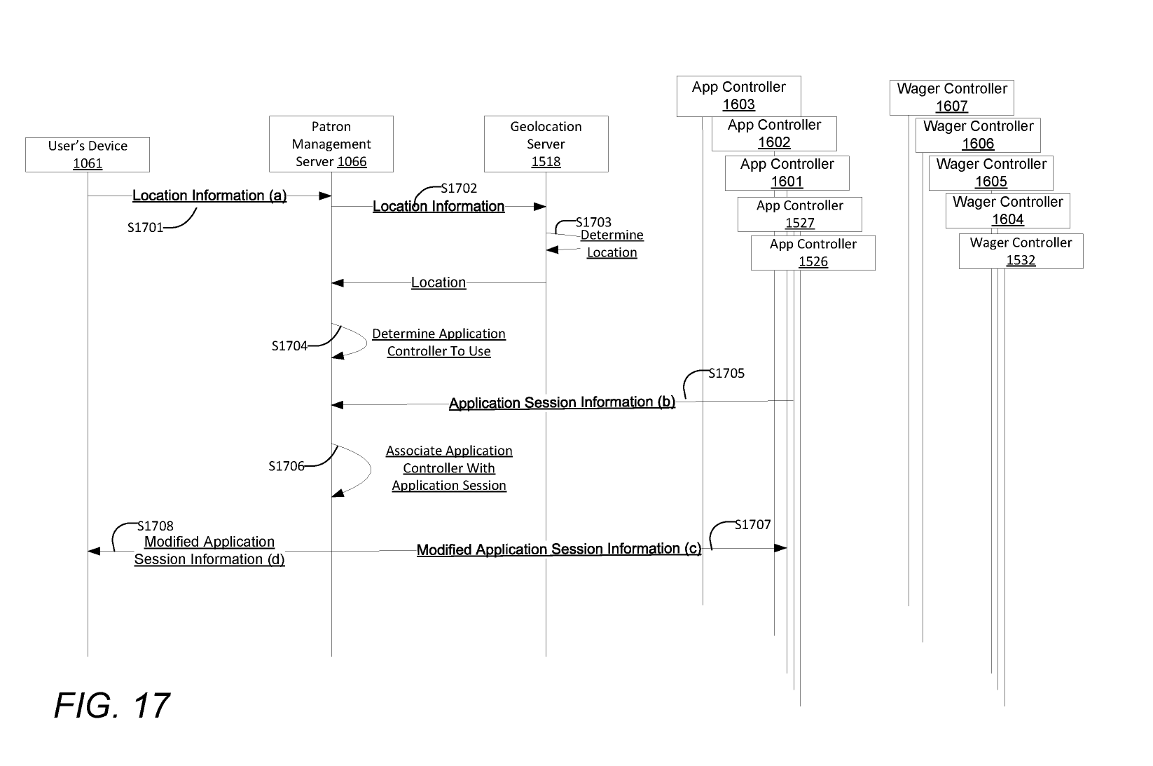

FIG. 17 is a sequence diagram of an embodiment of a user transfer interleaved wagering system. In some embodiments, the system includes a user's device, a patron management server, a geolocation server, one or more application controllers, and one or more wager controller. In some embodiments, the user's device is an interactive controller, as described herein. In some embodiments, the patron management server operatively connects the user's device to one of the one or more application controllers.

This transition from an application controller (and corresponding wager controller) of one real application jurisdiction to an application controller (and corresponding wager controller) of another real application jurisdiction is performed by the patron management server 1066, as illustrated in FIG. 17.

In some implementations, an operator may control multiple application controllers (and corresponding wager controllers). In an example embodiment, an operator may control application controllers in multiple jurisdictions such that the operator may continue providing real currency credit wagering in a case where a user changes jurisdictions.

At S1701, the patron management server 1066 receives location data of the user's device 1061 from the user's device 1061. In some embodiments, the patron management server is a session management controller, as described herein. At S1702, the patron management server 1066 scans the location data to determine whether the user's device 1061 has moved into a new jurisdiction. In an implementation, the patron server 1066 determines the change of jurisdiction by using the geolocation server 1518 (S1703).

At S1704, in a case where the patron management server 1066 determines (based on the location information received from the user's device 1061) that the user's device has moved to a new real application jurisdiction, then the patron management server 1066 selects a application controller (e.g., one of application controllers 1526, 1527, 1601, 1602, 1603) that enables real currency credit wagering in accordance with the real currency credit wagering regulations of the new jurisdiction.

In a case in which there are more than one application controllers that enable real currency credit wagering in the new jurisdiction, then the patron management server 1066 selects one of the real currency credit wagering application controllers based on at least one of user profile data (corresponding to a user of the user's device 1061) and information received via the user input device 1168 of the user's device 1061. In an example embodiment an application controller of Operator A and an application controller of Operator B may provide real currency credit wagering in a same jurisdiction, and one of the application controllers may be selected based on a user's prior registration with a particular operator, as identified by user profile data, or based on user selection via the user input device of the user's device 1061.

At S1705, the patron management server 1066 receives application session data from the current real currency credit wagering application controller (e.g., application controller 1601). The patron management server 1066 scans the application session data to determine application session information. The patron management server 1066 modifies the received application session information to associate the selected real currency credit wagering application controller (e.g., 1602) for the new real currency credit wagering jurisdiction with the application session (at S1706). The patron management server communicates modified application session data, including the modified application session information, to the selected real currency credit wagering application controller 1602 (at S1707) and the user's device 1061 (at S1708).

After the user's device 1061 and the real currency credit wagering application controller 1602 receive the modified application session data, the application session continues with real credit wagering enabled, by using the real currency credit wagering application controller 1602 and an associated wager controller (e.g., one of wager controller 1532, 1604, 1605, 1606, 1607).

In this manner, an application session may transition from one real currency credit wagering jurisdiction (in which the application controller 1601 is used) to a new real currency credit wagering jurisdiction (in which the application controller. 1602 is used) in a case where a location of the user's device 1061 moves to a new jurisdiction in which real currency credit wagering is allowed.

In some implementations, the patron management server 1066 updates the user profile data (e.g., 1215 of FIG. 12) corresponding to the user of the device 1061 based on the modified application session information, as described above.

In some implementations, the application session information includes rule set information that identifies rules sets used in the application session, and the patron management server 1066 uses the rule set information to select an application controller (e.g., one of application controller 1526, 1527, 1601, 1602, 1603) that enables virtual currency credit application in accordance with the identified rule sets. In some implementations, rule sets include, but are not limited to, rule sets that are specific to a particular jurisdiction and determine whether or not the application controller may make real money wagering decisions. In some implementations, the rule sets include, but are not limited to, rule sets that define what application resources may be transmitted to the interactive application from the application controller based on wagering outcomes and application information.

### —Changing Application Operators in a Same Real Currency Credit Wagering Jurisdiction—

In Wagering-Enabled Mode, an application session may transition from an application controller operated by one real currency credit wagering operator to a new application controller operated by a new real currency credit wagering operator in the same jurisdiction.

In an example embodiment, while playing an interactive application that uses an application controller operated by A to provide real currency credit wagering, a user of the interactive application receives a special offer from B to play the interactive application with B. In such a situation, the user may wish to change the real currency credit wagering operator of the current application session so that the user may take advantage of B's special offer.

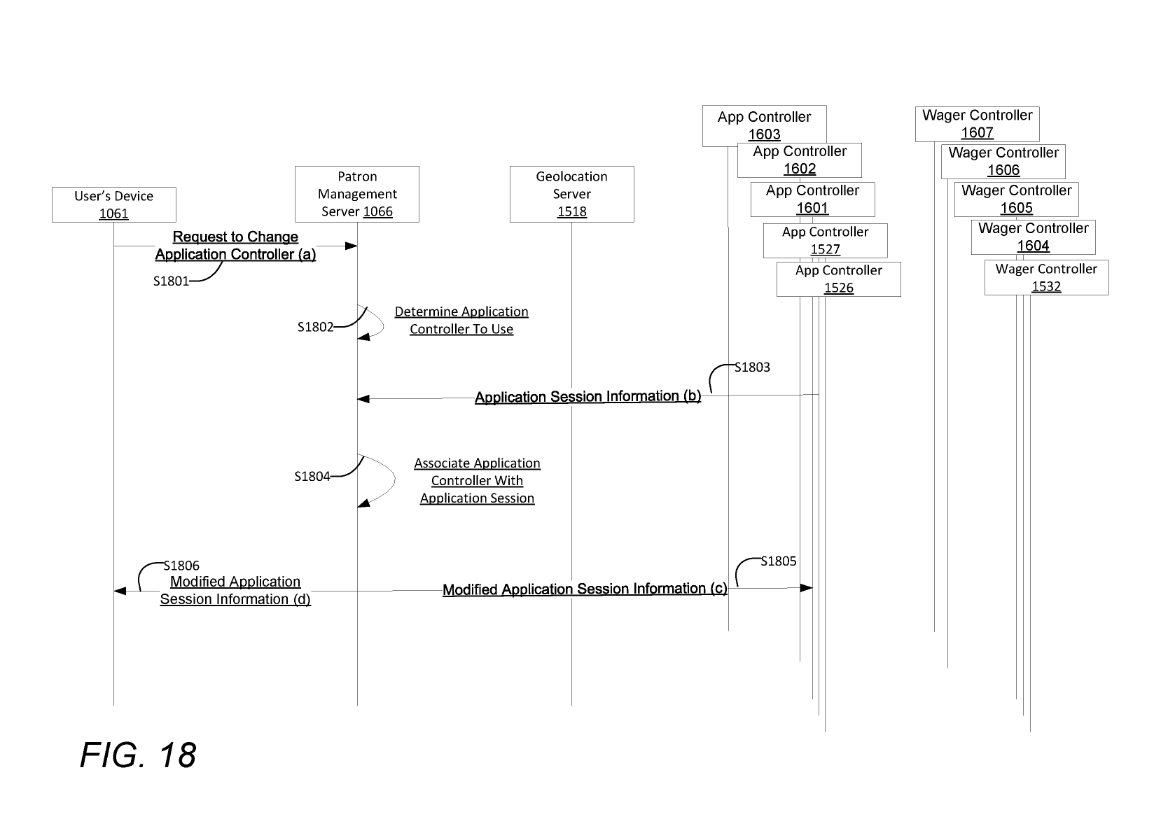

FIG. 18 is a sequence diagram of an embodiment of a user transfer interleaved wagering system. In some embodiments, the system includes a user's device, a patron management server, a geolocation server, one or more application controllers, and one or more wager controller. In some embodiments, the user's device is an interactive controller, as described herein. In some embodiments, the patron management server operatively connects the user's device to one of the one or more application controllers.

This transition from an application controller (and corresponding wager controller) of one real currency credit wagering operator to an application controller (and corresponding wager controller) of another real currency credit wagering operator is performed by the patron management server 1066, as illustrated in FIG. 18.

At S1801, the patron management server 1066 receives from the user's device 1061 a request to change the application controller of the application session to a new application controller that is controlled by a specified operator. In some embodiments, the patron management server 1066 is a session management controller, as described herein. At S1802, the patron management server 1066 scans the request to change the application controller of the application session to a new application controller that is controlled by a specified operator. The patron management server 1066 selects a real currency credit wagering application controller (e.g., 1603) of the specified operator that provides real currency credit wagering in accordance with a jurisdiction in which the user's device 1061 is located.

At S1803, the patron management server 1066 receives application session data from the current real currency credit wagering application controller (e.g., application controller 1602). The patron management server 1066 scans the application session data to determine application session information. The patron management server 1066 modifies the application session information to associate the selected real currency credit wagering application controller (e.g., 1603) for the specified operator with the application session (at S1804), and communicates modified application session data, including the modified application session information, to the selected real currency credit wagering application controller 1603 (at S1805) and the user's device 1061 (at S1806).

After the user's device 1061 and the real currency credit wagering application controller 1603 receive the modified application session data, the application session continues with real credit wagering enabled, by using the real currency credit wagering application controller 1603 and an associated wager controller (e.g., one of wager controller 1532, 1604, 1605, 1606, 1607).

In this manner, an application session may transition from an application controller operated by one real currency credit wagering operator to a new application controller operated by a new real currency credit wagering operator in the same jurisdiction.

In some implementations, the patron management server 1066 updates the user profile data (e.g., 1215 of FIG. 12) corresponding to the user of the device 1061 based on the modified application session information, as described above.

In some implementations, the application session information includes rule set information that identifies rules sets used in the application session, and the patron management server 1066 uses the rule set information to select an application controller (e.g., one of application controller 1526, 1527, 1601, 1602, 1603) that enables virtual currency credit application in accordance with the identified rule sets. In some implementations, rule sets include, but are not limited to, rule sets that are specific to a particular jurisdiction and determine whether or not the application controller may make real money wagering decisions. In some implementations, the rule sets include, but are not limited to, rule sets that define what application resources may be transmitted to the interactive application from the application controller based on wagering outcomes and application information.

—Moving from a Real Currency Credit Wagering Jurisdiction to a Non-Application Jurisdiction—

In Wagering-Enabled Mode, an application session may transition from real credit wagering to virtual credit wagering in a case where a location of the user's device 1061 moves from a jurisdiction in which real currency credit wagering is allowed to a jurisdiction in which real currency credit wagering is not allowed.

In an example embodiment, a user may be playing an application session in Wagering-Enabled mode during a train ride from New Jersey (a jurisdiction in which real currency credit wagering is allowed) to New York (a jurisdiction in which real currency credit wagering is not allowed). While in New Jersey, the application session involves real credit wagering. When the user moves into New York (as determined by location information provided by the user's device), the application session transitions to virtual credit wagering.

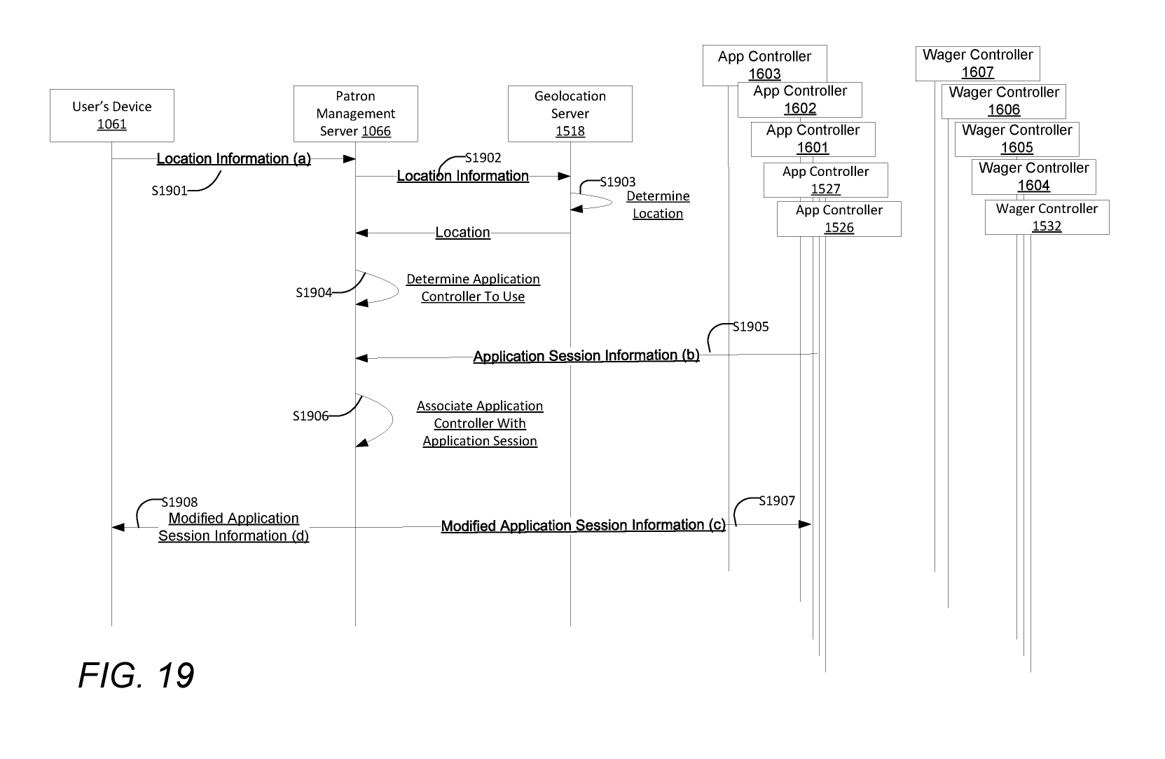

FIG. 19 is a sequence diagram of an embodiment of a user transfer interleaved wagering system. In some embodiments, the system includes a user's device, a patron management server, a geolocation server, one or more application controllers, and one or more wager controller. In some embodiments, the user's device is an interactive controller, as described herein. In some embodiments, the patron management server operatively connects the user's device to one of the one or more application controllers. In multiple embodiments, the one or more application controllers are software objects instantiated on an application controller server. In some embodiments, the application controllers are standalone processes instantiated on the application controller server. In some embodiments, the application controllers are threads or child processes or subprocesses of a main process instantiated on the application controller server.

This transition from real credit wagering to virtual credit wagering is performed by the patron management server 1066, as illustrated in FIG. 19.

At S1901, the patron management server 1066 receives location data associated with the user's device 1061. In some embodiments, the patron management server 1066 is a session management controller, as described herein. At S1902, the patron management server 1066 scans the location data to determine whether the user's device 1061 has moved into a new jurisdiction. In an implementation, the patron management server 1066 determines the change of jurisdiction by using the geolocation server 1518 (S1903).

At S1904, in a case where the patron management server 1066 determines (based on the location information received from the user's device 1061) that the user's device has moved from a jurisdiction in which real currency credit wagering is allowed to a jurisdiction in which real currency credit wagering is not allowed, then the patron management server 1066 selects a non-wagering application controller or a virtual currency credit application controller (e.g., one of application controller 1526, 1527, 1601, 1602, 1603).

At S1905, the patron management server 1066 receives application session data from the current real currency credit wagering application controller (e.g., application controller 1603). In some embodiments, the patron management server 1066 receives the application session data from an application controller within an application controller server which manages instantiations of the one or more application controllers (e.g., 1601, 1602, 1603, 1526, 1527). In some embodiments, each of the instantiations of the application controllers are created by the application controller server upon receiving application controller instantiation instructions from the patron management server 1066.

In some embodiments, the patron management server 1066 generates application controller instantiation instructions based on the determination of an application controller to use. The patron management server 1066 instructs the application controller server by communicating the application controller instantiation instructions to the application controller server.

The application controller server receives the application controller instantiation instructions from the patron management server 1066. The application controller server scans the application controller instantiation instructions to determine an application controller instantiation to create. The application controller server creates the application controller instantiation and communicates the application controller instantiation data to the patron management server 1066. The patron management server 1066 receives the application controller instantiation data and scans the application controller instantiation data to determine the application controller instantiation to associate with the application session. In some embodiments, the application controller associated with the application session is not created until the application controller server receives the application controller instantiation instructions.

The patron management server 1066 scans the application session data received from the application controller to determine application session information. The patron management server 1066 modifies the application session information to associate the selected virtual currency credit application controller (e.g., 1527) with the application session (at S1906), and communicates modified application session data, including modified application session information, to the selected virtual currency credit application controller 1527 (at S1907) and the user's device 1061 (at S1908).

After the user's device 1061 and the virtual credit application controller 1527 receive the application session information, the application session continues with virtual credit wagering enabled, by using the virtual credit application controller 1527.

In this manner, an application session may transition from real credit wagering to virtual credit wagering in a case where a location of the user's device 1061 moves from a jurisdiction in which real currency credit wagering is allowed to a jurisdiction in which real currency credit wagering is not allowed.

In some embodiments, the patron management server 1066 configures the user transfer interleaved wagering system by communicating application session information to the application controller and the user's device. In some embodiments, the user transfer interleaved wagering system is not configured until the patron management server 1066 configures the system.

In some implementations, the patron management server 1066 updates the user profile data (e.g., 1215 of FIG. 12) corresponding to the user of the device 1061 based on the modified application session information, as described above.

In some implementations, the application session information includes rule set information that identifies rules sets used in the application session, and the patron management server 1066 uses the rule set information to select an application controller (e.g., one of application controller 1526, 1527, 1601, 1602, 1603) that enables virtual currency credit application in accordance with the identified rule sets. In some implementations, rule sets include, but are not limited to, rule sets that are specific to a particular jurisdiction and determine whether or not the application controller may make real money wagering decisions. In some implementations, the rule sets include, but are not limited to, rule sets that define what application resources may be transmitted to the interactive application from the application controller based on wagering outcomes and application information.

While various example embodiments of the present disclosure have been described above, it should be understood that they have been presented by way of example, and not limitation. It will be apparent to persons skilled in the relevant art(s) that various changes in form and detail may be made therein. Thus, the present disclosure should not be limited by any of the above described example embodiments, but should be defined only in accordance with the following claims and their equivalents.

While the above description may include many specific embodiments of the invention, these should not be construed as limitations on the scope of the invention, but rather as examples of embodiments thereof. It is therefore to be understood that the present invention can be practiced otherwise than specifically described, without departing from the scope and spirit of the present invention. Thus, embodiments of the present invention described herein should be considered in all respects as illustrative and not restrictive.

What is claimed:

1. A configurable user transfer interleaved skill wagering gaming system, comprising:
a player's gaming device operatively connected to an application controller, the player's gaming device, configured to:
communicate, to a patron management server, application session request data associated with an interactive application provided by the player's gaming device; and
receive, from the patron management server, application session instructions based on the application session request data;
an application controller constructed to receive, from the patron management server, application session instructions; and
the patron management server operatively connecting the player's gaming device and the application controller, and constructed to:
receive, from the player's gaming device, the application session request data;
scan the application session request data to determine location information associated with the player's gaming device;
determine a location of the player's gaming device based on the location information;
determine to use the application controller based on the location of the player's gaming device, the application controller being one of a plurality of application controllers;
generate the application session instructions based on the application controller;
dynamically configure the player's gaming device by communicating the application session instructions to the player's gaming device; and
dynamically configure the application controller by communicating the application session instructions to the application controller.

2. The configurable user transfer interleaved skill wagering gaming system of claim 1,
wherein the player's gaming device and the application controller are constructed from a same device, and
wherein the application controller is operatively connected to a real credit controller using a communication link.

3. The configurable user transfer interleaved skill wagering gaming system of claim 1,
wherein a real credit controller and the application controller are constructed from a same device, and
wherein the application controller is operatively connected to the player's gaming device using a communication link.

4. The configurable user transfer interleaved skill wagering gaming system of claim 1, wherein the player's gaming device comprises a global positioning system (GPS) receiver, wherein the location information is generated using the GPS receiver.

5. The configurable user transfer interleaved skill wagering gaming system of claim 1,
wherein the patron management server determines the location of the player's gaming device by:
generating location information request instructions using the location information;
instructing a geolocation server by communicating the location information request instructions to the geolocation server;
receiving, from the geolocation server, player's gaming device location data; and
scanning the player's gaming device location data to determine the location of the player's gaming device.

6. The configurable user transfer interleaved skill wagering gaming system of claim 1, wherein the patron management server is further constructed to associate the determined application controller with an application session associated with the player's gaming device.

7. The configurable user transfer interleaved skill wagering gaming system of claim 1,
wherein the patron management server is further constructed to:
generate application controller instantiation instructions; and
instruct an application controller server by communicating the application controller instantiation instructions to the application controller server, and
wherein the application controller server is constructed to:
receive, from the patron management server, the application controller instantiation instructions; and
scan the application controller instantiation instructions to determine the application controller to be instantiated.

8. The configurable user transfer interleaved skill wagering gaming system of claim 7, wherein the instantiated application controller is a subprocess of a parent application controller.

9. A configurable user transfer interleaved skill wagering gaming system, comprising:
an application controller of the configurable user transfer interleaved skill wagering gaming system constructed to receive, from a patron management server, application session instructions; and
the patron management server of the configurable user transfer interleaved skill wagering gaming system operatively connecting the application controller to a player's gaming device using a communication link, the patron management server constructed to:
receive, from the player's gaming device, an application session request data associated with the player's gaming device provided by the interactive controller;
scan the application session request data to determine location information associated with the player's gaming device;
determine a location of the player's gaming device based on the location information;
determine to use the application controller based on the location of the player's gaming device, the application controller being one of a plurality of application controllers;
generate the application session instructions based on the application controller;
dynamically configure the player's gaming device by communicating the application session instructions to the player's gaming device; and
dynamically configure the application controller by communicating the application session instructions to the application controller.

10. The configurable user transfer interleaved skill wagering gaming system of claim 9, wherein the player's gaming device comprises a global positioning system (GPS) receiver, wherein the location information is generated using the GPS receiver.

11. The configurable user transfer interleaved skill wagering gaming system of claim 9,
wherein the patron management server determines the location of the player's gaming device by:
generating location information request instructions using the location information;
instructing a geolocation server by communicating the location information request instructions to the geolocation server;
receiving, from the geolocation server, player's gaming device location data; and
scanning the player's gaming device location data to determine the location of the player's gaming device.

12. The configurable user transfer interleaved skill wagering gaming system of claim 9, wherein the patron management server is further constructed to associate the determined application controller with an application session associated with the player's gaming device.

13. The configurable user transfer interleaved skill wagering gaming system of claim 9,
wherein the patron management server is further constructed to:
generate application controller instantiation instructions; and
instruct an application controller server by communicating the application controller instantiation instructions to the application controller server, and
wherein the application controller server is constructed to:
receive, from the patron management server, the application controller instantiation instructions; and
scan the application controller instantiation instructions to determine the application controller to be instantiated.

14. The configurable user transfer interleaved skill wagering gaming system of claim 13, wherein the instantiated application controller is a subprocess of a parent application controller.

15. A configurable user transfer interleaved skill wagering gaming system, comprising:
a player's gaming device of the configurable user transfer interleaved skill wagering gaming system constructed to:
communicate, to a patron management server, application session request data associated with an interactive application provided by the player's gaming device; and
receive, from the patron management server, application session instructions based on the application session request data; and
the patron management server of the configurable user transfer interleaved skill wagering gaming system operatively connecting the player's gaming device to a real credit controller, and constructed to:
receive, from the player's gaming device, the application session request data;
scan the application session request data to determine location information associated with the player's gaming device;
determine a location of the player's gaming device based on the location information;
determine to use the application controller based on the location of the player's gaming device, the application controller being one of a plurality of application controllers;
generate application session instructions based on the application controller;
dynamically configure the player's gaming device by communicating the application session instructions to the player's gaming device; and
dynamically configure the application controller by communicating the application session instructions to the application controller.

16. The configurable user transfer interleaved skill wagering gaming system of claim 15, wherein the player's gaming device comprises a global positioning system (GPS) receiver, wherein the location information is generated using the GPS receiver.

17. The configurable user transfer interleaved skill wagering gaming system of claim 15,
wherein the patron management server determines the location of the player's gaming device by:
generating location information request instructions using the location information;
instructing a geolocation server by communicating the location information request instructions to the geolocation server;
receiving, from the geolocation server, player's gaming device location data; and
scanning the player's gaming device location data to determine the location of the player's gaming device.

18. The configurable user transfer interleaved skill wagering gaming system of claim 15, wherein the patron management server is further constructed to associate the determined application controller with an application session associated with the player's gaming device.

19. The configurable user transfer interleaved skill wagering gaming system of claim 15,
wherein the patron management server is further constructed to:
generate application controller instantiation instructions; and
instruct an application controller server by communicating the application controller instantiation instructions to the application controller server, and
wherein the application controller server is constructed to:
receive, from the patron management server, the application controller instantiation instructions; and
scan the application controller instantiation instructions to determine the application controller to be instantiated.

20. The configurable user transfer interleaved skill wagering gaming system of claim 19, wherein the instantiated application controller is a subprocess of a parent application controller.
